(19) United States
(12) Patent Application Publication
(10) Pub. No.: US 2008/0173215 A1
(43) Pub. Date: Jul. 24, 2008

(54) Cellulose Acylate Film, and Polarizing Plate and Liquid-Crystal Display Device Using the Same

(75) Inventors: Mamoru Sakurazawa, Kanagawa (JP); Yutaka Nozoe, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/885,954

(22) PCT Filed: Mar. 10, 2006
(86) PCT No.: PCT/JP2006/305307

§ 371 Date: Sep. 10, 2007

(30) Foreign Application Priority Data
Mar. 11, 2005 (JP) 2005-069714
Jun. 21, 2005 (JP) 2005-181061

(51) Int. Cl. C08L 1/10; G02F 1/1335

(52) U.S. Cl. 106/168.01; 349/96

(57) ABSTRACT

A cellulose acylate film comprising: at least one retardation regulator; and at least one UV absorber having at least one absorption maximum in a wavelength range of from 250 nm to 380 nm.

### TECHNICAL FIELD

The present invention relates to a cellulose acylate film, and a polarizing plate and a liquid-crystal display device using the same.

### BACKGROUND ART

Hitherto, cellulose acylate films have been used as supports for photographs, and various optical materials in view of the toughness and flame retardancy. In particular, recently, they have widely been used as optical transparent films for liquid crystal display devices. Since cellulose acylate films have a high optical transparency and a high optical isotropy, they are excellent as optical materials for devices handling polarized light such as liquid-crystal display devices. Thus, they have hitherto been used as protective films for polarizers and supports for optically-compensatory films capable of improving the display viewed from an oblique direction (compensation of viewing angle).

In recent liquid-crystal display devices, it has been strongly desired to improve a viewing angle property. Optical transparent films such as protective films for polarizers and supports for optically-compensatory films are desired to be optically isotropic. It is important for optical isotropy to be a small retardation value represented by the product of birefringence and thickness of the optical film. In particular, in order to improve the display viewed from an oblique direction, it is necessary to lessen not only retardation in the in-plane direction (Re) but also retardation in the thickness direction (Rth). Specifically, at evaluation of optical properties of the optical transparent film, it is required that Re measured in front of the film is small and Re thereof does not change even when measured with changing angle.

Although a cellulose acylate film having a lessened in-plane Re has hitherto been known, it has been difficult to manufacture a cellulose acylate film having a small Re change with angle, i.e., a small Rth. An optical transparent film having an optical isotropy is strongly desired, wherein in-plane Re of the cellulose acylate film is nearly zero and change in retardation with angle is small, i.e., Rth is also nearly zero.

In the production of a cellulose acylate film, a compound called a plasticizer is added generally in order to improve film-forming performance. As the kind of plasticizer, there are disclosed phosphate triesters such as triphenyl phosphate and biphenyl diphenyl phosphate; phthalate esters (e.g., cf Plastic Material Koza, Vol. 17, Nikkan Kogyo Shinbun, “Sen-iso kei Jushi”, p. 121 (1970)). Of these plasticizers, there are known those having an effect of decreasing optical anisotropy of cellulose acylate films (e.g., specific fatty acid esters, cf. JP-A-2001-247717), but the effect of decreasing optical anisotropy of cellulose acylate films is not sufficient.

Moreover, in recent liquid-crystal display devices, there have increased the cases that they are used out of doors, such as mobile ones and automobile uses and hence the stability of optical performance against exposure to light (light resistance) becomes important.

Furthermore, demand of cellulose acylate films as protective films for polarizing plates has steeply increased and thus a small change in optical performance against saponification treatment necessary for preparation of polarizing plates is also important.

### DISCLOSURE OF THE INVENTION

An object of the invention is to provide a cellulose acylate film having a small optical anisotropy (Re, Rth), a small change in optical anisotropy against exposure to light, and an excellent light resistance.

Another object of the invention is to provide a cellulose acylate film having a small change in optical anisotropy by saponification treatment and an excellent saponification resistance.

Even another object of the invention is to provide optical materials such as a polarizing plate formed of a cellulose acylate film having a small optical anisotropy, an excellent light resistance, and an excellent saponification resistance and to provide a liquid-crystal display device having a wide viewing angle and a high display quality using the same.

As a result of extensive studies, the present inventors have found that the objects of the invention are achieved by the cellulose acylate film described below.

(1) A cellulose acylate film comprising:

at least one retardation regulator; and

at least one UV absorber having at least one absorption maximum in a wavelength range of from 250 nm to 380 nm.

(2) The cellulose acylate film as described in (1) above,

wherein the at least one retardation regulator is a compound satisfying numerical formula (11-1):

Rth(a)−Rth(0)/a≦−1.5 Numerical formula (11-1)

wherein 0.01≦a≦30;

Rth(a) represents Rth (nm) of a cellulose acylate film containing the at least one retardation regulator in an amount of a % at a wavelength of 630 nm;

Rth(0) represents Rth (nm) of a cellulose acylate film containing no retardation regulator at a wavelength of 630 nm; and

a represents part by mass of the at least one retardation regulator relative to 100 parts by mass of a cellulose acylate.

(3) The cellulose acylate film as described in (1) or (2) above,

wherein at least one of the at least one retardation regulator is a compound represented by any one of formulae (1) to (6):

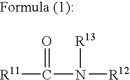

wherein R¹¹ represents an aryl group; R¹² and R¹³ each independently represents an alkyl group or an aryl group, and at least one of which is an aryl group; and the alkyl group and the aryl group each may have a substituent;

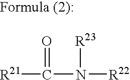

wherein R²¹, R²², and R²³ each independently represents an alkyl group; and the alkyl group may have a substituent;

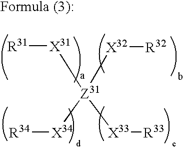

wherein R³¹, R³², R³³ and R³⁴ each independently represents a hydrogen atom, a substituted or unsubstituted aliphatic group or a substituted or unsubstituted aromatic group; X³¹, X³², X³³ and X³⁴ each independently represents a divalent connecting group formed of one or more groups selected from the group consisting of a single bond, —CO— and —NR³⁵— in which R³⁵ represents a substituted or unsubstituted aliphatic group or a substituted or unsubstituted aromatic group; a, b, c and d each is an integer of 0 or more, and a+b+c+d is 2 or more; and Z³¹ represents an (a+b+c+d) valent organic group excluding a cyclic group;

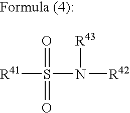

wherein R⁴¹ represents an alkyl group or an aryl group; R⁴² and R⁴³ each independently represents a hydrogen atom, an alkyl group or an aryl group; and a total carbon number of R⁴¹, R⁴² and R⁴³ is 10 or more;

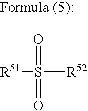

wherein R⁵¹ and R⁵² each independently represents an alkyl group or an aryl group; and a total carbon number of R⁵¹ and R⁵² is 10 or more;

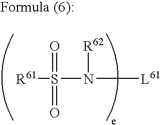

wherein R⁶¹ represents a substituted or unsubstituted aliphatic group or a substituted or unsubstituted aromatic group; R⁶² represents a hydrogen atom, a substituted or unsubstituted aliphatic group or a substituted or unsubstituted aromatic group; L⁶¹ represents a 2 to 6 valent connecting group; and e is an integer of 2 to 6 corresponding to the valency of L⁶¹.

(4) The cellulose acylate film as described in (3) above,

wherein at least one of the at least one retardation regulator is a compound represented by any one of the formulae (1) to (3).

(5) The cellulose acylate film as described in any of (1) to (4) above,

wherein the at least one UV absorber is at least one compound represented by formulae (7) to (9):

Q⁷¹-Q⁷²-OH Formula (7)

wherein Q⁷¹ represents a nitrogen-containing aromatic heterocycle; and Q⁷² represents an aromatic ring;

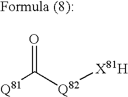

wherein Q⁸¹ and Q⁸² each independently represents an aromatic ring; and X⁸¹ represents NR⁸¹ in which R⁸¹ represents a hydrogen atom or a substituent, an oxygen atom or a sulfur atom;

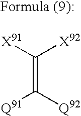

wherein Q⁹¹ and Q⁹² each independently represents an aromatic ring; and X⁹¹ and X⁹² each independently represents a hydrogen atom or a substituent, and at least one of which represents a cyano group, a carbonyl group, a sulfonyl group or an aromatic heterocycle.

(6) The cellulose acylate film as described in (5) above,

wherein the at least one UV absorber is a triazine compound wherein Q⁷¹ in the formula (7) is a 1,3,5-triazine ring.

(7) The cellulose acylate film as described in any of (1) to (6) above,

wherein the at least one UV absorber is a liquid compound at 25° C.

(8) The cellulose acylate film as described in any of (1) to (7) above,

wherein when the cellulose acylate film is irradiated with xenon light, contents of at least one of the at least one retardation regulator and the at least one UV absorber before and after irradiation satisfy numerical formula (1):

0.8≦Cmₓ/Cmₒ≦1.0 Numerical formula (1)

wherein Cmₒ is a content of the compound before irradiation with xenon light; and Cmₓ is a content of the compound after irradiation with xenon light.

(9) The cellulose acylate film as described in any of (1) to (8) above,

wherein the cellulose acylate film is saponified, and contents of at least one of the at least one retardation regulator and the at least one UV absorber before and after saponification satisfy a relation of numerical formula (2):

0.9≦Cmₛ/Cmₒ≦1.0 Numerical formula (2)

wherein Cmₒ is a content of the compound before saponification; and Cmₛ is a content of the compound after saponification.

(10) The cellulose acylate film as described in any of (1) to (9) above,

wherein Rth and Re of the cellulose acylate film at a wavelength of 630 nm satisfy ranges of numerical formulae (3) and (4):

−25 nm≦Rth₆₃₀≦25 nm, Numerical formula (3)

0 nm≦Re₆₃₀≦10 nm. Numerical formula (4)

(11) The cellulose acylate film as described in any of (1) to (10) above,

wherein values of Re and Rth of the cellulose acylate film at a wavelength of 630 nm satisfy a relation of numerical formula (5):

|Re₆₃₀×Rth₆₃₀|≦200. Numerical formula (5)

(12) The cellulose acylate film as described in any of (1) to (11) above,

wherein values of Re and Rth of the cellulose acylate film at a wavelength of 630 nm satisfy a relation of numerical formula (6):

|Re₆₃₀₍ₘₐₓ₎−Re₆₃₀₍ₘᵢₙ₎|≦5 and |Rth₆₃₀₍ₘₐₓ₎−Rth₆₃₀₍ₘᵢₙ₎|≦10. Numerical formula (6)

wherein Re₆₃₀₍ₘₐₓ₎ and Rth₆₃₀₍ₘₐₓ₎ each is a maximum retardation value of a film having a size of 1 m square randomly cut out at a wavelength of 630 nm; and Re₆₃₀(min) and Rth₆₃₀₍ₘᵢₙ₎ each is a minimum retardation value at a wavelength of 630 nm.

(13) The cellulose acylate film as described in any of (1) to (12) above,

wherein changes in values of Re and Rth of the cellulose acylate film at a wavelength of 630 mm before and after saponification of the film surface with an alkali solution satisfy numerical formula (7):

|Re₆₃₀₍ₒ₎−Re₆₃₀₍ₛ₎|≦10 and |Rth₆₃₀₍ₒ₎−Rth₆₃₀₍ₛ₎|≦20. Numerical formula (7)

wherein Re₆₃₀₍ₒ₎ represents Re at a wavelength of 630 nm before saponification with an alkali solution; Re₆₃₀₍ₛ₎ represents Re at a wavelength of 630 nm after saponification with an alkali solution; Rth₆₃₀₍ₒ₎ represents Rth at a wavelength of 630 nm before saponification with an alkali solution; and Rth₆₃₀₍ₛ₎ represents Rth at a wavelength of 630 nm after saponification with an alkali solution.

(14) The cellulose acylate film as described in any of (1) to (13) above,

wherein a change in Rth in a wavelength range of from 400 nm to 700 nm is 25 nm or less, and a change in Re in a wavelength range of from 400 nm to 700 nm is 10 nm or less.

(15) The cellulose acylate film as described in any of (1) to (14) above,

wherein a spectral transmittance of the cellulose acylate film at a wavelength of 400 nm is from 45% to 95%, and a spectral transmittance of the cellulose acylate film at a wavelength of 350 nm is 10% or less.

(16) The cellulose acylate film as described in any of (1) to (15) above,

wherein a degree of an acyl substitution of a cellulose acylate in the cellulose acylate film is from 2.50 to 3.00, and an average degree of polymerization of the cellulose acylate is from 180 to 700.

(17) The cellulose acylate film as described in any of (1) to (16) above,

wherein an acyl substituent of a cellulose acylate in the cellulose acylate film comprises substantially only an acetyl group, a total degree of substitution of the cellulose acylate is from 2.50 to 2.95 and an average degree of polymerization of the cellulose acylate is from 180 to 550.

(18) The cellulose acylate film as described in any of (1) to (17) above, which has a film thickness of from 10 μm to 120 μm.

(19) The cellulose acylate film as described in any of (1) to (18) above, which is obtained by stretching,

wherein a stretching magnitude is from 1% to 100% in a direction perpendicular to a film-carrying direction (width direction).

(20) The cellulose acylate film as described in (19) above,

wherein Re at a wavelength of 630 nm in the cellulose acylate film obtained by stretching satisfies a relation of numerical formula (8):

|Re₍ₙ₎−Re₍ₒ₎|/n≦1.0 Numerical formula (8)

wherein Re₍ₙ₎ is Re of a film stretched in a ratio of n(%); and Re₍₀₎ is Re of an unstreched film.

(21) The cellulose acylate film as described in any of (1) to (20) above, which is obtained by casting a cellulose acylate solution (dope) to form a film,

wherein a compound having a molecular weight of 3,000 or less is added to the a cellulose acylate solution in a final step in a preparation step of the dope.

(22) A polarizing plate comprising:

a polarizer; and

at least two protective films attached to both faces of the polarizer,

wherein at least one of the at least two protective films is a cellulose acylate film as described in any of (1) to (21) above.

(23). A liquid-crystal display device comprising:

a liquid-crystal cell; and

at least two polarizing plates arranged on both faces of the liquid-crystal cell,

wherein at least one of the at least two polarizing plates is a polarizing plate as described in (22) above.

(24) The liquid-crystal display device as described in (23) above,

wherein the liquid-crystal display device is IPS-mode.

### BRIEF DESCRIPTION OF THE DRAWING

FIGS. 1A and 1B are explanatory drawings illustrating compositional examples of combining a polarizing plate of the invention and a functional optical film; and

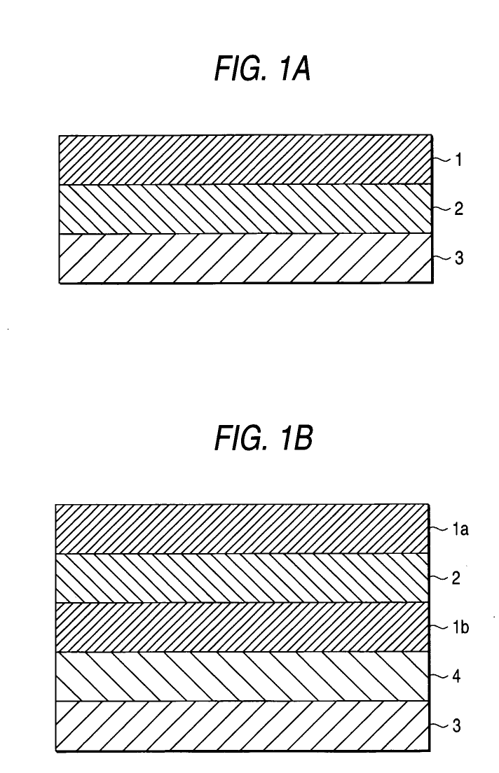

FIG. 2 is an explanatory drawing illustrating one example of a liquid-crystal display device using a polarizing plate of the invention,

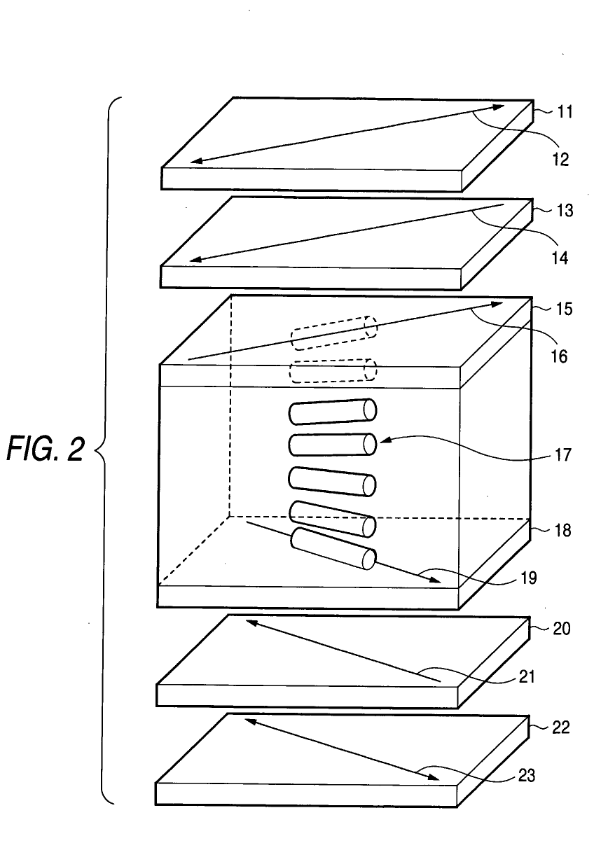

wherein 1, 1a, 1b denote protective films; 2 denotes polarizer; 3 denotes functional optical film; 4 denotes adhesive layer; 11 denotes upper polarizing plate; 12 denotes absorption axis of upper polarizing plate; 13 denotes upper optically-anisotropic layer; 14 denotes orientation-controlling direction of upper optically-anisotropic layer; 15 denotes upper substrate of liquid-crystal cell; 16 denoets orientation-controlling direction of upper substrate; 17 denotes liquid-crystal molecule; 18 denotes lower substrate of liquid-crystal cell; 19 denotes orientation-controlling direction of lower substrate; 20 denotes lower optically-anisotropic layer; 21 denotes orientation-controlling direction of lower optically-anisotropic layer; 22 denotes lower polarizing plate; and 23 denotes absorption axis of lower polarizing plate

### BEST MODE FOR CARRYING OUT THE INVENTION

### <Cellulose Acylate Film>

### [Retardation Regulator]

The cellulose acylate film of the invention contains at least one retardation regulator.

The retardation regulator in the invention is a compound satisfying the following numerical formula (10) or (11):

|Re(a)−Re(0)|/a≧1.0 Numerical formula (10)

|Rth(a)−Rth(0)|/a≧1.0

wherein 0.01≦a≦30;

Re(a): Re (nm) of a cellulose acylate film containing the retardation regulator in an amount of a %;

Rth(0): Re (nm) of a cellulose acylate film containing no retardation regulator;

Rth(a): Rth (nm) of a cellulose acylate film containing the retardation regulator in an amount of a %;

Rth(0): Rth (nm) of a cellulose acylate film containing no retardation regulator;

a: part by mass of the retardation regulator relative to 100 parts by mass of the cellulose acylate film.

Preferably, the retardation regulator is a compound satisfying the numerical formula (11). The retardation regulator preferably satisfies the numerical formula (11-1), more preferably satisfies the numerical formula (I-2), particularly preferably satisfies the numerical formula (11-3).

Rth(a)−Rth(0)/a≦−1.5 Numerical formula (11-1)

Rth(a)−Rth(0)/a≦−2.0 Numerical formula (11-2)

Rth(a)−Rth(0)/a≦−2.5 Numerical formula (11-3)

wherein 0.01≦a≦30.

The retardation regulator for use in the invention is preferably at least one selected from the above formulae (1) to (6). The following will describe these retardation regulators in detail.

First, a compound represented by the formula (1) will be described in detail.

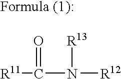

In the formula (1), R¹¹ represents an aryl group, R¹² and R¹³ each independently represents an alkyl group or an aryl group, at least one of which is an aryl group. When R¹² is an aryl group, R¹³ may be an alkyl group or an aryl group but is preferably an alkyl group. The alkyl group may be linear, branched, or cyclic and is preferably one having 1 to 20 carbon atoms, more preferably one having 1 to 15 carbon atoms, most preferably one having 1 to 12 carbon atoms. The aryl group is preferably one having 6 to 36 carbon atoms, more preferably one having 6 to 24 carbon atoms.

Next, a compound represented by the formula (2) will be described in detail.

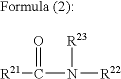

In the above formula (2), R²¹, R²², and R²³ each independently represents an alkyl group. The alkyl group may be linear, branched, or cyclic. Preferably, R²¹ is a cyclic alkyl group, and at least one of R²² and R²³ is more preferably a cyclic alkyl group. The alkyl group is preferably one having 1 to 20 carbon atoms, more preferably one having 1 to 15 carbon atoms, most preferably one having 1 to 12 carbon atoms. The cyclic alkyl group is particularly preferably a cyclohexyl group.

The alkyl groups in the above formulae (1) and (2) each may have a substituent. As the substituent, preferred are a halogen atom (e.g., chlorine, bromine, fluorine, or iodine), an alkyl group, an aryl group, an alkoxy group, an aryloxy group, an acyl group, an alkoxycarbonyl group, an aryloxycarbonyl group, an acyloxy group, a sulfonylamino group, a hydroxyl group, a cyano group, an amino group, and an acylamino group, more preferred are a halogen atom, an alkyl group, an aryl group, an alkoxy group, an aryloxy group, a sulfonylamino group, and an acylamino group, and particularly preferred are an alkyl group, an aryl group, a sulfonylamino group, and an acylamino group.

Next, the following will show preferred examples of the compound represented by the formula (1) or (2) but the invention is not limited to these specific examples.

In this connection, the compounds assigned as (A-) are specific examples of the compound represented by the formula (1) and the compounds assigned as (B-) are specific examples of the compound represented by the formula (2).

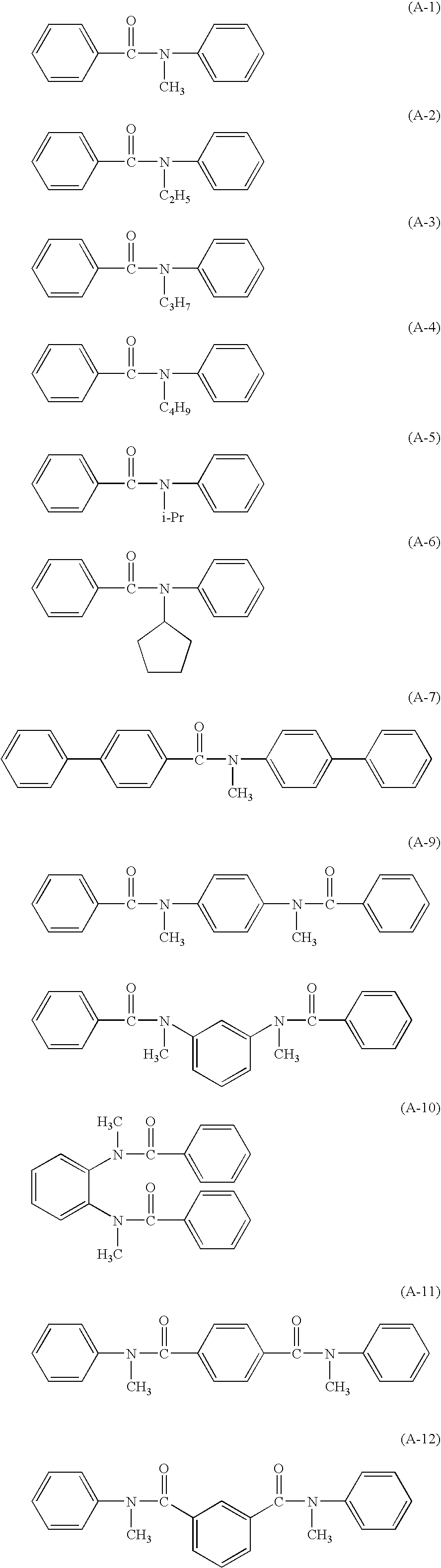

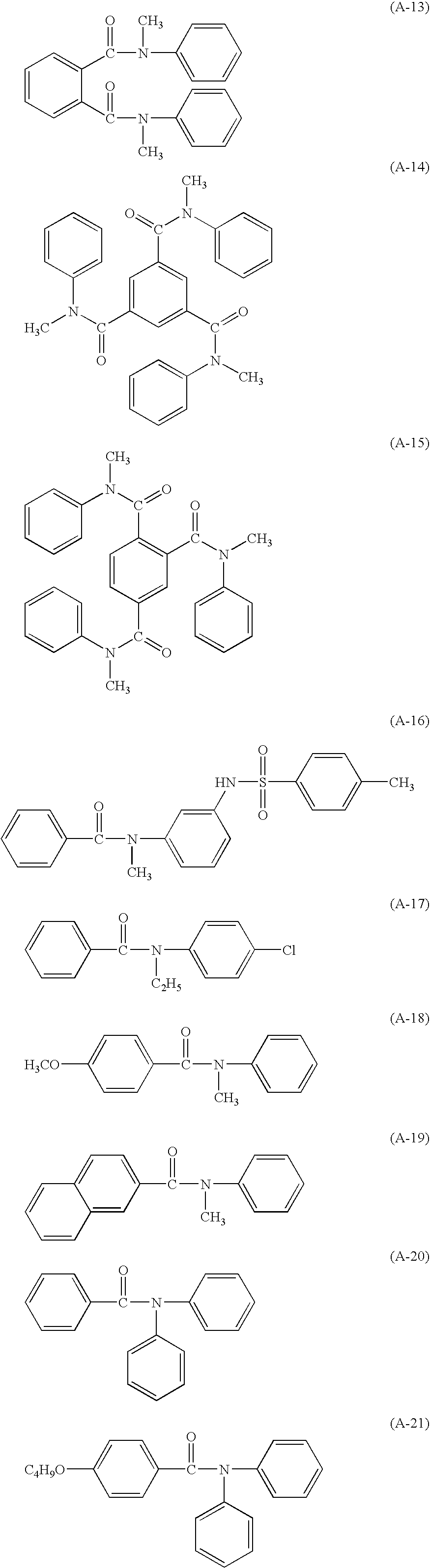

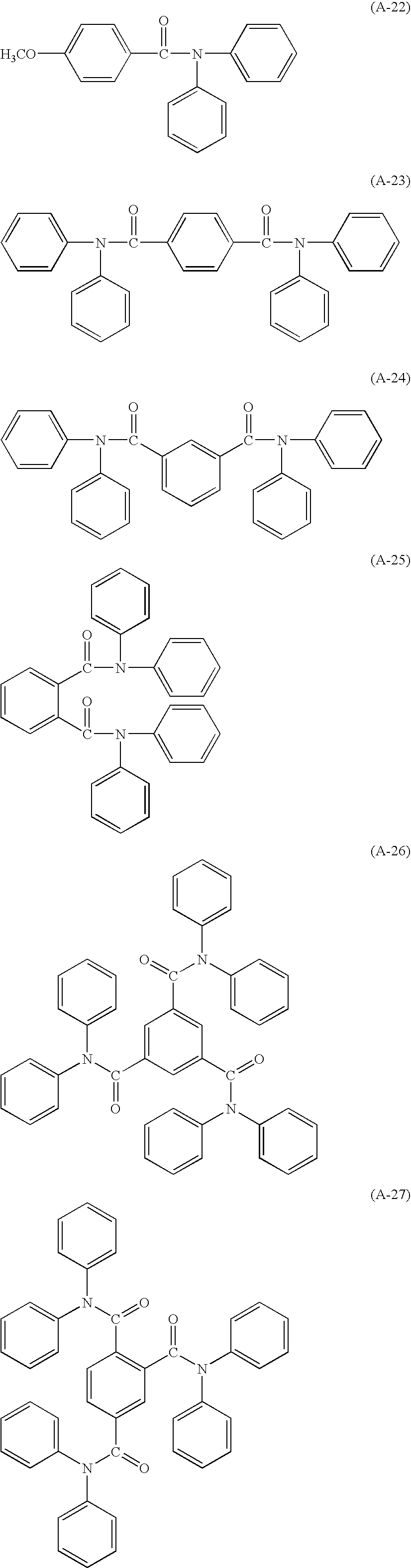

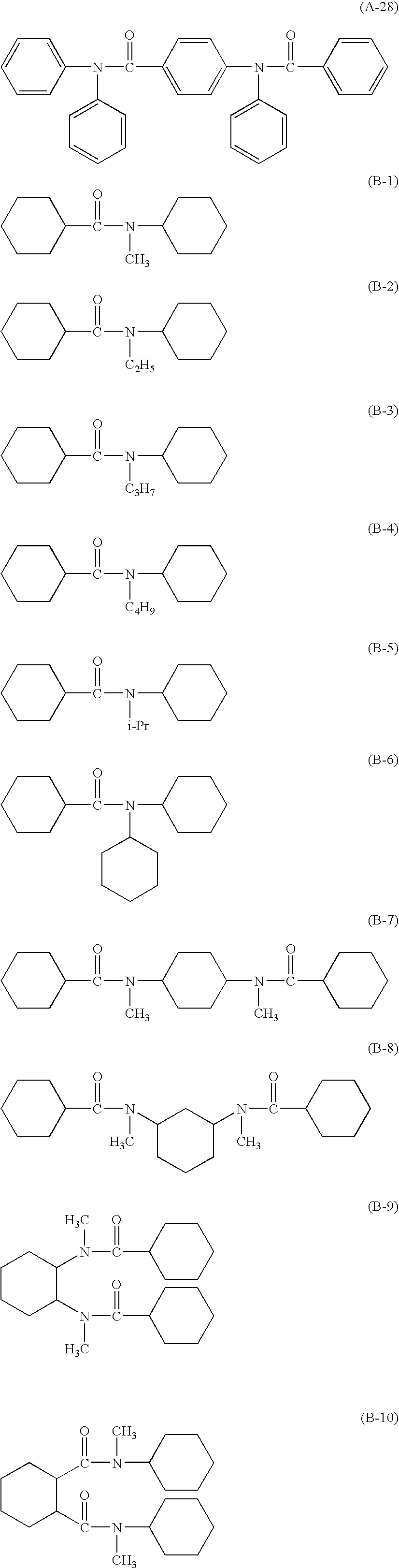

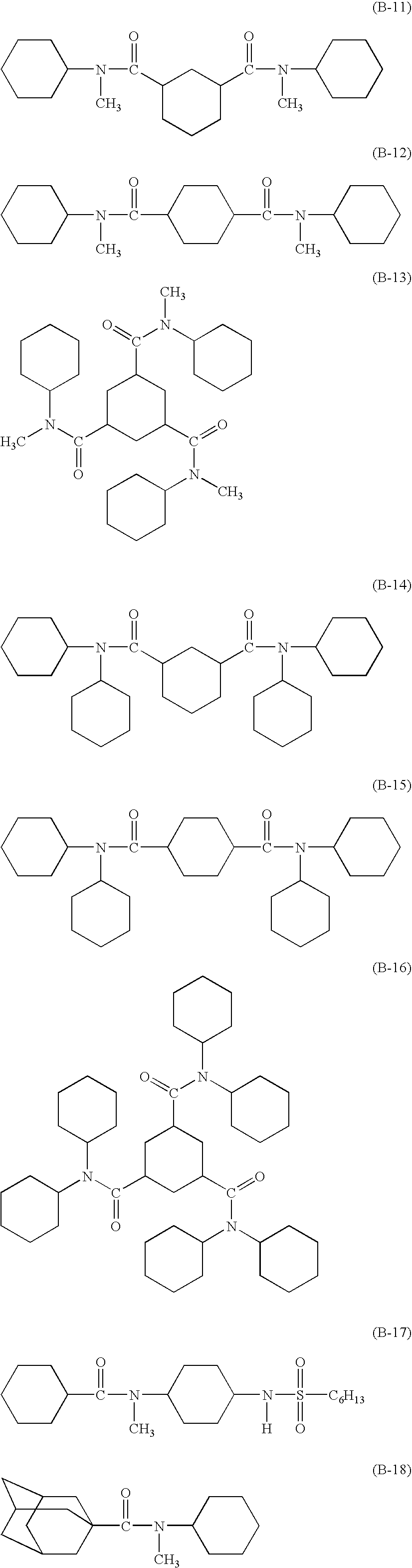

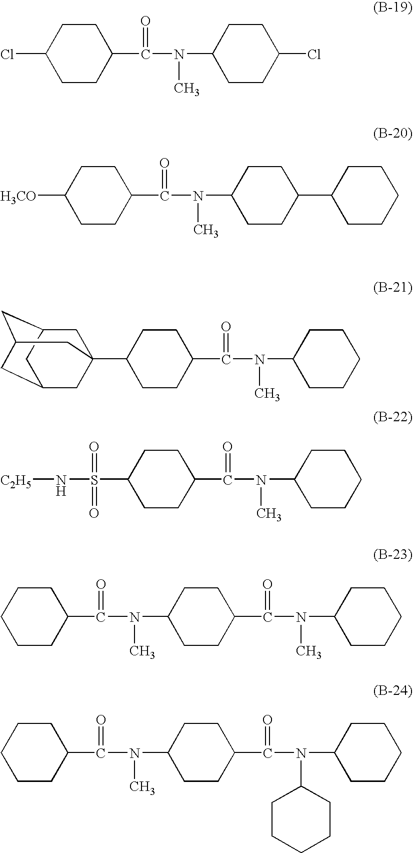

All of the above compounds can be produced by known methods. Namely, the compounds of the formulae (1) and (2) can be obtained by a dehydrative condensation reaction of carboxylic acids with amines using a condensing agent, e.g., dicyclohexylcarbodiimide (DCC) or a substitution reaction of carboxylic chloride derivatives with amine derivatives.

Next, the compound of the above formula (3) will be described.

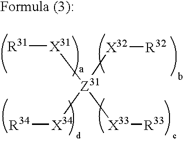

In the above formula (3), R³¹, R³², R³³, and R³⁴ each independently represents a hydrogen atom, a substituted or unsubstituted aliphatic group, or a substituted or unsubstituted aromatic group and is preferably an aliphatic group. The aliphatic group may be linear, branched, or cyclic and is preferably cyclic. As the substituent that the aliphatic group and the aromatic group may have, the following substituent T may be mentioned but unsubstituted ones are preferred.

X³¹, X³², X³³, and X³⁴ each independently represents a divalent connecting group formed of one or more groups selected from a group consisting of a single bond, —CO—, and —NR³⁵— in which R³⁵ represents a substituted or unsubstituted aliphatic group or a substituted or unsubstituted aromatic group, and an unsubstituted and/or an aliphatic group is more preferred. The combination of X³¹, X³², X³³, and X³⁴ is not particularly limited but is preferably selected from —CO— and —NR³⁵—. a, b, c, and d each is an integer of 0 or more and is more preferably 0 or 1, and a+b+c+d is 2 or more, preferably from 2 to 8, more preferably from 2 to 6, even more preferably from 2 to 4. Z³ represents an (a+b+c+d) valent organic group excluding a cyclic group. The valency of Z³ is preferably from 2 to 8, more preferably from 2 to 6, even more preferably from 2 to 4, most preferably 2 or 3. The organic group means a group derived from an organic compound.

Moreover, as the above formula (3), preferred is a compound represented by the following formula (3-1).

R³¹¹—X³¹¹-Z³¹¹-X³¹²—R³¹² Formula (3-1)

In the above formula (3-1), R³¹¹ and R³¹² each represents a substituted or unsubstituted aliphatic group or a substituted or unsubstituted aromatic group and is preferably an aliphatic group. The aliphatic group may be linear, branched, or cyclic and is more preferably cyclic. As the substituent that the aliphatic group and the aromatic group may have, the following substituent T may be mentioned but unsubstituted ones are preferred. X³¹¹ and X³¹² each independently represents —CONR³¹³— or —NR³¹⁴CO—, and R³¹³ and R³¹⁴ each represents a substituted or unsubstituted aliphatic group or a substituted or unsubstituted aromatic group and is more preferably unsubstituted ones and/or an aliphatic group. Z³¹¹ represents a divalent organic group excluding a cyclic one formed of one or more groups selected from —O—, —S—, —SO—, —SO₂—, —CO—, —NR³¹⁵— (wherein R³¹⁵ represents a substituted or unsubstituted aliphatic group or a substituted or unsubstituted aromatic group and is preferably an unsubstituted ones and/or an aliphatic group), an alkylene group, and an arylene group. The combination of Z³¹¹ is not particularly limited but is preferably selected from —O—, —S—, —NR³¹⁵—, and an alkylene group, more preferably selected from —O—, —S—, and an alkylene group, most preferably selected from —O—, —S—, and an alkylene group.

As the above formula (3-1), preferred are compounds represented by the following formulae (3-2) to (3-4).

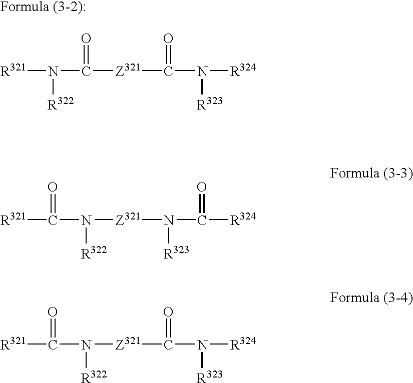

In the above formulae (3-2) to (3-4), R³²¹, R³²², R³²³, and R³²⁴ each independently represents a substituted or unsubstituted aliphatic group or a substituted or unsubstituted aromatic group and is preferably an aliphatic group. The aliphatic group may be linear, branched, or cyclic and is more preferably cyclic. As the substituent that the aliphatic group and the aromatic group may have, the following substituent T may be mentioned but unsubstituted ones are preferred. Z³²¹ represents a divalent connecting group formed of one or more groups selected from —O—, —S—, —SO—, —SO₂—, —CO—, —NR³¹⁵— (wherein R³²⁵ represents a substituted or unsubstituted aliphatic group or a substituted or unsubstituted aromatic group and is preferably unsubstituted one and/or an aliphatic group), an alkylene group, and an arylene group. The combination of Z³²¹ is not particularly limited but is preferably selected from —O—, —S—, —NR³²⁵—, and an alkylene group, more preferably selected from —O—, —S—, and an alkylene group, most preferably selected from —O—, —S—, and an alkylene group.

The following will describe the above substituted or unsubstituted aliphatic group.

The aliphatic group may be linear, branched or cyclic and preferably one having 1 to 25 carbon atoms, more preferably one having 6 to 25 carbon atoms, particularly preferably one having 6 to 20 carbon atoms. Specific examples of the aliphatic group include a methyl group, an ethyl group, an n-propyl group, an isopropyl group, a cyclopropyl group, an n-butyl group, an isobutyl group, a t-butyl group, an amyl group, an isoamyl group, a t-amyl group, an n-hexyl group, a cyclohexyl group, an n-heptyl group, an n-octyl group, a bicyclooctyl group, an adamantyl group, an n-decyl group, a t-octyl group, a dodecyl group, a hexadecyl group, an octadecyl group, and a didecyl group.

The following will describe the above aromatic group.

The aromatic group may be an aromatic hydrocarbon or an aromatic heterocyclic group, preferably an aromatic hydrocarbon group. The aromatic hydrocarbon group has preferably 6 to 24 carbon atoms, more preferably 6 to 12 carbon atoms. Examples of specific rings of the aromatic hydrocarbon group include benzene, naphthalene, anthracene, biphenyl, and terphenyl. As the aromatic hydrocarbon group, particularly preferred are benzene, naphthalene, and biphenyl. As the aromatic heterocyclic group, preferred are those containing at least one of oxygen atom, nitrogen atom, and sulfur atom. Specific examples of the heterocycle include furan, pyrrole, thiophene, imidazole, pyrazole, pyridine, pyrazine, pyridazine, triazole, triazine, indole, indazole, purine, thiazoline, thiadiazole, oxazoline, oxazole, oxadiazole, quinoline, isoquinoline, phtharazine, naphthylidine, quinoxaline, quinazoline, cinnoline, pteridine, acridine, phenanthroline, phenazine, tetrazole, benzimidazole, benzoxazole, benzothiazole, benzotriazole, tetrazaindene. As the aromatic heterocyclic group, particularly preferred are pyridine, triazine, and quinoline.

Moreover, the following will describe the above substituent T in detail.

Examples of the substituent T include alkyl groups (preferably 1 to 20, more preferably 1 to 12, particularly preferably 1 to 8 carbon atoms, e.g., a methyl group, an ethyl group, an isopropyl group, a t-butyl group, an n-octyl group, an n-decyl group, an n-hexadecyl group, a cyclohexyl group, a cyclopentyl group, and a cyclohexyl group), alkenyl groups (preferably 2 to 20, more preferably 2 to 12, particularly preferably 2 to 8 carbon atoms, e.g., a vinyl group, an allyl group, a 2-butenyl group, and a 3-pentenyl group), alkynyl groups (preferably 2 to 20, more preferably 2 to 12, particularly preferably 2 to 8 carbon atoms, e.g., a propargyl group, and a 3-pentynyl group), aryl groups (preferably 6 to 30, more preferably 6 to 20, particularly preferably 6 to 12 carbon atoms, e.g., a phenyl group, a biphenyl group, and a naphthyl group), amino groups (preferably 0 to 20, more preferably 0 to 10, particularly preferably 0 to 6 carbon atoms, e.g., an amino group, a methylamino group, a dimethylamino group, a diethylamino group, and a benzylamino group), alkoxy groups (preferably 1 to 20, more preferably 1 to 12, particularly preferably 1 to 8 carbon atoms, e.g., a methoxy group, an ethoxy group, and arbutoxy group), aryloxy groups (preferably 6 to 20, more preferably 6 to 16, particularly preferably 6 to 12 carbon atoms, e.g., a phenyloxy group and a 2-naphthyloxy group), acyl groups (preferably 1 to 20, more preferably 1 to 16, particularly preferably 1 to 12 carbon atoms, e.g., an acetyl group, a benzoyl group, a formyl group, and a pivaloyl group), alkoxycarbonyl groups (preferably 2 to 20, more preferably 2 to 16, particularly preferably 2 to 12 carbon atoms, e.g., a methoxycarbonyl group and an ethoxycarbonyl group), aryloxycarbonyl groups (preferably 7 to 20, more preferably 7 to 16, particularly preferably 7 to 10 carbon atoms, e.g., a phenyloxycarbonyl group), acyloxy groups (preferably 2 to 20, more preferably 2 to 16, particularly preferably 2 to 10 carbon atoms, e.g., an acetoxy group and a benzoyloxy group), acylamino groups (preferably 2 to 20, more preferably 2 to 16, particularly preferably 2 to 10 carbon atoms, e.g., an acetylamino group and a benzoylamino group), alkoxycarbonylamino groups (preferably 2 to 20, more preferably 2 to 16, particularly preferably 2 to 12 carbon atoms, e.g., a methoxycarbonylamino group), aryloxycarbonylamino groups (preferably 7 to 20, more preferably 7 to 16, particularly preferably 7 to 12 carbon atoms, e.g., a phenyloxycarbonylamino group), sulfonylamino groups (preferably 1 to 20, more preferably 1 to 16, particularly preferably 1 to 12 carbon atoms, e.g., a methanesulfonylamino group and a benzenesulfonylamino group), sulfamoyl groups (preferably 0 to 20, more preferably 0 to 16, particularly preferably 0 to 12 carbon atoms, e.g., a sulfamoyl group, a methylsulfamoyl group, a dimethylsulfamoyl group, and a phenylsulfamonyl group), carbamoyl groups (preferably 1 to 20, more preferably 1 to 16, particularly preferably 1 to 12 carbon atoms, e.g., a carbamoyl group, a methylcarbamoyl group, a diethylcarbamoyl group, and a phenylcarbamoyl group), alkylthio groups (preferably 1 to 20, more preferably 1 to 16, particularly preferably 1 to 12 carbon atoms, e.g., a methylthio group and an ethylthio group), arylthio groups (preferably 6 to 20, more preferably 6 to 1.6, particularly preferably 6 to 12 carbon atoms, e.g., a phenylthio group), sulfonyl groups (preferably 1 to 20, more preferably 1 to 16, particularly preferably 1 to 12 carbon atoms, e.g., a mesyl group and a tosyl group), sulfinyl groups (preferably 1 to 20, more preferably 1 to 16, particularly preferably 1 to 12 carbon atoms, e.g., a methanesulfinyl group and a benzenesulfinyl group), ureido groups (preferably 1 to 20, more preferably 1 to 16, particularly preferably 1 to 12 carbon atoms, e.g., a ureido group, a methylureido group and a phenylureido group), phosphoric amide groups (preferably 1 to 20, more preferably 1 to 16, particularly preferably 1 to 12 carbon atoms, e.g., a diethylphosphoric amide and a phenylphosphoric amide), a hydroxyl group, a mercapto group, halogen atoms (e.g., fluorine, chlorine, bromine, and iodine atoms), a cyano group, a sulfo group, a carboxyl group, a nitro group, a hydroxamic acid group, a sulfino group, a hydrazino group, an imino group, heterocylic groups (preferably 1 to 30, more preferably 1 to 12 carbon atoms, and e.g., a nitrogen atom, an oxygen atom, a sulfur atom as a heteroatom, specifically, e.g., an imidazolyl group, a pyridyl group, a quinolyl group, a furyl group, a piperidyl group, a morpholino group, a benzoxazolyl group, a benzimidazolyl group, and a benzothiazolyl group), silyl groups (preferably, 3 to 40, more preferably 3 to 30, particularly preferably 3 to 24 carbon atoms, e.g., a trimethylsilyl group and a triphenylsilyl group), and the like. These substituents may be further substituted. Moreover, in the case that two substituents are present, they may be the same or different from each other. Furthermore, if possible, they may be combined with each other to form a ring.

The following will show preferred examples of the compound represented by the formula (3) but the invention is not limited to these specific examples.

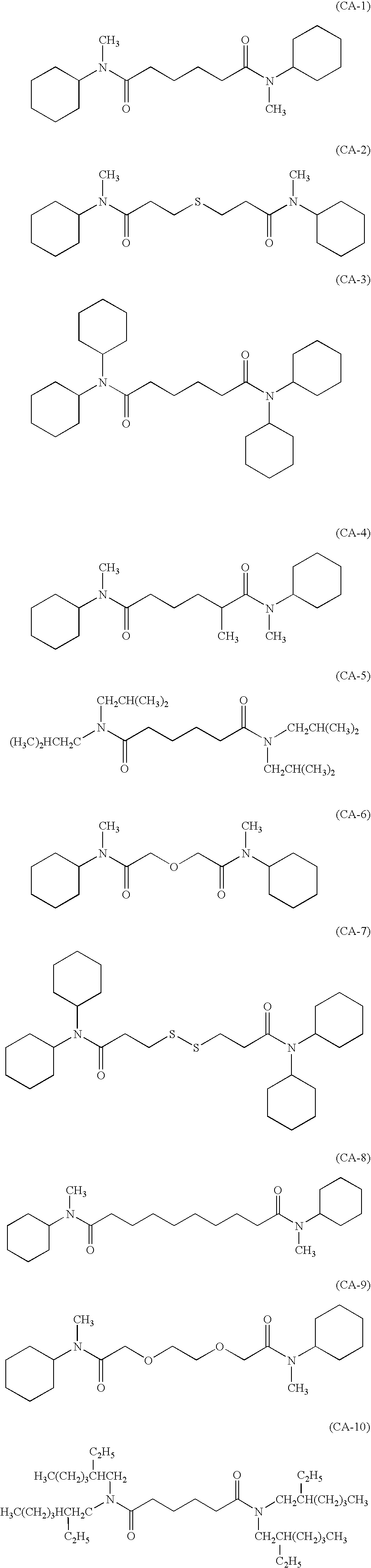

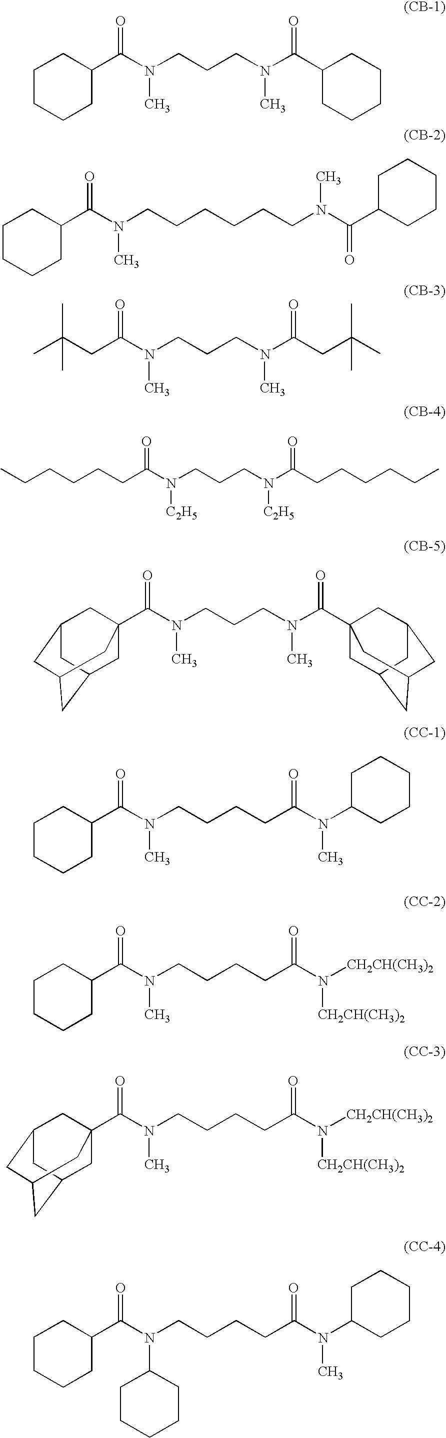

All the compounds for use in the invention can be produced from known compounds. The compound represented by any of the formulae (3) and (3-1) to (3-4) is obtained by a condensation reaction of a carbonyl chloride with an amine.

Next, compounds of the formulae (4) and (5) will be described.

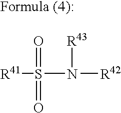

In the above formula (4), R⁴¹ represents an alkyl group or an aryl group and R⁴² and R⁴³ each independently represents a hydrogen atom, an alkyl group, or an aryl group. Moreover, total carbon number of R⁴¹, R⁴², and R⁴³ is particularly preferably 10 or more.

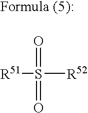

In the above formula (5), R⁵¹ and R⁵² each independently represents an alkyl group or an aryl group and total carbon number of R⁵¹ and R⁵² is 10 or more. The alkyl group and the aryl group each may have a substituent.

As the substituent, preferred are a fluorine atom, an alkyl group, an aryl group, an alkoxy group, a sulfone group, and a sulfonamide group and particularly preferred are an alkyl group, an aryl group, an alkoxy group, a sulfone group, and a sulfonamide group.

The alkyl group may be linear, branched, or cyclic and is preferably one having 1 to 25 carbon atoms, more preferably one having 6 to 25 carbon atoms, and particularly preferably one having 6 to 20 carbon atoms, e.g., methyl, ethyl, propyl, isopropyl, butyl, isobutyl, t-butyl, amyl, isoamyl, t-amyl, hexyl, cyclohexyl, heptyl, octyl, bicyclooctyl, nonyl, adamantyl, decyl, t-octyl, undecyl, dodecyl, tridecyl, tetradecyl, pentadecyl, hexadecyl, heptadecyl, octadecyl, nonadecyl, or didecyl.

The aryl group is preferably one having 6 to 30 carbon atoms, particularly preferably one having 6 to 24 carbon atoms, e.g., phenyl, biphenyl, terphenyl, naphthyl, binaphthyl, or triphenylphenyl.

The following will show preferred examples of the compound represented by the formula (4) or (5) but the invention is not limited to these specific examples.

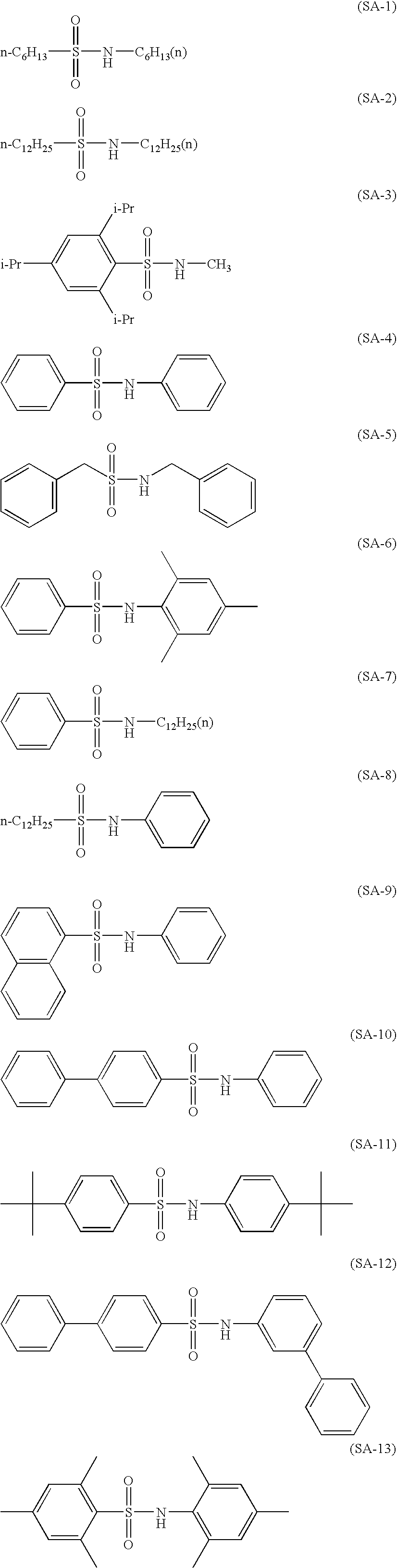

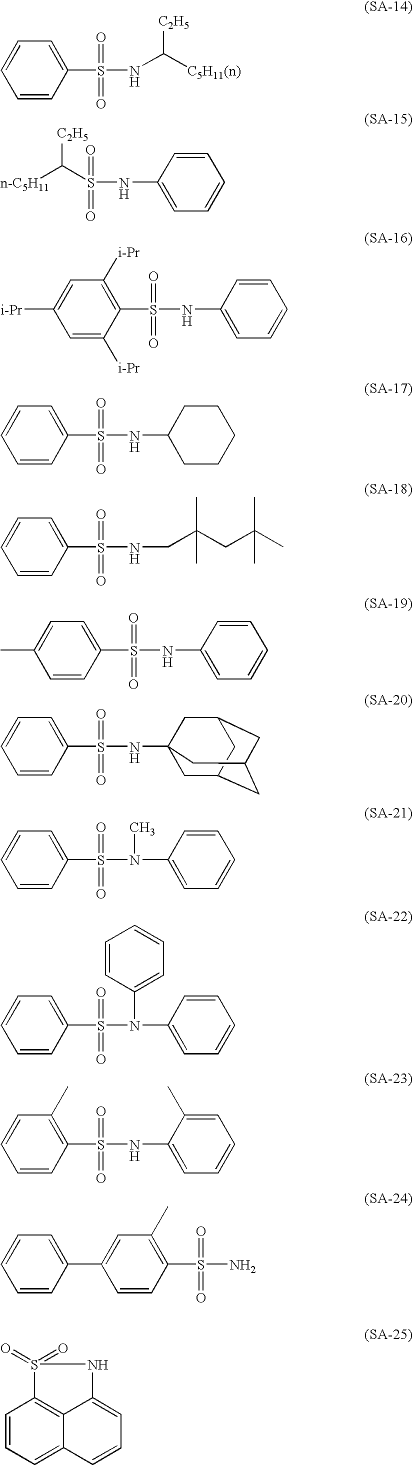

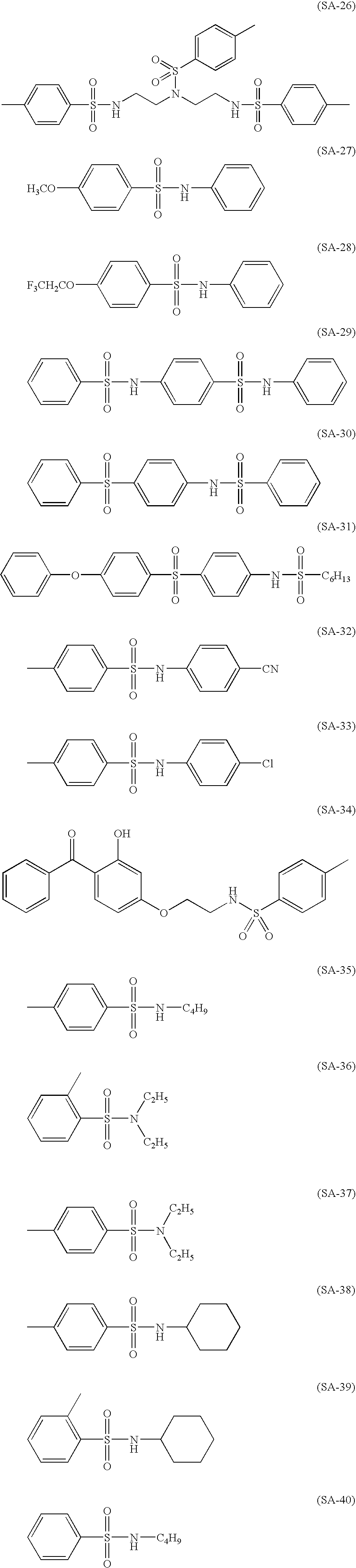

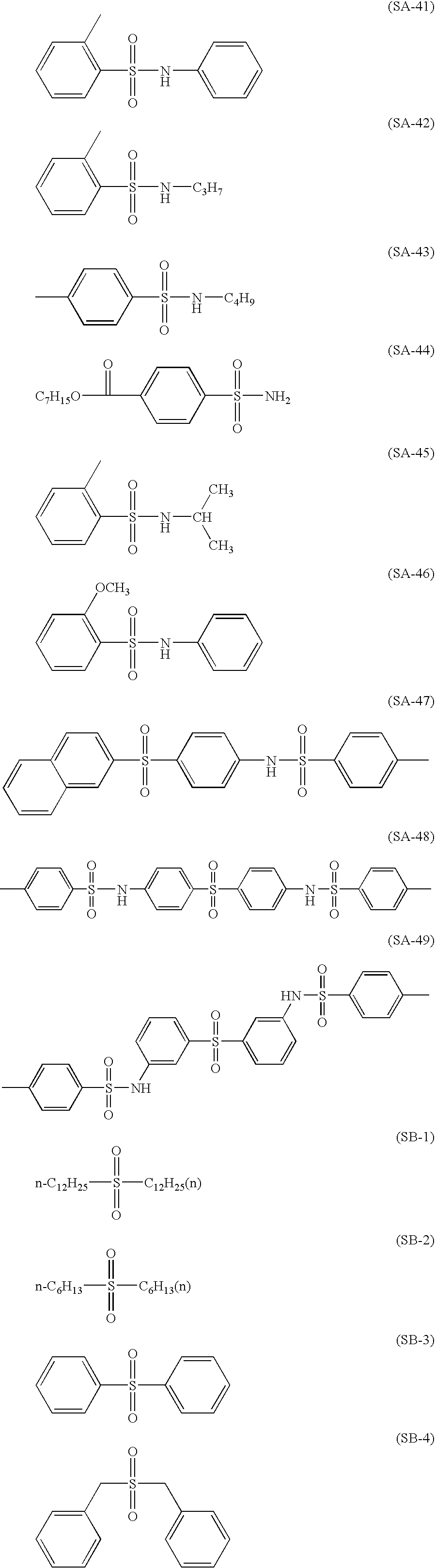

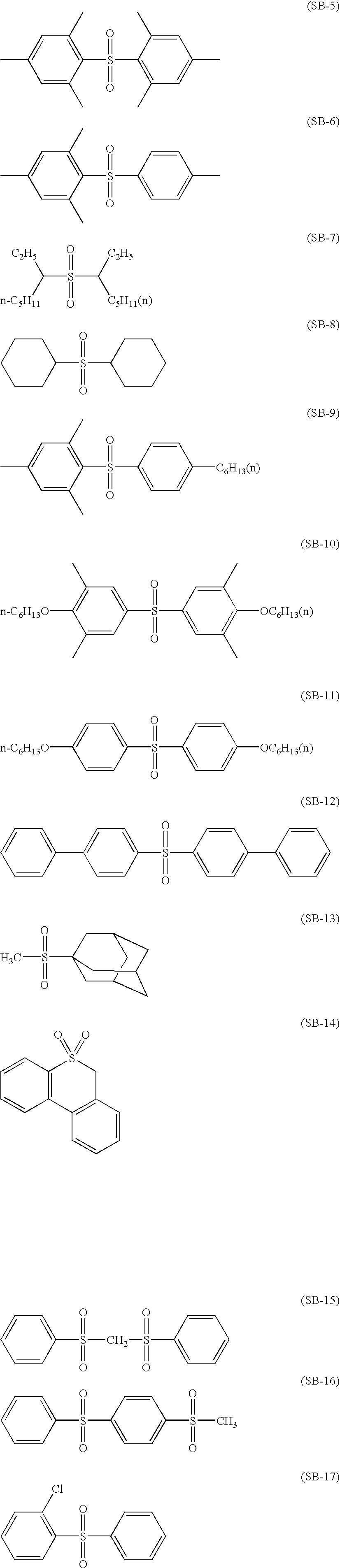

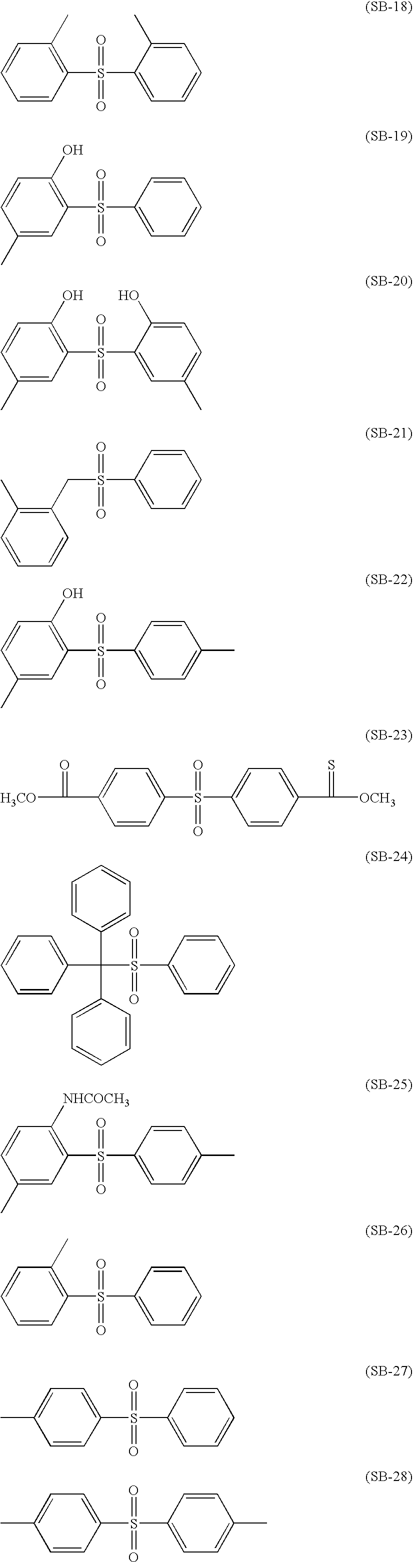

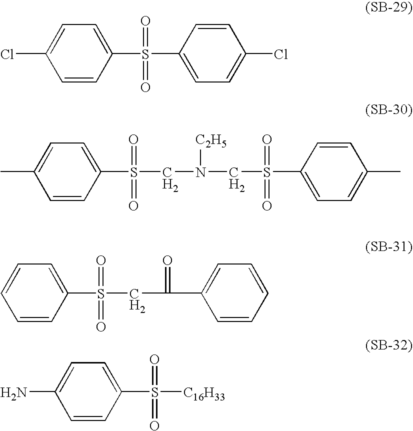

The following will describe the compound represented by the formula (6) of the invention.

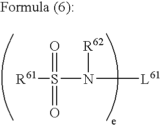

In the formula (6), R⁶¹ represents a substituted or unsubstituted aliphatic group or a substituted or unsubstituted aromatic group, R⁶² represents a hydrogen atom, a substituted or unsubstituted aliphatic group, or a substituted or unsubstituted aromatic group. As the substituent, the above substituent T may be mentioned (the same shall apply to hereinafter unless otherwise specified). L⁶¹ represents a 2 to 6 valent connecting group. The valency of L⁶¹ is preferably from 2 to 4, more preferably 2 or 3. e represents an integer of 2 to 6 corresponding to the valency of L⁶¹ and is more preferably from 2 to 4, particularly preferably 2 or 3.

Two or more of R⁶¹ and R⁶² contained in one compound may be the same or different from each other but are preferably the same.

The compound of the above formula (6) is preferably a compound represented by the following formula (6-1).

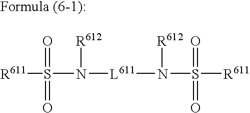

In the formula (6-1), R⁶¹¹ represents a substituted or unsubstituted aliphatic group or a substituted or unsubstituted aromatic group. R⁶¹¹ is preferably a substituted or unsubstituted aromatic group, more preferably unsaturated aromatic group. R⁶¹² represents a hydrogen atom, a substituted or unsubstituted aliphatic group, or a substituted or unsubstituted aromatic group. R⁶¹² is preferably a hydrogen atom or a substituted or unsubstituted aliphatic group, more preferably a hydrogen atom. L⁶¹¹ represents a divalent connecting group formed of one or more groups selected from —O—, —S—, —CO—, —NR⁶¹³— (wherein R⁶¹³ is a hydrogen atom, a substituted or unsubstituted aliphatic group, or a substituted or unsubstituted aromatic group), an alkylene group, and an arylene group. The combination of the connecting group is not particularly limited but is preferably selected from —O—, —S—, —NR⁶¹³—, and an alkylene group, particularly preferably selected from —O—, —S—, and an alkylene group. Moreover, the connecting group is preferably a connecting group comprising two or more selected from —O—, —S—, and an alkylene group.

The following will describe the above substituted or unsubstituted aliphatic group.

The aliphatic group may be linear, branched, or cyclic and is preferably one having 1 to 25 carbon atoms, more preferably one having 6 to 25 carbon atoms, most preferably one having 6 to 20 carbon atoms. Specific examples of the aliphatic group include a methyl group, an ethyl group, an n-propyl group, an isopropyl group, a cyclopropyl group, an n-butyl group, an isobutyl group, a t-butyl group, an amyl group, an isoamyl group, a t-amyl group, an n-hexyl group, a cyclohexyl group, an n-heptyl group, an n-octyl group, a bicyclooctyl group, an adamantyl group, an n-decyl group, a t-octyl group, a dodecyl group, a hexadecyl group, an octadecyl group, and a didecyl group.

The following will describe the above aromatic group. The aromatic group may be an aromatic hydrocarbon or an aromatic heterocyclic group, more preferably an aromatic hydrocarbon group. The aromatic hydrocarbon group has preferably 6 to 24 carbon atoms, more preferably 6 to 12 carbon atoms. Examples of specific rings of the aromatic hydrocarbon group include benzene, naphthalene, anthracene, biphenyl, and terphenyl. As the aromatic hydrocarbon group, particularly preferred are benzene, naphthalene, and biphenyl. As the aromatic heterocyclic group, preferred are those containing at least one of oxygen atom, nitrogen atom, and sulfur atom. Specific examples of the heterocycle include furan, pyrrole, thiophene, imidazole, pyrazole, pyridine, pyrazine, pyridazine, triazole, triazine, indole, indazole, purine, thiazoline, thiadiazole, oxazoline, oxazole, oxadiazole, quinoline, isoquinoline, phtharazine, naphthylidine, quinoxaline, quinazoline, cinnoline, pteridine, acridine, phenanthroline, phenazine, tetrazole, benzimidazole, benzoxazole, benzothiazole, benzotriazole, tetrazaindene. As the aromatic heterocyclic group, particularly preferred are pyridine, triazine, and quinoline.

As the above formula (6), more preferred is a compound represented by the following formula (6-2).

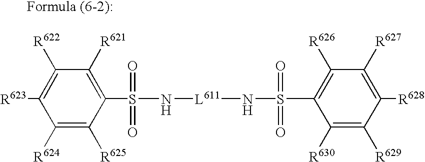

In the above formula (3), R⁶²¹, R⁶²², R⁶²³, R⁶²⁴, R⁶²⁵, R⁶²⁶, R⁶²⁷, R⁶²⁸, R⁶²⁹, and R⁶³⁰ each independently represents a hydrogen atom or a substituent, and as a substituent, the above substituent T may be applied.

As R⁶²¹, R⁶²², R⁶²³, R⁶²⁴, R⁶²⁵, R⁶²⁶, R⁶²⁷, R⁶²⁸, R⁶²⁹, and R⁶³⁰, preferred are an alkyl group, an alkenyl group, an alkynyl group, an aryl group, an amino group, an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a sulfonyl group, a sulfinyl group, a ureido group, a phosphoric amide group, a hydroxyl group, a mercapto group, a halogen atom (e.g., fluorine, chlorine, bromine, or iodine atom), a cyano group, a sulfo group, a carboxyl group, a nitro group, a hydroxamic acid group, a sulfino group, a hydrazino group, an imino group, a heterocylic group (preferably one having 1 to 30, more preferably one having 1 to 12 carbon atoms, and e.g., a nitrogen atom, an oxygen atom, or a sulfur atom as a heteroatom, specifically, e.g., an imidazolyl group, a pyridyl group, a quinolyl group, a furyl group, a piperidyl group, a morpholino group, a benzoxazolyl group, a benzimidazolyl group, or a benzothiazolyl group), a silyl group, more preferred are an alkyl group, an aryl group, an aryloxycarbonylamino group, an alkoxy group, and an aryloxy group, particularly preferred are an alkyl group, an aryl group, and an aryloxycarbonylamino group. These substituents may be further substituted and, in the case that two substituents are present, they may be the same or different from each other. Moreover, if possible, they may be combined with each other to form a ring. Each of R⁶²¹ and R⁶²⁶, R⁶²² and R⁶²⁷, R⁶²³ and R⁶², R⁶²⁴ and R⁶²⁹, and R⁶²⁵ and R⁶³⁰ is preferably the same. Furthermore, R⁶²¹ to R⁶³⁰ each is preferably a hydrogen atom.

L⁶²¹ represents a divalent connecting group formed of one or more groups selected from —O—, —S—, —CO—, —NR⁶³¹— (wherein R⁶³¹ is a hydrogen atom, an aliphatic group, or an aromatic group), an alkylene group, and an arylene group. The combination of the connecting group is not particularly limited but is preferably selected from —O—, —S—, —NR⁶¹³—, and an alkylene group, particularly preferably selected from —O—, —S—, and an alkylene group. Moreover, the connecting group is preferably a connecting group comprising two or more selected from —O—, —S—, and an alkylene group.

The following will show preferred examples of the compound represented by the formula (6), (6-1), or (6-2) but the invention is not limited to these specific examples.

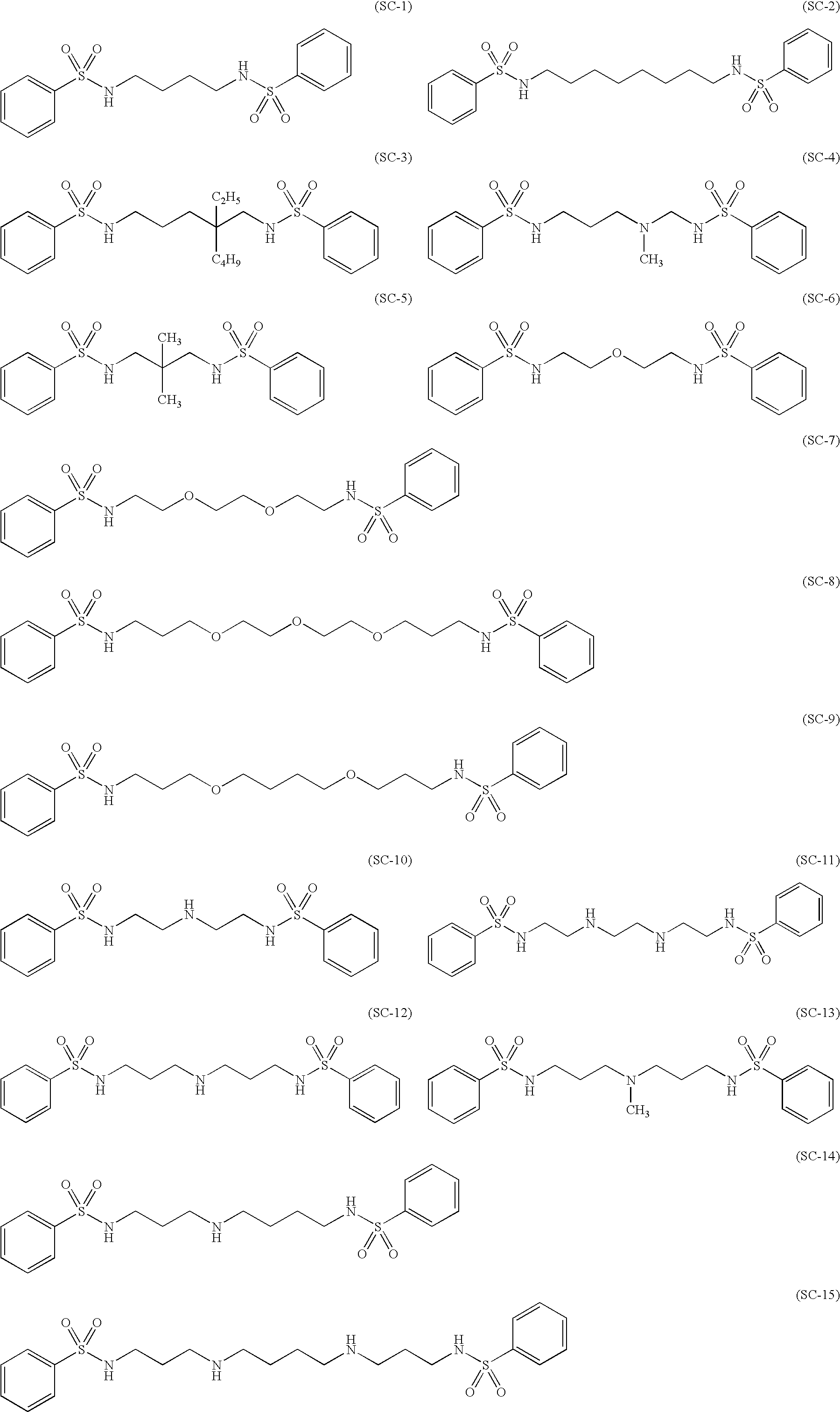

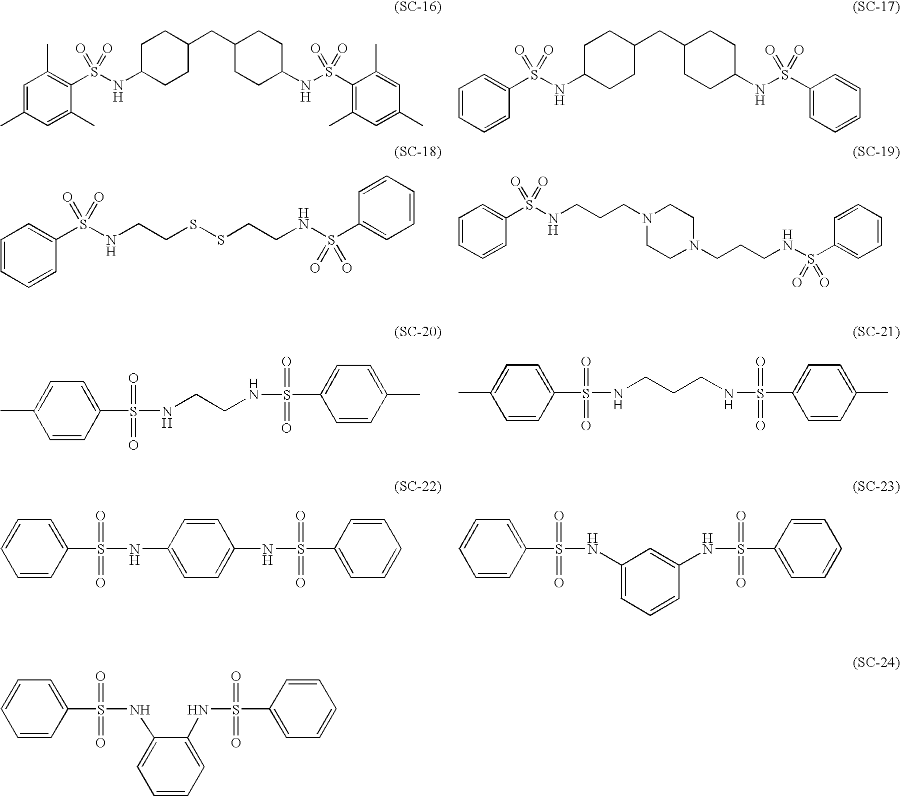

All the compounds for use in the invention can be produced from known compounds.

The compound represented by any one of the formulae (6), (6-1), and (6-2) is obtained by a condensation reaction of a sulfonyl chloride with a polyfunctional amine.

Of the compounds represented by the formulae (1) to (6) as retardation regulators for use in the invention, preferred are compounds represented by the formulae (1) to (3) and most preferred is compound represented by the formula (2).

Moreover, as the retardation regulators for use in the invention, the compounds having an octanol-water partition coefficient (log P value) of from 0 to 7 are preferred among the compounds of the formulae (1) to (6). When the log P value of the compound is 7 or less, compatibility with cellulose acylate is excellent and there arises no problem of occurrence of white turbidity and powder formation of films, so that the case is preferred. Moreover, when the log P value is 0 or more, the case is preferred since there arises no problem of deterioration of water resistance of cellulose acylate films, the problem being induced by too high hydrophilicity. More preferred range of the log P value is from 1 to 6 and particularly preferred range is from 1.5 to 5.

The measurement of the octanol-water partition coefficient (log P value) can be carried out by the flask-shaking method described in JIS Z-7260-107 (2000). Alternatively, the octanol-water partition coefficient (log P value) can be estimated by a chemical computing method or an empirical method instead of the actual measurement. As the computing method, Crippen's fragmentation method {“J. Chem. Inf. comput. Sci.”, Vol. 27, p. 21 (1987)}, Viswanadhan's fragmentation method {“J. Chem. Inf. comput. Sci.”, Vol. 29, p. 163 (1989)}, Broto's fragmentation method {“Eur. J. Med. Chem.-Chim. Theor.”, Vol. 19, p. 71 (1984)}, and the like are preferably employed and Crippen's fragmentation method is more preferred. In the case that the log P value of a certain compound is different depending on the measuring method or computing method, whether the compound falls within the above range or not is judged by the Crippen's fragmentation method.

The compounds of the above formulae (1) to (6) preferably have a molecular weight of from 150 to 3,000, more preferably from 170 to 2,000, particularly preferably from 200 to 1,000. When they have a molecular weight within the range, they may have a specific monomer structure or may be an oligomer structure or a polymer structure wherein plurality of the monomer units are combined.

The compounds of the formulae (1) to (6) are preferably liquid at 25° C. or solid having a melting point of 25 to 250° C., more preferably liquid at 25° C. or solid having a melting point of 25 to 200° C. Moreover, the compound lowering retardation is preferably not evaporated in the progress of dope casting and drying in the manufacture of cellulose acylate films.

The amount of the compounds of the formulae (1) to (6) to be added is preferably from 0.01 to 30% by mass, more preferably from 1 to 25% by mass, particularly preferably from 5 to 20% by mass relative to the cellulose acylate. (In this specification, parts by mass and % by mass (mass %) are equal to parts by mass and % by weight (weight %), respectively.)

The compounds of the formulae (1) to (6) may be used solely or as a mixture of two or more compounds in any ratio.

The timing of the addition of the compounds of the formulae (1) to (6) may be at any time during the dope preparation step and may be at the final stage of the dope preparation step.

It is preferred for the compounds of the formulae (1) to (6) that an average content of the compound in the film portion from the surface of at least one side to 10% of total film thickness of the cellulose acylate film is preferably from 80 to 99% of the average content of the compound in the central part of the film. The existing amount of the compound for use in the invention can be determined by measuring the amount of the compound at the surface and at the central part by the method using an IR spectrum described in JP-A-8-57879.

### [Ultraviolet (UV) Absorber]

The following will describe the UV absorber for use in the invention. The invention is characterized by combined use of the retardation regulator and the UV absorber. By incorporating the UV absorber in the film, it becomes possible to suppress decomposition and degradation of the retardation regulator by light. As a result, it becomes possible to provide a cellulose acylate film having a small change in optical anisotropy against exposure to light and an excellent light resistance.

The compound having absorption in a ultraviolet region of from 200 to 400 nm, i.e., a UV absorber has a property that absorbance at a longer wavelength side in the ultraviolet range of the absorption is larger than that at a shorter wavelength side.

On the other hand, values of Re and Rth of the cellulose acylate film generally have a wavelength dispersion property where the values are larger at a longer wavelength side of visible region than at a shorter wavelength side. Therefore, it is possible to smoothen the wavelength dispersion by increasing Re and Rth at a shorter wavelength side where the values are relatively small.

When the above compound itself is present isotropically inside the cellulose acylate film, the birefringence of the above compound itself and furthermore the wavelength dispersion of Re and Rth are presumed to be larger at a short wavelength side, similarly to the fact that absorbance is larger at a longer wavelength side of ultraviolet region, i.e., a shorter wavelength side of visible region.

Therefore, by using a compound having an absorption within an ultraviolet region of from 200 to 400 nm and being supposed that the wavelength dispersion of Re and Rth of the compound itself is large at a shorter wavelength side, the wavelength dispersion of Re and Rth of the cellulose acylate film can be controlled.

In the invention, the UV absorber preferably has at least one absorption maximum in the range of from 250 to 380 nm, and more preferably has at least one absorption maximum in the range of from 250 to 360 nm. Most preferred is to have at least one absorption maximum in the range of from 320 to 355 nm.

Specific examples of the UV absorber for use in the invention include known UV absorbers such as benzotriazole-based compounds, triazine compounds, benzophenone-based compounds, cyano group-containing compounds, sulfo-group containing compounds, oxybenzophenone-based compounds, salicylate ester-based compounds, and nickel complex salt-based compounds but the invention is not limited only to these compounds.

The UV absorber for use in the invention is preferably the compounds represented by the above formulae (7) to (9). Of the formulae (7) to (9), the compound represented by the formula (7) is more preferred.

The following will describe the UV absorber represented by the formula (7).

Q⁷¹-Q⁷²-OH Formula (7)

In the formula (7), Q⁷¹ represents a nitrogen-containing aromatic heterocycle and is preferably a 5- to 7-membered nitrogen-containing aromatic heterocycle, more preferably a 5- to 6-membered nitrogen-containing aromatic heterocycle.

Examples of preferred nitrogen-containing aromatic heterocycle include imidazole, pyrazole, triazole, tetrazole, thiazole, oxazole, selenazole, benzotriazole, benzothiazole, benzoxazole, benzoselenazole, thiadiazole, oxadiazole, naphthothiazole, naphthoxazole, azabenzimidazole, purine, pyridine, pyrazine, pyrimidine, pyridazine, triazine, triazaindene, and tetrazaindene. More preferred are triazine and 5-membered nitrogen-containing aromatic heterocycles. Specifically, preferred are 1,3,5-triazine, imidazole, pyrazole, triazole, tetrazole, thiazole, oxazole, benzotriazole, benzothiazole, benzoxazole, thiadiazole, and oxadiazole, and particularly preferred are 1,3,5-triazine and benzotriazole. Most preferred is 1,3,5-triazine.

The nitrogen-containing aromatic heterocycle represented by Q⁷¹ may further have a substituent. As the substituent, the above substituent T can be applied. Moreover, when plurality of the substituents are present, they can be condensed to further form a ring.

Q⁷² represents an aromatic ring. The aromatic ring represented by Q⁷² may be an aromatic hydrocarbon ring or an aromatic heterocycle. Moreover, they may be a single ring or may form a condensed ring together with another ring. The aromatic hydrocarbon ring is preferably a monocyclic or bicyclic aromatic hydrocarbon ring having 6 to 30 carbon atoms (e.g., benzene ring, naphthalene ring), more preferably an aromatic hydrocarbon ring having 6 to 20 carbon atoms, even more preferably an aromatic hydrocarbon ring having 6 to 12 carbon atoms. Further preferred is a benzene ring.

The aromatic heterocycle is preferably a nitrogen atom or sulfur atom-containing aromatic heterocycle. Specific examples of the heterocycle include thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phtharazine, naphthylidine, quinoxaline, quinazoline, cinnoline, pteridine, acridine, phenanthroline, phenazine, tetrazole, benzimidazole, benzoxazole, benzothiazole, benzotriazole, tetrazaindene. As the aromatic heterocycle, particularly preferred are pyridine, triazine, and quinoline.

The aromatic ring represented by Q⁷² is preferably an aromatic hydrocarbon ring, more preferably a naphthalene ring and a benzene ring, particularly preferably a benzene ring. Q⁷² may further have a substituent and the above substituent T is preferred.

The UV absorber represented by the formula (7) is a compound having a 1,3,5-triazine ring represented by the following formula (7-1).

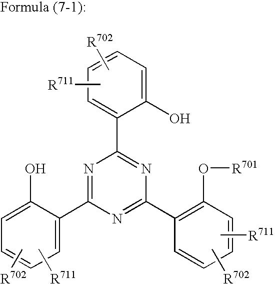

In the formula (7-1), R⁷⁰¹ represents an alkyl group having 1 to 18 carbon atoms; a cycloalkyl group having 5 to 12 carbon atoms; an alkenyl group having 3 to 18 carbon atoms; a phenyl group; an alkyl group having 1 to 18 carbon atoms substituted with a phenyl group, H, an alkoxy group having 1 to 18 carbon atoms, a cycloalkoxy group having 5 to 12 carbon atoms, an alkenyloxy group having 3 to 18 carbon atoms, a halogen atom, —COOH, —COOR⁷⁰⁴, —O—CO—R⁷⁰⁵, —O—CO—O—R⁷⁰⁶, —CO—NH₂, —CO—NHR⁷⁰⁷, —CO—N(R⁷⁰⁷)(R⁷⁰⁸), CN, NH₂, NHR⁷⁰⁷, —N(R⁷⁰⁷)(R⁷⁰⁸), —NH—CO—R⁷⁰⁵, a phenoxy group, a phenoxy group substituted with an alkyl group having 1 to 18 carbon atoms, a phenyl-C₁₋₄alkoxy group, a bicycloalkoxy group having 6 to 15 carbon atoms, a bicycloalkylalkoxy group having 6 to 15 carbon atoms, a bicycloalkenylalkoxy group having 6 to 15 carbon atoms, or a tricycloalkoxy group having 6 to 15 carbon atoms; a cycloalkyl group having 5 to 12 carbon atoms substituted with OH, an alkyl group having 1 to 4 carbon atoms, an alkenyl group having 2 to 6 carbon atoms, or —O—CO—R⁷⁰⁵; a glycidyl group; —CO—R⁷⁰⁹; or —SO₂—R⁷¹⁰; or represents an alkyl group having 3 to 50 carbon atoms interrupted with one or more oxygen atoms and/or substituted with OH, a phenoxy group, or an alkylphenoxy group having 7 to 18 carbon atoms; or represents -A⁷¹; —CH₂—CH(X⁷¹A⁷¹)—CH₂—O—R⁷¹²; —CR⁷¹³R′⁷¹³—(CH₂)ₘ—X⁷¹-A⁷¹; —CH₂—CH(OA⁷¹)—R⁷¹⁴; —CH₂—CH(OH)—CH₂—X⁷¹A⁷¹;

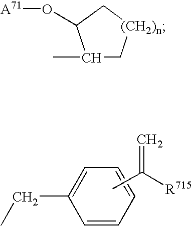

—CR⁷¹⁵R′⁷¹⁵—C(═CH₂)—R″⁷¹⁵; —CR⁷¹³R′⁷¹³—(CH₂)ₘ—CO—X⁷¹-A⁷¹; —CR⁷¹³R′⁷¹³—(CH₂)ₘ—CO—CR⁷¹⁵R′⁷¹³—C(═CH₂)—R″⁷¹⁵ or —CO—O—CR⁷¹⁵R′⁷¹⁵—C(═CH₂)—R″⁷¹⁵ {A⁷¹ represents —CO—CR⁷¹⁶=CH—R⁷¹⁷}.

R⁷⁰² each independently represents an alkyl group having 6 to 18 carbon atoms; an alkenyl group having 2 to 6 carbon atoms; a phenyl group; a phenylalkyl group having 7 to 11 carbon atoms; COOR⁷⁰⁴; CN; —NH—CO—R⁷⁰⁵; a halogen atom; a trifluoromethyl group; or —O—R⁷⁰³. R⁷⁰³ has the same meaning as defined for R⁷⁰¹. R⁷⁰⁴ represents an alkyl group having 1 to 18 carbon atoms; an alkenyl group having 3 to 18 carbon atoms; a phenyl group; a phenylalkyl group having 7 to 11 carbon atoms; a cycloalkyl group having 5 to 12 carbon atoms; or represents an alkyl group having 3 to 50 carbon atoms interrupted with one or more —O—, —NH—, —NR⁷⁰⁷—, or —S— and/or substituted with OH, a phenoxy group, or an alkylphenoxy group having 7 to 18 carbon atoms.

R⁷⁰⁵ represents H; an alkyl group having 1 to 18 carbon atoms; an alkenyl group having 2 to 18 carbon atoms; a cycloalkyl group having 5 to 12 carbon atoms; a phenyl group; a phenylalkyl group having 7 to 11 carbon atoms; a bicycloalkyl group having 6 to 15 carbon atoms; a bicycloalkenyl group having 6 to 15 carbon atoms; or a tricycloalkyl group having 6 to 15 carbon atoms. R⁷⁰⁶ represents H; an alkyl group having 1 to 18 carbon atoms; an alkenyl group having 3 to 18 carbon atoms; a phenyl group; a phenylalkyl group having 7 to 11 carbon atoms; or a cycloalkyl group having 5 to 12 carbon atoms. R⁷⁰⁷ and R⁷⁰⁸ each independently represents an alkyl group having 1 to 12 carbon atoms; an alkoxyalkyl group having 3 to 12 carbon atoms; a dialkylaminoalkyl group having 4 to 16 carbon atoms; or a cycloalkyl group having 5 to 12 carbon atoms; or R⁷⁰⁷ and R⁷⁰⁸ are combined together to form an alkylene group having 3 to 9 carbon atoms, an oxaalkylene group having 3 to 9 carbon atoms, or an azaalkylene group having 3 to 9 carbon atoms.

R⁷⁰⁹ represents an alkyl group having 1 to 18 carbon atoms; an alkenyl group having 2 to 18 carbon atoms; a phenyl group; a cycloalkyl group having 5 to 12 carbon atoms; a phenylalkyl group having 7 to 11 carbon atoms; a bicycloalkyl group having 6 to 15 carbon atoms; a bicycloalkylalkyl group having 6 to 15 carbon atoms; a bicycloalkenyl group having 6 to 15 carbon atoms; or a tricycloalkyl group having 6 to 15 carbon atoms. R⁷¹⁰ represents an alkyl group having 1 to 12 carbon atoms; a phenyl group; a naphthyl group; or a phenylalkyl group having 7 to 14 carbon atoms.

R⁷¹¹ each independently represents H; an alkyl group having 1 to 18 carbon atoms; an alkenyl group having 3 to 6 carbon atoms; a phenylalkyl group having 7 to 111 carbon atoms; a halogen atom; or an alkoxy group having 1 to 18 carbon atoms.

R⁷¹² represents an alkyl group having 1 to 18 carbon atoms; an alkenyl group having 3 to 18 carbon atoms; a phenyl group; a phenyl group substituted once to three times with an alkyl group having 1 to 8 carbon atoms, an alkoxy group having 1 to 8 carbon atoms, an alkenoxy group having 3 to 8 carbon atoms, a halogen atom, or a trifluoromethyl group; a phenylalkyl group having 7 to 11 carbon atoms; a cycloalkyl group having 5 to 12 carbon atoms; a tricycloalkyl group having 6 to 15 carbon atoms; a bicycloalkyl group having 6 to 15 carbon atoms; a bicycloalkylalkyl group having 6 to 15 carbon atoms; a bicycloalkenylalkyl group having 6 to 15 carbon atoms; or —CO—R⁷⁰⁵; or R⁷¹² represents an alkyl group having 3 to 50 carbon atoms which is interrupted with one or more —O—, —NH—, —NR⁷⁰⁷—, or —S— and may be substituted with OH, a phenoxy group, or an alkylphenoxy group having 7 to 18 carbon atoms.

R⁷¹³ and R′⁷¹³ each independently represents H; an alkyl group having 1 to 18 carbon atoms; or a phenyl group. R⁷¹⁴ represents an alkyl group having 1 to 18 carbon atoms; an alkoxyalkyl group having 3 to 12 carbon atoms; a phenyl group; or a phenyl-C₁₋₄alkyl group. R⁷¹⁵, R′⁷¹⁵, and R″⁷¹⁵ each independently represents H or CH₃. R⁷¹⁶ represents H; —CH₂—COO—R⁷⁰⁴; an alkyl group having 1 to 4 carbon atoms; or CN. R¹⁷⁷ represents H; —COOR⁷⁰⁴; an alkyl group having 1 to 17 carbon atoms; or a phenyl group.

X⁷¹ represents —NH—; —NR⁷⁰⁷—; —O—; —NH—(CH₂)ₚ—NH—; or —O—(CH₂)ₚ—NH—. The index m represents an integer of from 0 to 19; n represents an integer of from 1 to 8; p represents an integer of from 0 to 4; and q represents an integer of from 2 to 4. In the formula (7-2), at least one of the groups R⁷⁰¹, R⁷⁰², and R⁷¹¹ contains two or more carbon atoms.

Furthermore, the compound (7-1) will be described.

The groups R⁷⁰¹ to R⁷¹⁰, R⁷¹² to R⁷¹⁴, R⁷¹⁶, and R⁷¹⁷ each is a linear or branched alkyl group and is, for example, a methyl group, an ethyl group, a propyl group, an isopropyl group, an n-butyl group, an s-butyl group, an isobutyl group, a t-butyl group, a 2-ethylbutyl group, an n-pentyl group, an isopentyl group, a 1-methylpentyl group, a 1,3-dimethylbutyl group, an n-hexyl group, a 1-methylhexyl group, an n-heptyl group, an isoheptyl group, a 1,1,3,3-tetramethylbutyl group, a 1-methylheptyl group, a 3-methylheptyl group, an n-octyl group, a 2-ethylhexyl group, a 1,1,3-trimethylhexyl group, a 1,1,3,3-tetramethylpentyl group, a nonyl group, a decyl group, an undecyl group, a 1-methylundecyl group, a dodecyl group, a 1,1,3,3,5,5-hexamethylhexyl group, a tridecyl group, a tetradecyl group, a pentadecyl group, a hexadecyl group, a heptadecyl group, or an octadecyl group.

R⁷⁰¹, R⁷⁰³ to R⁷⁰⁹, and R⁷¹² as cycloalkyl groups having 5 to 12 carbon atoms each is, for example, a cyclopentyl group, a cyclohexyl group, a cycloheptyl group, a cyclooctyl group, a cyclononyl group, a cyclodecyl group, a cycloundecyl group, or a cyclododecyl group. Preferred are a cyclopentyl group, a cyclohexyl group, a cyclooctyl group, and a cyclododecyl group.

R⁷⁰⁶, R⁷⁰⁹, R⁷¹¹ and R⁷¹² as alkenyl groups each particularly include an allyl group, an isopropenyl group, a 2-butenyl group, a 3-butenyl group, an isobutenyl group, an n-penta-2,4-dienyl group, a 3-methyl-but-2-enyl group, an n-oct-2-enyl group, an n-dodec-2-enyl group, an isododecenyl group, an n-dodec-2-enyl group, and an n-octadec-4-enyl group.

The substituted alkyl group, cycloalkyl group, or phenyl group may be substituted once or more times, and on the carbon atom to which the group is bonded (at an α-position) or on the other carbon atom, the group can possess a substituent. In the case that the substituent is bonded through a heteroatom (e.g., an alkoxy group), the bond is preferably not at an α-position and the substituted alkyl group contains two, particularly three or more carbon atoms. When two or more substituents are present, those substituents are preferably bonded to different carbon atoms.

When an alkyl group is interrupted with —O—, —NH—, —NR¹⁰⁷—, or —S—, the alkyl group may be interrupted with one or more of these groups and in each case, generally, one group is inserted in one bond and a hetero-hetero bond, e.g., —O—, S—S, NH—NH, or the like is not formed; in the case that the interrupted alkyl group is further substituted, it is suitable that the substituent is generally present not at an α-position to the heteroatom. In the case that two or more interrupting groups of —O—, —NH—, —NR⁷⁰⁷—, or —S— type are present, they are suitably the same.

The aryl group is generally an aromatic hydrocarbon group and is, for example, a phenyl group, a biphenylyl group, or a naphthyl group, preferably a phenyl group or a biphenylyl group. The aralkyl group is an alkyl group generally substituted with an aryl group, especially a phenyl group. Accordingly, an aralkyl group having 7 to 20 carbon atoms includes a benzyl group, an α-methylbenzyl group, a phenylethyl group, a phenylpropyl group, a phenylbutyl group, a phenylpentyl group, and a phnylhexyl group; and the phenylalkyl group having 7 to 11 carbon atom is preferably a benzyl group, an α-methylbenzyl group, or an α,α-dimethylbenzyl group.

The alkylphenyl group and alkylphenoxy group are a phenyl group or phenoxy group substituted with an alkyl group, respectively.

The halogen atom to be a halogen substituent is a fluorine atom, a chlorine atom, a bromine atom, or an iodine atom, more preferred is a fluorine atom or a chlorine atom, and particularly preferred is a chlorine atom.

The alkylene group having 1 to 20 carbon atoms is, for example, a methylene group, an ethylene group, a propylene group, a butylene group, a pentylene group, or a hexylene group. The alkyl chain is also a branched one, such as an isopropylene group.

The cycloalkenyl group having 4 to 12 carbon atoms is, for example, a 2-cyclobut-2-enyl group, a 2-cylopent-2-enyl group, a 2,4-cyclopentadien-2-yl group, a 2-cyclohex-1-enyl group, a 2-cyclohepten-1-yl group, or a 2-cycloocten-1-yl group.

The bicycloalkyl group having 6 to 15 carbon atoms is, for example, a bornyl group, norbornyl group, or [2.2.2]bicyclooctyl group. A bornyl group and a norbornyl group, especially a bornyl group and a norborn-2-yl group are preferred.

The bicycloalkoxy group having 6 to 15 carbon atoms is, for example, a bornyloxy group or a norborn-2-yloxy group.

The bicycloalkyl-alkyl or -alkoxy group having 6 to 15 carbon atoms is an alkyl group or alkoxy group substituted with a bicycloalkyl group and having 6 to 15 carbon atoms in total. Specific examples include a norbornan-2-methyl group and a norbornyl-2-methoxy group.

The bicycloalkenyl group having 6 to 15 carbon atoms is, for example, a norbornenyl group or a norbornadienyl group. Preferred is a norbornenyl group, especially a norborn-5-enyl group.

The bicycloalkenylalkoxy group having 6 to 15 carbon atoms is an alkoxy group substituted with a bicycloalkenyl group and having 6 to 15 carbon atoms in total. A specific example is a norborn-5-ene-2-methoxy group.

The tricycloalkyl group having 6 to 15 carbon atoms is, for example, a 1-adamantyl group or a 2-adamantyl group. Preferred is a 1-adamantyl group.

The tricycloalkoxy group having 6 to 15 carbon atoms is, for example, an adamantyloxy group. The heteroaryl group having 3 to 12 carbon atoms is preferably a pyridyl group, a pyrimidinyl group, a triazinyl group, a pyrrolyl group, a furanyl group, a thiophenyl group or a quinonyl group.

In the more preferred compound represented by the formula (7-1), R⁷⁰¹ represents an alkyl group having 1 to 18 carbon atoms; a cycloalkyl group having 5 to 12 carbon atoms; an alkenyl group having 3 to 12 carbon atoms; a phenyl group; an alkyl group having 1 to 18 carbon atoms substituted with a phenyl group, H, an alkoxy group having 1 to 18 carbon atoms, a cycloalkoxy group having 5 to 12 carbon atoms, an alkenyloxy group having 3 to 18 carbon atoms, a halogen atom, —COOH, —COOR⁷⁰⁴, —O—CO—R⁷⁰⁵, —O—CO—O—R⁷⁰⁶, —CO—NH₂, —CO—NHR⁷⁰⁷, —CO—N(R⁷⁰⁷)(R⁷⁰⁸), CN, NH₂, NHR⁷⁰⁷, —N(R⁷⁰⁷)(R⁷⁰), —NH—CO—R⁷⁰⁵, a phenoxy group, a phenoxy group substituted with an alkyl group having 1 to 18 carbon atoms, a phenyl-C₁₋₄alkoxy group, a bornyloxy group, a norborn-2-yloxy group, a norbornyl-2-methoxy group, a norborn-5-en-2-methoxy group, or an adamantyloxy group; a cycloalkyl group having 5 to 12 carbon atoms substituted with OH, an alkyl group having 1 to 4 carbon atoms, an alkenyl group having 2 to 6 carbon atoms, and/or —O—CO—R⁷⁰⁵; a glycidyl group; —CO—R⁷⁰⁹; or —SO₂—R⁷¹⁰; or represents an alkyl group having 3 to 50 carbon atoms interrupted with one or more oxygen atoms and/or substituted with OH, a phenoxy group, or an alkylphenoxy group having 7 to 18 carbon atoms; or represents any of -A⁷¹; —CH₂—CH(X⁷¹A⁷¹)—CH₂—O—R⁷¹²; —CR⁷¹³R′⁷¹³—(CH₂)ₘ—X⁷¹-A⁷¹; —CH₂—CH(OA⁷¹)—R⁷¹⁴; —CH₂—CH(OH)—CH₂—X⁷¹A⁷¹;

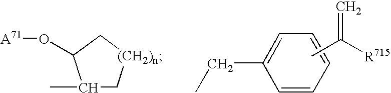

—CR⁷¹⁵R′⁷¹⁵—C(═CH₂)—R¹⁷¹⁵; —CR⁷¹³R′⁷¹³—(CH₂)ₘ—CO—X⁷¹-A⁷¹; —CR⁷¹³R′⁷¹³—(CH₂)ₘ—CO—O—CR⁷¹⁵R′⁷¹⁵—C(═CH₂)—R″⁷¹⁵ or —CO—O—CR⁷¹⁵R′⁷¹⁵—C(═CH₂)—R″⁷¹⁵ (wherein A⁷¹ represents —CO—CR⁷¹⁶=CH—R⁷¹⁷). R⁷⁰² represents an alkyl group having 6 to 18 carbon atoms; an alkenyl group having 2 to 6 carbon atoms; a phenyl group; —O—R⁷⁰³ or —NH—CO—R⁷⁰⁵. R⁷⁰³ each independently has the same meaning as defined for R⁷⁰¹.

R⁷⁰⁴ represents an alkyl group having 1 to 18 carbon atoms; an alkenyl group having 3 to 18 carbon atoms; a phenyl group; a phenylalkyl group having 7 to 11 carbon atoms; a cycloalkyl group having 5 to 12 carbon atoms; or R⁷⁰⁴ represents an alkyl group having 3 to 50 carbon atoms which is interrupted with one or more —O—, —NH—, —NR⁷⁰⁷—, or —S— and may be substituted with OH, a phenoxy group, or an alkylphenoxy group having 7 to 18 carbon atoms.

R⁷⁰⁵ represents H; an alkyl group having 1 to 18 carbon atoms; an alkenyl group having 2 to 18 carbon atoms; a cycloalkyl group having 5 to 12 carbon atoms; a phenyl group; a phenylalkyl group having 7 to 11 carbon atoms; a norborn-2-yl group, a norborn-5-en-2-yloxy group, or an adamantyl group. R⁷⁰⁶ represents H; an alkyl group having 1 to 18 carbon atoms; an alkenyl group having 3 to 18 carbon atoms; a phenyl group; a phenylalkyl group having 7 to 11 carbon atoms; or a cycloalkyl group having 5 to 12 carbon atoms.

R⁷⁰⁷ and R⁷⁰⁸ each independently represents an alkyl group having 1 to 12 carbon atoms; an alkoxyalkyl group having 3 to 12 carbon atoms; a dialkylaminoalkyl group having 4 to 16 carbon atoms; or a cycloalkyl group having 5 to 12 carbon atoms; or R⁷⁰⁷ and R⁷⁰⁸ are combined together to form an alkylene group having 3 to 9 carbon atoms, an oxaalkylene group having 3 to 9 carbon atoms, or an azaalkylene group having 3 to 9 carbon atoms. R⁷⁰⁹ represents an alkyl group having 1 to 18 carbon atoms; an alkenyl group having 2 to 18 carbon atoms; a phenyl group; a cycloalkyl group having 5 to 12 carbon atoms; a phenylalkyl group having 7 to 11 carbon atoms; a norborn-2-yl group, a norborn-5-en-2-yloxy group, or an adamantyl group.

R⁷¹⁰ represents an alkyl group having 1 to 12 carbon atoms; a phenyl group; a naphthyl group; or a phenylalkyl group having 7 to 14 carbon atoms. R⁷¹ each independently represents H; an alkyl group having 1 to 18 carbon atoms; or a phenylalkyl group having 7 to 11 carbon atoms.

R⁷¹² represents an alkyl group having 1 to 18 carbon atoms; an alkenyl group having 3 to 18 carbon atoms; a phenyl group; a phenyl group substituted once to three times with an alkyl group having 1 to 8 carbon atoms, an alkoxy group having 1 to 8 carbon atoms, an alkenoxy group having 3 to 8 carbon atoms, a halogen atom, or a trifluoromethyl group; or a phenylalkyl group having 7 to 11 carbon atoms; a cycloalkyl group having 5 to 12 carbon atoms; a 1-adamantyl group; a 2-adamantyl group; a norbornyl group; a norbornan-2-methyl-; or —CO—R⁷⁰⁵; or R⁷¹² represents an alkyl group having 3 to 50 carbon atoms which is interrupted with one or more —O—, —NH—, —NR⁷⁰⁷—, or —S— and may be substituted with OH, a phenoxy group, or an alkylphenoxy group having 7 to 18 carbon atoms.

R⁷¹³ and R′⁷¹³ each independently represents H; an alkyl group having 1 to 18 carbon atoms; or a phenyl group. R⁷¹⁴ represents an alkyl group having 1 to 18 carbon atoms; an alkoxyalkyl group having 3 to 12 carbon atoms; a phenyl group; or a phenyl-C₁₋₄alkyl group. R⁷¹⁵, R′⁷¹⁵, and R″⁷¹⁵ each independently represents H or CH₃. R⁷¹⁶ represents H; —CH₂—COO—R⁷⁰⁴; an alkyl group having 1 to 4 carbon atoms; or CN. R⁷¹⁷ represents H; —COOR⁷⁰⁴; an alkyl group having 1 to 17 carbon atoms; or a phenyl group.

X⁷¹ represents —NH—; —NR⁷¹⁷—; —O—; —NH—(CH₂)ₚ—NH—; or —O—(CH₂)ₚ—NH—. The index m represents an integer of from 0 to 19; n represents an integer of from 1 to 8; p represents an integer of from 0 to 4; and q represents an integer of from 2 to 4.

The compounds represented by the formulae (7) and (7-1) can be obtained similarly to known compounds by Friedel-Crafts addition of a halotriazine to a corresponding phenol according to conventional methods, for example methods described in publications such as European Patent No. 434608 or H. Brunetti and C. E. Luthi, “Helv. Chim. Acta”, Vol. 55, p. 1566 (1072) or similarly thereto.

Next, the following will show preferred examples of the compounds represented by the formulae (7) and (7-1) but the invention is not limited to these specific examples.

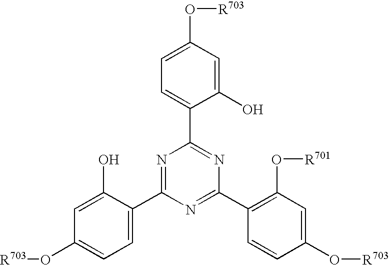

| Compound No. | R⁷⁰³ | R⁷⁰¹ |
|---|---|---|
| UV-1 | —CH₂CH(OH)CH₂OC₄H₉(-n) | —CH₃ |
| UV-2 | —CH₂CH(OH)CH₂OC₄H₉(-n) | —C₂H₅ |
| UV-3 | R⁷⁰³═R¹⁰¹: —CH₂CH(OH)CH₂OC₄H₉(-n) | |
| UV-4 | —CH(CH₃)—CO—O—C₂H₅ | —C₂H₅ |
| UV-5 | R⁷⁰³═R⁷⁰¹: —CH(CH₃)—CO—C₂H₅ | |
| UV-6 | —C₂H₅ | —C₂H₅ |
| UV-7 | —CH₂CH(OH)CH₂OC₄H₉(-n) | —CH(CH₃)₂ |
| UV-8 | —CH₂CH(OH)CH₂OC₄H₉(-n) | —CH(CH₃)—C₂H₅ |
| UV-9 | R⁷⁰³═R⁷⁰¹: —CH₂CH(C₂H₅)—C₄H₉(-n) | |
| UV-10 | —C₈H₁₇(-n) | —C₈H₁₇(-n) |
| UV-11 | —C₃H₇(-n) | —CH₃ |
| UV-12 | —C₃H₇(-n) | —C₂H₅ |
| UV-13 | —C₃H₇(-n) | —C₃H₇(-n) |
| UV-14 | —C₃H₇(-i) | —CH₃ |
| UV-15 | —C₃H₇(-i) | —C₂H₅ |
| UV-16 | —C₃H₇(-i) | —C₃H₇(-i) |
| UV-17 | —C₄H₉(-n) | —CH₃ |
| UV-18 | —C₄H₉(-n) | —C₂H₅ |
| UV-19 | —C₄H₉(-n) | —C₄H₉(-n) |
| UV-20 | —CH₂CH(CH₃)₂ | —CH₃ |
| UV-21 | —CH₂CH(CH₃)₂ | —C₂H₅ |
| UV-22 | —CH₂CH(CH₃)₂ | —CH₂CH(CH₃)₂ |
| UV-23 | —C₆H₁₃(-n) | —CH₃ |
| UV-24 | —C₆H₁₃(-n) | —C₂H₅ |
| UV-25 | —C₆H₁₃(-n) | —C₈H₁₃(-n) |
| UV-26 | —C₇H₁₅(-n) | —CH₃ |
| UV-27 | —C₇H₁₅(-n) | —C₂H₅ |
| UV-28 | —C₇H₁₅(-n) | —C₇H₁₅(-n) |
| UV-29 | —C₈H₁₇(-n) | —CH₃ |
| UV-30 | —C₈H₁₇(-n) | —C₂H₅ |
| UV-31 | —CH₂CH₂CH(CH₃)₂ | —CH₂CH₂CH(CH₃)₂ |
| UV-32 | —C₅H₁₁(-n) | —C₅H₁₁(-n) |
| UV-33 | —C₁₂H₂₅(-n) | —C₁₂H₂₅(-n) |
| UV-34 | —C₁₆H₃₇(-n) | —C₂H₅ |
| UV-35 | —CH₂—CO—O—C₂H₅ | —CH₂—CO—O—C₂H₅ |

| | |
|---|---|
| (UV-36) | 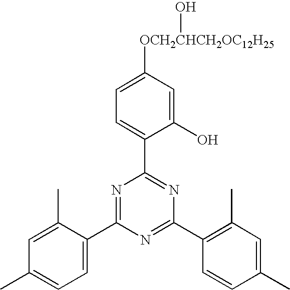 |
| (UV-37) | 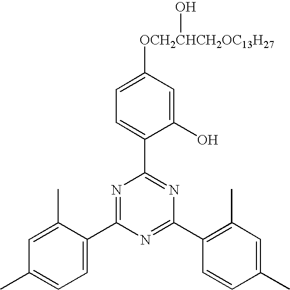 |
| (UV-38) | 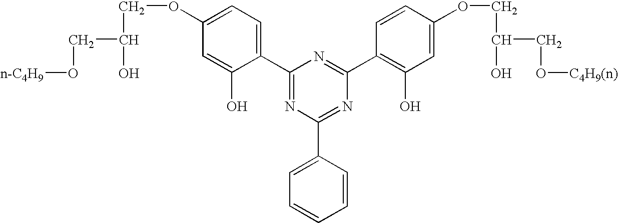 |
| (UV-39) | 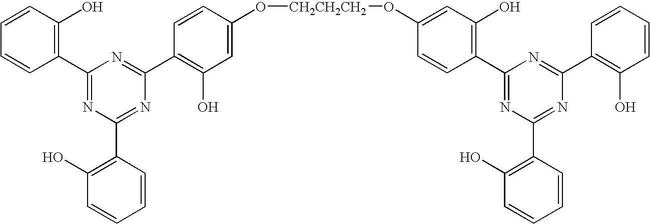 |
| (UV-40) | 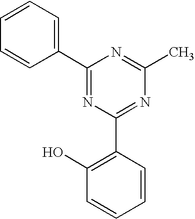 |
| (UV-41) | 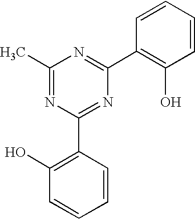 |

As preferred compounds of the UV absorber represented by the above formula (7), there may be mentioned a compound represented by the following formula (7-2) in addition to the compound represented by the formula (7-1).

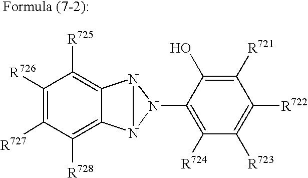

In the above formula (7-2), R²¹, R⁷²², R⁷²³, R⁷²⁴, R⁷²⁵, R⁷²⁶, R⁷²⁷ and R⁷²⁸ each independently represents a hydrogen atom or a substituent and as the substituent, the above substituent T can be applied. Moreover, these substituents may be further substituted with another substituent and the substituents themselves may be condensed to form a ring structure.

R⁷²¹ and R⁷²³ each is preferably a hydrogen atom, an alkyl group, an alkenyl group, an alkynyl group, an aryl group, a substituted or unsubstituted amino group, an alkoxy group, an aryloxy group, a hydroxyl group, or a halogen atom, more preferably a hydrogen atom, an alkyl group, an aryl group, an alkyloxy group, an aryloxy group, a hydroxyl group, or a halogen atom, and particularly preferably an alkyl group having 1 to 12 carbon atoms (preferably 4 to 12 carbon atoms).

R⁷²² and R⁷²⁴ each is preferably a hydrogen atom, an alkyl group, an alkenyl group, an alkynyl group, an aryl group, a substituted or unsubstituted amino group, an alkoxy group, an aryloxy group, a hydroxyl group, or a halogen atom, more preferably a hydrogen atom, an alkyl group, an aryl group, an alkyloxy group, an aryloxy group, or a halogen atom, even more preferably a hydrogen atom or an alkyl group having 1 to 12 carbon atoms, particularly preferably a hydrogen atom or a methyl group, and most preferably a hydrogen atom.

R⁷²⁵ and R⁷²⁸ each is preferably a hydrogen atom, an alkyl group, an alkenyl group, an alkynyl group, an aryl group, a substituted or unsubstituted amino group, an alkoxy group, an aryloxy group, a hydroxyl group, or a halogen atom, more preferably a hydrogen atom, an alkyl group, an aryl group, an alkyloxy group, an aryloxy group, or a halogen atom, even more preferably a hydrogen atom or an alkyl group having 1 to 12 carbon atoms, particularly preferably a hydrogen atom or a methyl group, and most preferably a hydrogen atom.

R⁷²⁶ and R⁷²⁷ each is preferably a hydrogen atom, an alkyl group, an alkenyl group, an alkynyl group, an aryl group, a substituted or unsubstituted amino group, an alkoxy group, an aryloxy group, a hydroxyl group, or a halogen atom, more preferably a hydrogen atom, an alkyl group, an aryl group, an alkyloxy group, an aryloxy group, or a halogen atom, even more preferably a hydrogen atom or a halogen atom, and particularly preferably a hydrogen atom or a chlorine atom.

The following will show specific examples of the compound represented by the formula (7-2) but the invention is not limited to the following specific examples.

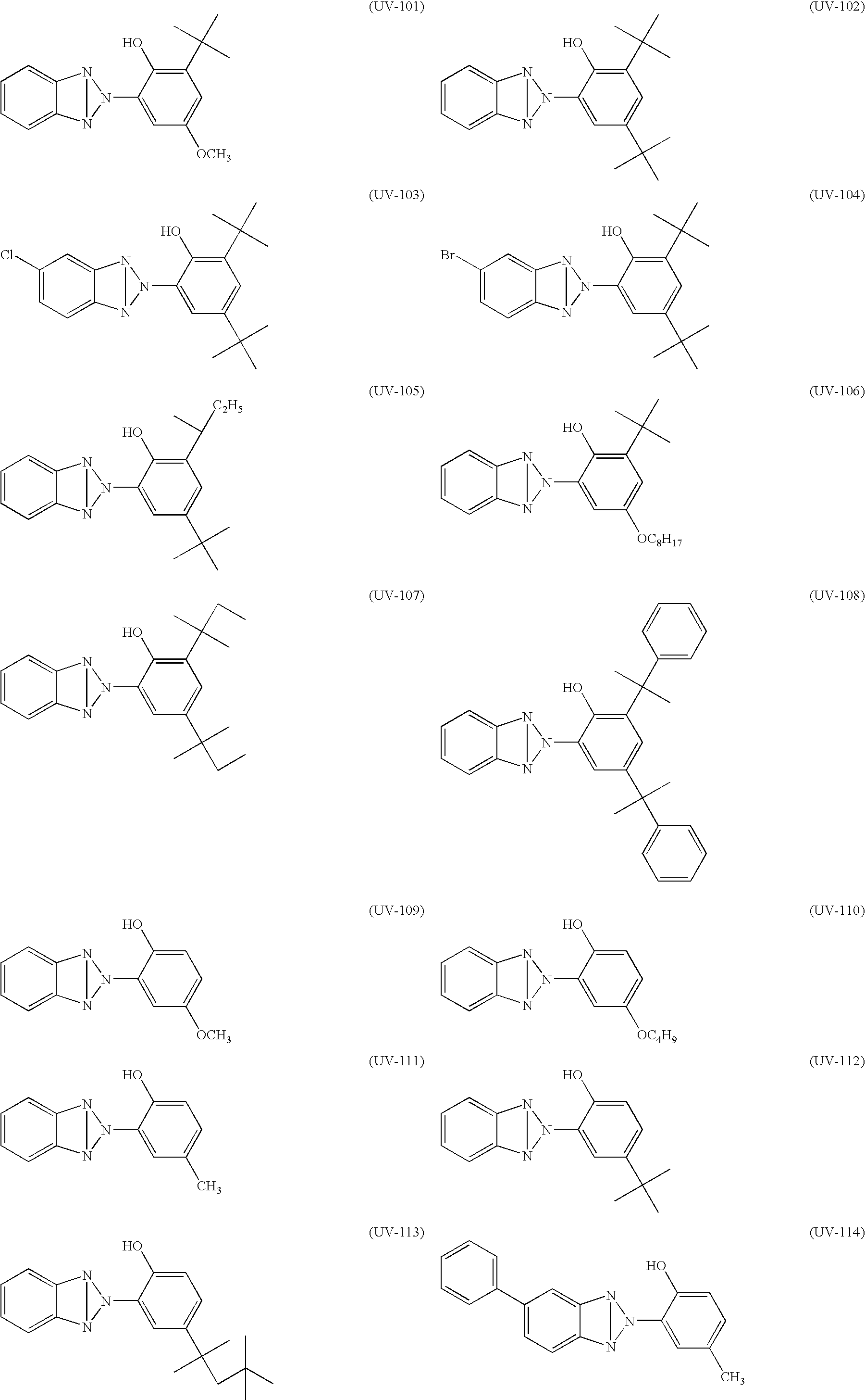

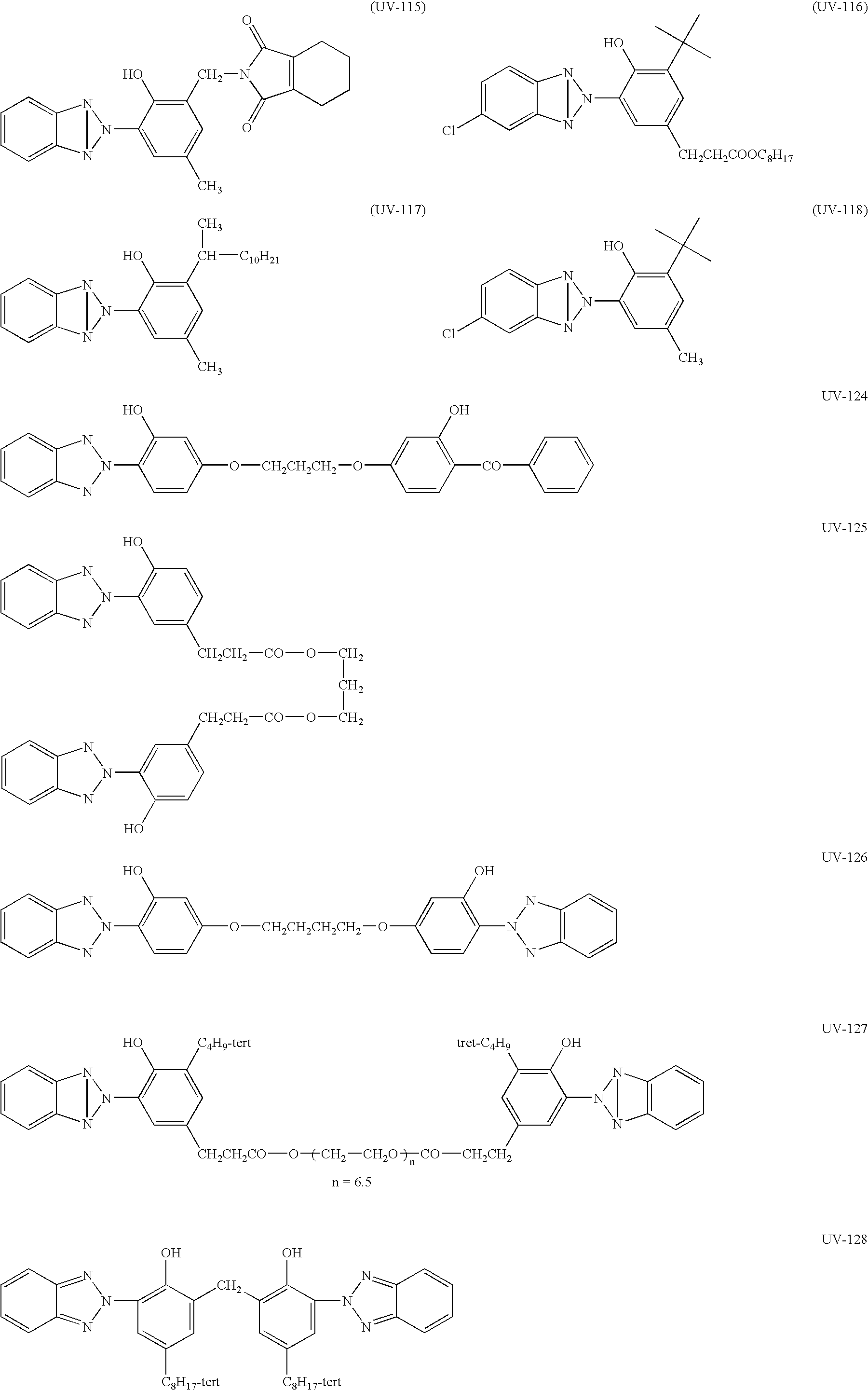

Next, the following will show specific examples of UV absorbers which are not included in the formulae (7-1) and (7-2) but can be suitably used in the invention.

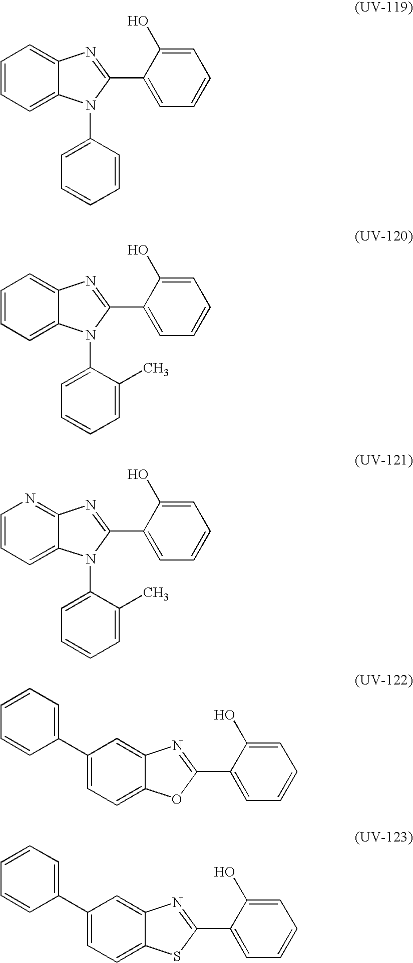

A UV absorber represented by the formula (8) will be described.

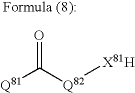

In the above formula (8), Q⁸¹ and Q⁸² each independently represents an aromatic ring. The aromatic ring represented by Q⁸¹ and Q⁸² may be an aromatic hydrocarbon ring or an aromatic heterocycle. Moreover, they may be a single ring or may form a condensed ring together with another ring.

The aromatic hydrocarbon ring represented by Q⁸¹ and Q⁸² is preferably a monocyclic or bicyclic aromatic hydrocarbon ring having 6 to 30 carbon atoms (e.g., benzene ring, naphthalene ring), more preferably an aromatic hydrocarbon ring having 6 to 20 carbon atoms, even more preferably an aromatic hydrocarbon ring having 6 to 12 carbon atoms. Particularly preferred is a benzene ring.

The aromatic heterocycle represented by Q⁸¹ and Q⁸² is preferably an aromatic heterocycle containing at least one of an oxygen atom, a nitrogen atom, and a sulfur atom. Specific examples of the aromatic heterocycle include furan, pyrrole, thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phtharazine, naphthylidine, quinoxaline, quinazoline, cinnoline, pteridine, acridine, phenanthroline, phenazine, tetrazole, benzimidazole, benzoxazole, benzothiazole, benzotriazole, tetrazaindene. As the aromatic heterocycle, preferred are pyridine, triazine, and quinoline.

The aromatic ring represented by Q⁸¹ and Q⁸² is preferably an aromatic hydrocarbon ring, more preferably an aromatic hydrocarbon ring having 6 to 10 carbon atoms, even more preferably a substituted or unsubstituted benzene ring.

Q⁸¹ and Q⁸² may further have a substituent and the above substituent T is preferred as the substituent but the substituent does not contain a carboxylic acid, sulfonic acid, or quaternary ammonium salt group. Moreover, if possible, the substituents may be combined each other to form a ring structure.

X⁸¹ represents NR⁸¹ (wherein R⁸¹ represents a hydrogen atom or a substituent and the above substituent T can be applied as the substituent), an oxygen atom, or a sulfur atom. Preferred as X⁸¹ is NR⁸¹ (wherein R⁸¹ is preferably an acyl group or a sulfonyl group and these substituents may be further substituted) or an oxygen atom, and particularly preferred is an oxygen atom.

As the formula (8), preferred is a compound represented by the following formula (8-1).

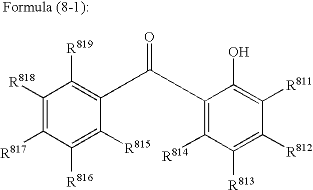

In the formula, R⁸¹¹, R⁸¹², R⁸¹³, R⁸¹⁴, R⁸¹⁵, R⁸¹⁶, R⁸¹⁷, R⁸¹⁸, and R⁸¹⁹ each independently represents a hydrogen atom or a substituent and as the substituent, the above substituent T can be applied. Moreover, these substituents may be further substituted with another substituent and the substituents may be condensed each other to form a ring structure.

R⁸¹¹, R⁸¹², R⁸¹³, R⁸¹⁴, R⁸¹⁵, R⁸¹⁶, R⁸¹⁸, and R⁸¹⁹ each is preferably a hydrogen atom, an alkyl group, an alkenyl group, an alkynyl group, an aryl group, a substituted or unsubstituted amino group, an alkoxy group, an aryloxy group, a hydroxyl group, or a halogen atom, more preferably a hydrogen atom, an alkyl group, an aryl group, an alkyloxy group, an aryloxy group, or a halogen atom, even more preferably a hydrogen atom or an alkyl group having 1 to 12 carbon atoms, particularly preferably a hydrogen atom or a methyl group, and most preferably a hydrogen atom.

R⁸¹² is preferably a hydrogen atom, an alkyl group, an alkenyl group, an alkynyl group, an aryl group, a substituted or unsubstituted amino group, an alkoxy group, an aryloxy group, a hydroxyl group, or a halogen atom, more preferably a hydrogen atom, an alkyl group having 1 to 20 carbon atoms, an amino group having 0 to 20 carbon atoms, an alkoxy group having 1 to 12 carbon atoms, an aryloxy group having 6 to 12 carbon atoms, or a hydroxyl group, even more preferably an alkoxy group having 1 to 20 carbon atoms, particularly preferably an alkoxy group having 1 to 12 carbon atoms.

R⁸¹⁷ is preferably a hydrogen atom, an alkyl group, an alkenyl group, an alkynyl group, an aryl group, a substituted or unsubstituted amino group, an alkoxy group, an aryloxy group, a hydroxyl group, or a halogen atom, more preferably a hydrogen atom, an alkyl group having 1 to 20 carbon atoms, an amino group having 0 to 20 carbon atoms, an alkoxy group having 1 to 12 carbon atoms, an aryloxy group having 6 to 12 carbon atoms, or a hydroxyl group, even more preferably a hydrogen atom or an alkyl group having 1 to 20 carbon atoms (preferably one having 1 to 12 carbon atoms, more preferably one having 1 to 8 carbon atoms, even more preferably a methyl group), and particularly preferably a methyl group or a hydrogen atom.

The compounds represented by the formulae (8) and (8-1) can be synthesized by the known method described in JP-A-11-12219.

The following will show specific examples of the compound represented by the formula (8) or (8-1) but the invention is not limited to the following specific examples.

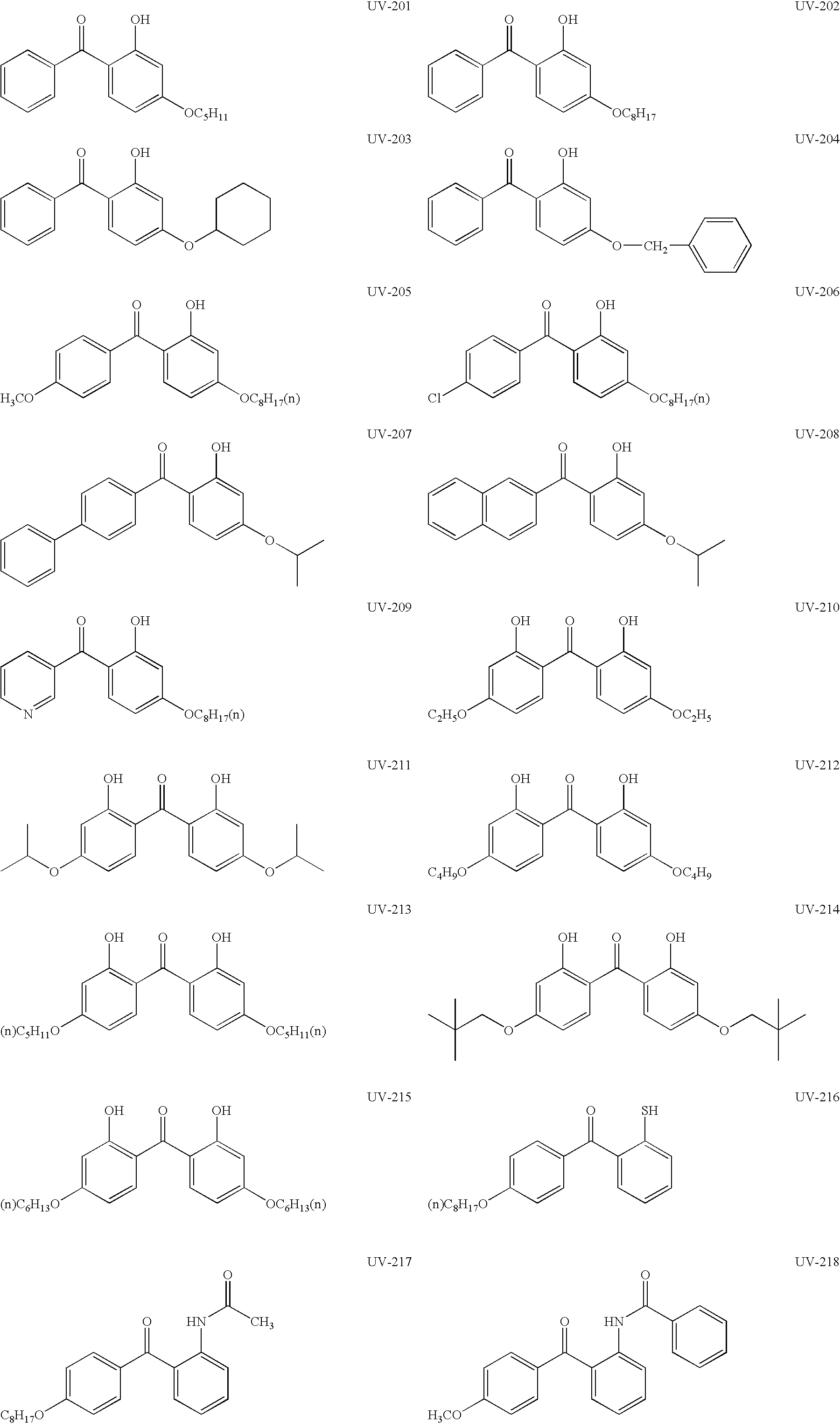

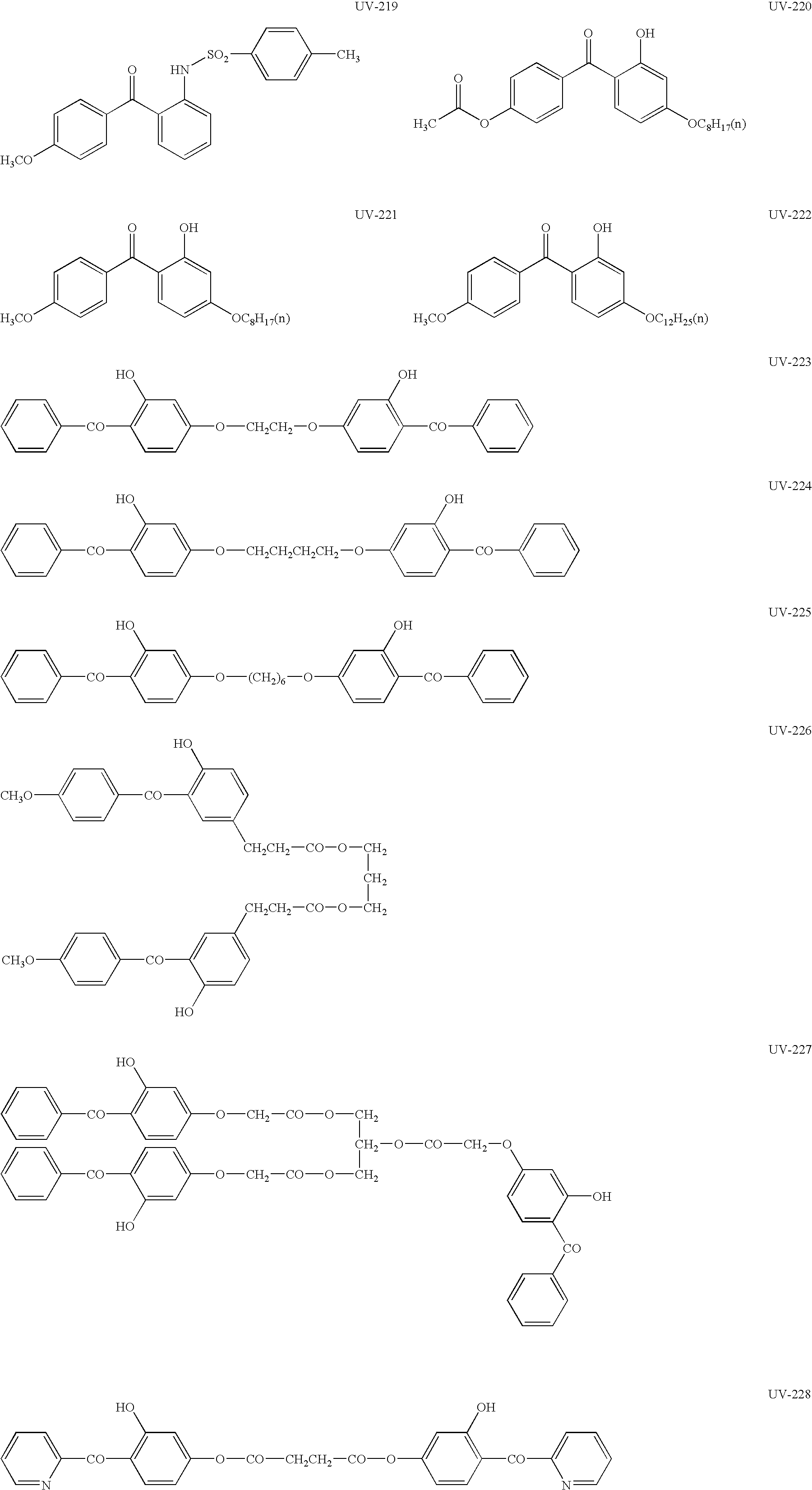

The following will describe a UV absorber represented by the formula (9).

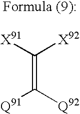

In the above formula (9), Q⁹¹ and Q⁹² each independently represents an aromatic ring. The aromatic ring represented by Q⁹¹ and Q⁹² may be an aromatic hydrocarbon ring or an aromatic heterocycle. Moreover, they may be a single ring or may form a condensed ring together with another ring.

The aromatic hydrocarbon ring is preferably a monocyclic or bicyclic aromatic hydrocarbon ring having 6 to 30 carbon atoms (e.g., benzene ring, naphthalene ring), more preferably an aromatic hydrocarbon ring having 6 to 20 carbon atoms, even more preferably an aromatic hydrocarbon ring having 6 to 12 carbon atoms, and particularly preferably a benzene ring.

The aromatic heterocycle is preferably an aromatic heterocycle containing a nitrogen atom or a sulfur atom. Specific examples of the aromatic heterocycle include thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phtharazine, naphthylidine, quinoxaline, quinazoline, cinnoline, pteridine, acridine, phenanthroline, phenazine, tetrazole, benzimidazole, benzoxazole, benzothiazole, benzotriazole, tetrazaindene. As the aromatic heterocycle, preferred are pyridine, triazine, and quinoline.

The aromatic ring represented by Q⁹¹ and Q⁹² is preferably an aromatic hydrocarbon ring, more preferably a benzene ring.

Q⁹¹ and Q⁹² may further have a substituent and the above substituent T is preferred.

X⁹¹ and X⁹² represents a hydrogen atom or a substituent, at least one of which represents a cyano group, a carbonyl group, a sulfonyl group, or an aromatic heterocycle. As the substituents represented by X⁹¹ and X⁹², the above substituent T can be applied. Moreover, the substituents represented by X⁹¹ and X⁹² may be further substituted with another substituent and the substituents may be condensed each other to form a ring structure.

X⁹¹ and X⁹² is preferably a hydrogen atom, an alkyl group, an aryl group, a cyano group, a nitro group, a carbonyl group, a sulfonyl group, or an aromatic heterocycle, more preferably a cyano group, a carbonyl group, a sulfonyl group, or an aromatic heterocycle, even more preferably a cyano group or a carbonyl group, and particularly preferably a cyano group or an alkoxycarbonyl group {—C(═O)OR⁹¹ (wherein R⁹¹ is an alkyl group having 1 to 20 carbon atoms, an aryl group having 6 to 12 carbon atoms, and a combination thereof)}.

As the formula (9), preferred is a compound represented by the following formula (9-1).

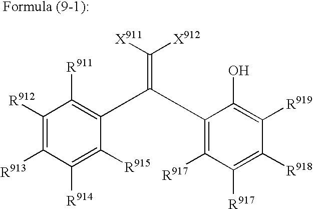

In the formula, R⁹¹, R⁹¹², R⁹¹³, R⁹¹⁴, R⁹¹⁵, R⁹¹⁶, R⁹¹⁷, R⁹¹⁸, and R⁹¹⁹ each independently represents a hydrogen atom or a substituent and the above substituent T can be applied as the substituent. Moreover, these substituents may be further substituted with another substituent and the substituents may be condensed each other to form a ring structure. X⁹¹¹ and X⁹¹² have the same meanings as those of X⁹¹ and X⁹² in the above formula (9), respectively.

R⁹¹¹, R⁹¹², R⁹¹⁴, R⁹¹⁵, R⁹¹⁶, R⁹¹⁷, and R⁹¹⁹ each is preferably a hydrogen atom, an alkyl group, an alkenyl group, an alkynyl group, an aryl group, a substituted or unsubstituted amino group, an alkoxy group, an aryloxy group, a hydroxyl group, or a halogen atom, more preferably a hydrogen atom, an alkyl group, an aryl group, an alkyloxy group, an aryloxy group, or a halogen atom, even more preferably a hydrogen atom or an alkyl group having 1 to 12 carbon atoms, particularly preferably a hydrogen atom or a methyl group, and most preferably a hydrogen atom.

R⁹¹³ and R⁹¹⁸ each is preferably a hydrogen atom, an alkyl group, an alkenyl group, an alkynyl group, an aryl group, a substituted or unsubstituted amino group, an alkoxy group, an aryloxy group, a hydroxyl group, or a halogen atom, more preferably a hydrogen atom, an alkyl group having 1 to 20 carbon atoms, an amino group having 0 to 20 carbon atoms, an alkoxy group having 1 to 12 carbon atoms, an aryloxy group having 6 to 12 carbon atoms, or a hydroxyl group, even more preferably a hydroxyl group, an alkyl group having 1 to 12 carbon atoms, or an alkoxy group having 1 to 12 carbon atoms, particularly preferably a hydrogen atom.

The following will show specific examples of the compound represented by the formula (9) or (9-1) but the invention is not limited to the following specific examples.

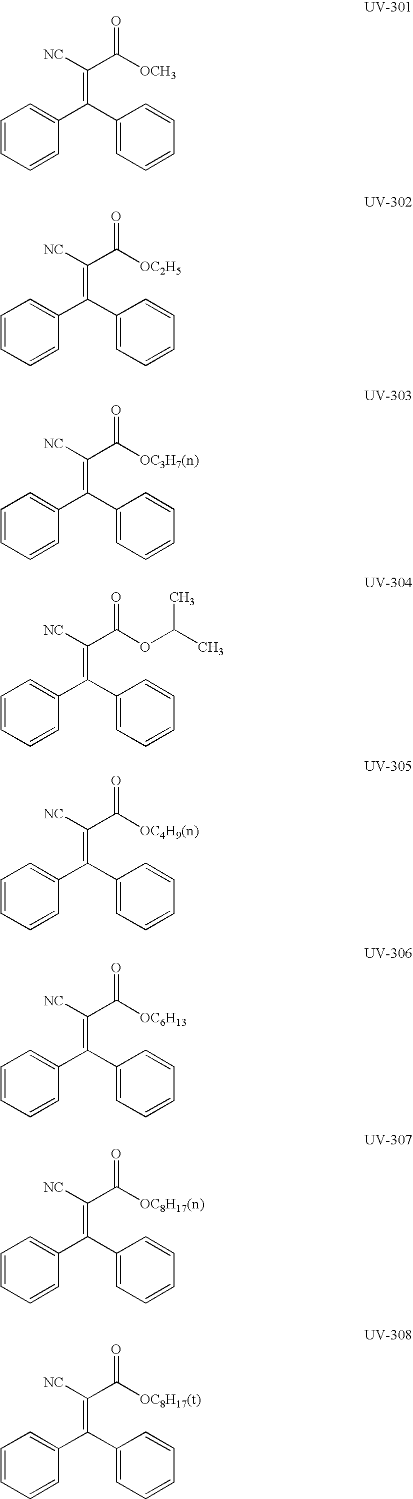

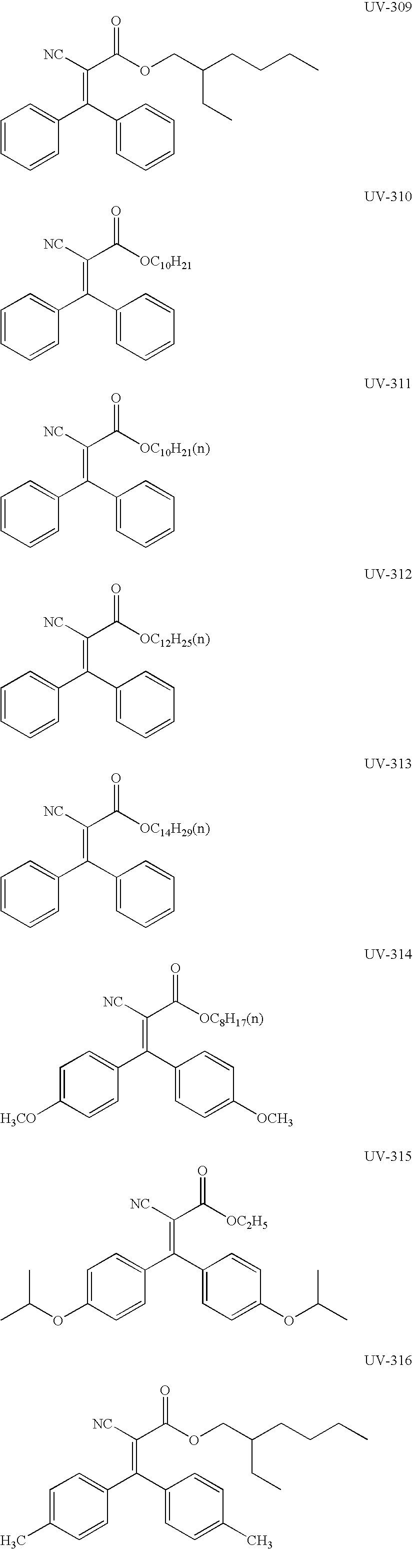

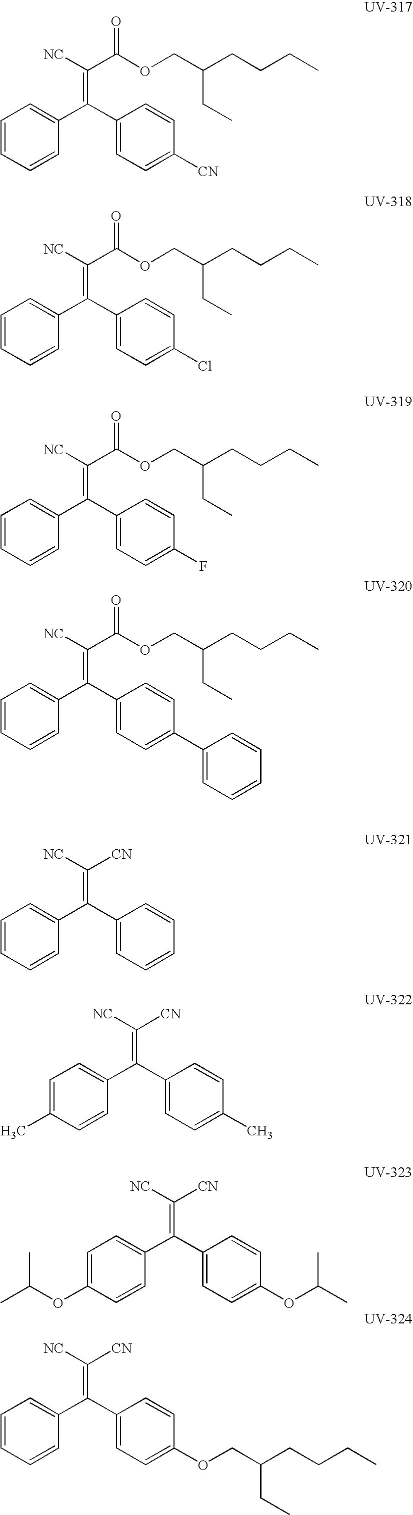

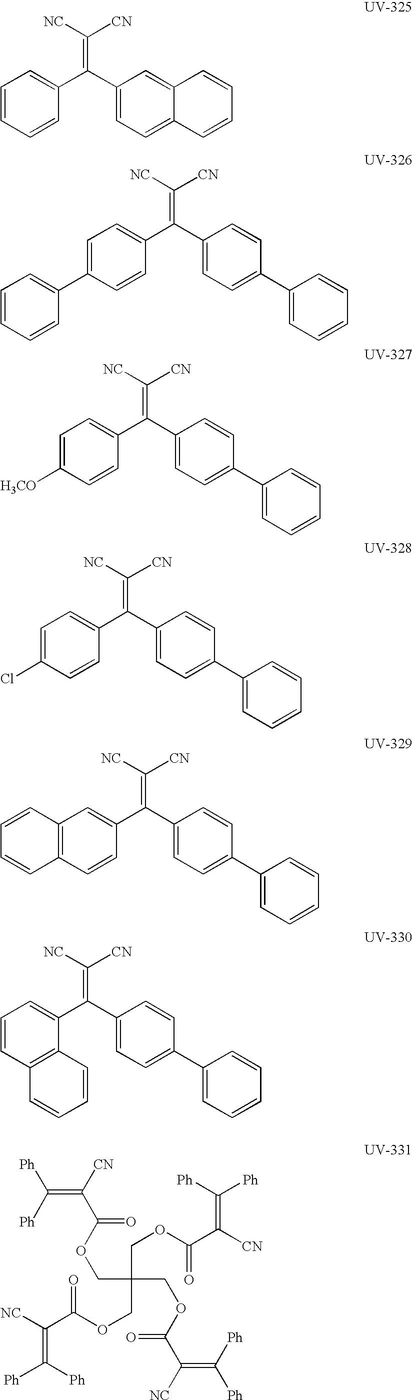

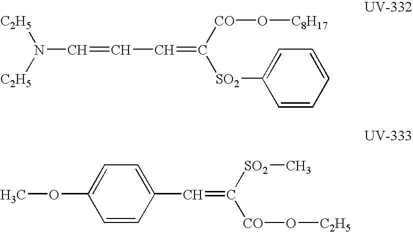

The following will show specific examples of the compound represented by the formulae (7) to (9) but the invention is not limited to the following specific examples.

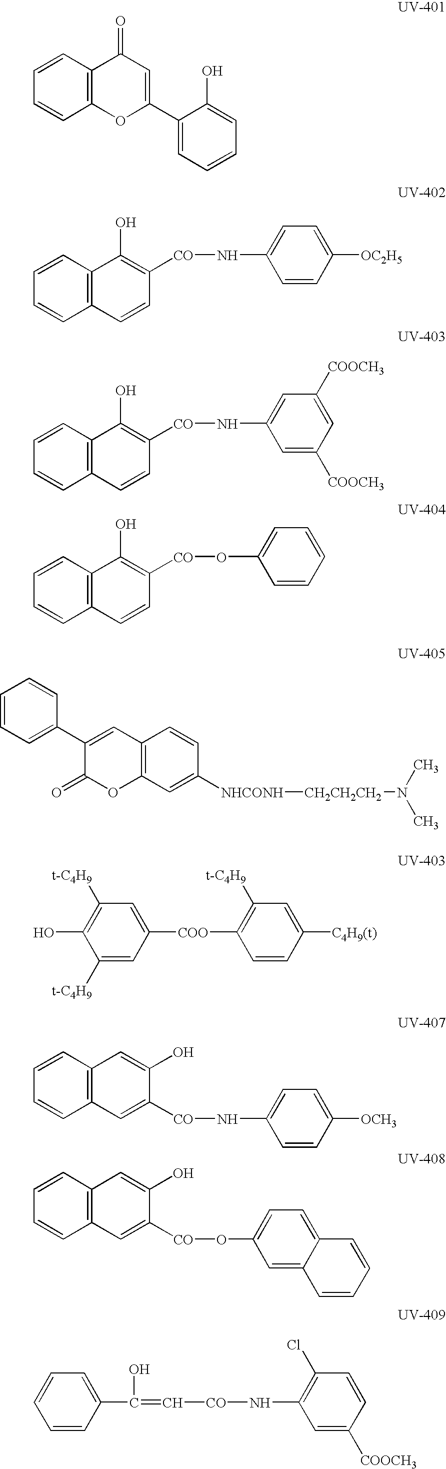

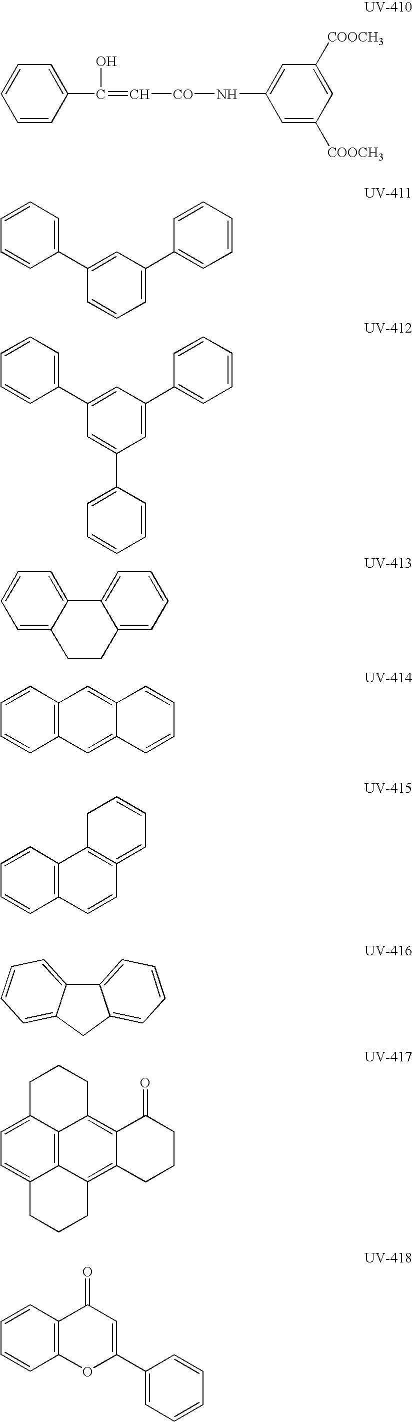

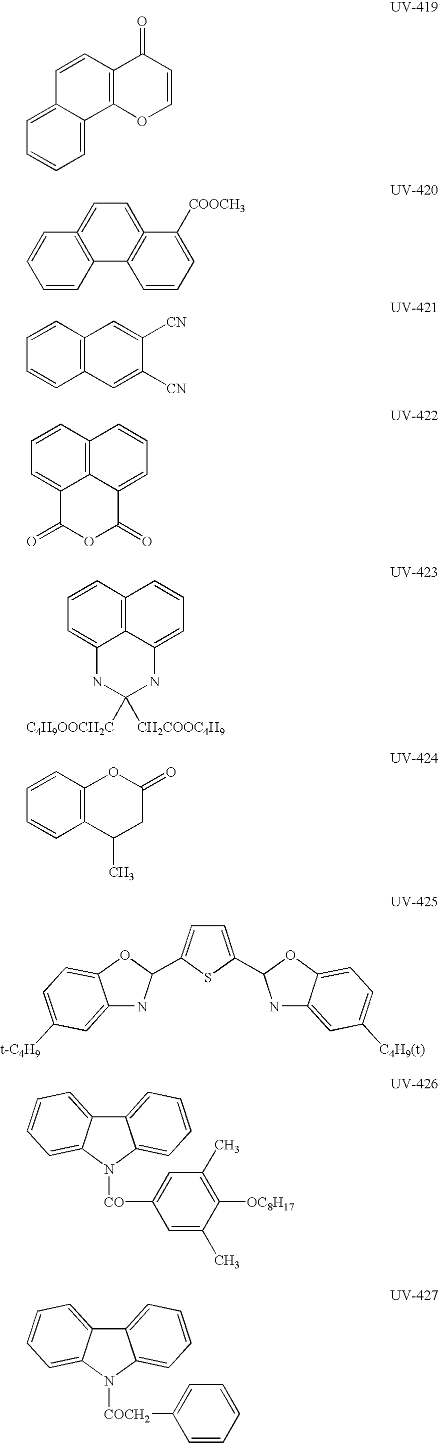

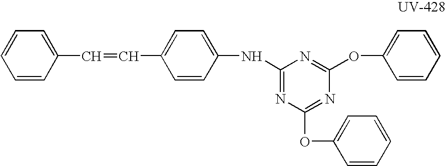

The UV absorber for use in the invention is preferably liquid at 25° C. “Liquid” means a state having no constant figure, showing fluidity, and having a nearly constant volume as defined in “Encyclopaedia Chimica” (Kyoritsu Shuppann) (1963) and the like. The melting point is not specified as far as the absorber has the above properties but is preferably 30° C. or lower, more preferably 15° C. or lower. As the UV absorber liquid at 25° C., UV-116, UV-117, UV-309, and UV-333 may be mentioned among the specific examples mentioned above but it is not limited thereto.

The UV absorber in the invention preferably has a molecular weight of from 250 to 1,000 in view of evaporating ability. More preferred is from 270 to 800, even more preferably from 270 to 800, and particularly preferably from 300 to 800. Within the molecular weight range, the UV absorber may have a specific monomer structure or may be a polymeric compound, an oligomer structure or a polymer structure wherein plurality of the monomer units are combined.

Among the compounds represented by the formulae (7) to (9), the UV absorber of the invention is preferably a polymeric compound having plurality of the compounds as units. As such a polymeric compound, preferred is a compound represented by the following formula (10).

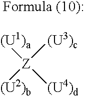

In the formula (10), U¹, U², U³, and U⁴ each is a partial structure selected from the compound structures represented by the above formulae (7) to (9), a, b, c, and d each is an integer of 0 or more and a+b+c+d is 2 or more. Z represents an (a+b+c+d) valent connecting group.

a, b, c, and d each is preferably 0 or 1 and a+b+c+d is 2 or more, preferably from 2 to 8, more preferably from 3 to 6, and even more preferably from 3 to 4. It is more preferred that Z does not form a cyclic structure.

In this regard, as the partial structures selected from the compound structures represented by the above formulae (7) to (9) in U¹, U², U³, and U⁴, there may be mentioned those obtained by removing a hydrogen atom from respective compounds. As the bonding position, there may be mentioned the position of the hydrogen atom.

Moreover, as the above formula (10), preferred is a compound represented by the following formula (10-1).

U¹¹-L-U¹² Formula (10-1)

In the above formula (10-1), U¹¹ and U¹² have the same meanings as in the partial structures represented by the above formulae (7) and (8), respectively. L represents a divalent connecting group and is preferably formed of one or more groups selected from —O—, —S—, —SO—, —SO₂—, —CO—, —NR¹—, (wherein R¹ represents a substituted or unsubstituted aliphatic group or a substituted or unsubstituted aromatic group and an unsubstituted and/or an aliphatic group is more preferred.), an alkylene group, and an arylene group. The combination of L is not particularly limited but is preferably selected from —O—, —S—, —NR¹—, and an alkylene group, more preferably selected from —O—, —S—, and an alkylene group, most preferably selected from —O— and an alkylene group. It is preferred that L does not form a cyclic structure. Moreover, number of atoms constituting the chain length of L is preferably from 3 to 20.

In this regard, as the partial structures selected from the compound structures represented by the above formulae (7) and (8) in U¹¹ and U¹², there may be mentioned those obtained by removing a hydrogen atom from respective compounds. As the bonding position, there may be mentioned the position of the hydrogen atom.

The UV absorber of the invention is preferably the compound of the above formula (10) or a triazine compound wherein Q⁷¹ in the above formula (7) is a 1,3,5-triazine ring in view of a small change in optical anisotropy during saponification treatment of the cellulose acylate film.

Furthermore, in view of an excellent light resistance of the cellulose acylate film (change in optical anisotropy after light irradiation), the UV absorber is preferably a triazine compound wherein Q⁷¹ in the above formula (7) is a 1,3,5-triazine ring.

It is preferred that the UV absorber does not evaporate in the progress of dope casting and drying in the manufacture of the cellulose acylate film.

The amount of the UV absorber to be added is preferably from 0.01 to 30% by mass, more preferably from 0.1 to 20% by mass, particularly preferably from 0.2 to 10% by mass of the cellulose acylate.

These UV absorbers may be used solely or as a mixture of two or more compounds in any ratio.

The timing of the addition of these UV absorbers may be at any time during the dope preparation step and may be at the final stage of the dope preparation step.

### [Retardation of Cellulose Acylate Film]

The following will describe retardation Re and Rth in detail.

In the invention, Reλ and Rthλ represent retardation in the in-plane direction and retardation in the thickness direction at a wavelength λ, respectively.

### [Measurement of Retardation]

The following will describe a measuring method of retardation of the cellulose acylate film of the invention.

### (Retardation Re in the In-Plane Direction and Retardation Rth in the Thickness Direction)

A cellulose acylate film sample having a size of 30 mm×40 mm was subjected to moisture conditioning at 25° C. and 60% RH for 2 hours and Re) was measured with entering a light having a wavelength of λ nm in the normal line direction of the film using an automatic birefringence meter “KOBRA 21ADH” (manufactured by Oji Scientific Instruments). Moreover, Rthλ was calculated based on retardation values measured in three directions in total, i.e., the Reλ, a retardation value measured with entering a light having a wavelength of λ nm from the direction +40° tilted to the normal line direction of the film using the in-plane retardation axis as a tilt axis, and a retardation value measured with entering a light having a wavelength of λ nm from the direction −40° tilted to the normal line direction of the film using the in-plane retardation axis as a tilt axis, with inputting a hypothetical value of mean refractive index of 1.48 and the film thickness.

(Change of Re and Rth in the Wavelength Range of from 400 nm to 700 nm)

A cellulose acylate film sample having a size of 30 mm×400 mm was subjected to moisture conditioning at 25° C. and 60% RH for 2 hours and Re at each wavelength was determined with entering a light having a wavelength of from 700 nm to 400 nm in the normal line direction of the film using an elipsometer “M-150” (manufactured by JASCO Corporation), whereby change in Re with wavelength was measured. Moreover, change in Rth with wavelength was calculated based on retardation values measured in three directions in total, i.e., the Re, a retardation value measured with entering a light having a wavelength of λ nm from the direction +40° tilted to the normal line direction of the film using the in-plane retardation axis as a tilt axis, and a retardation value measured with entering a light having a wavelength of λ nm from the direction −40° tilted to the normal line direction of the film using the in-plane retardation axis as a tilt axis, with inputting a hypothetical value of mean refractive index of 1.48 and the film thickness.

In the invention, as a cellulose film having a small optical anisotropy (Re, Rth), it is preferred that retardation Re in the in-plane direction and retardation Rth in the thickness direction at a wavelength of 630 nm each satisfy the ranges shown in the following numerical formulae (3) and (4):

−25 nm≦Rth₆₃₀≦25 nm, Numerical formula (3)

0 nm≦Re₆₃₀≦10 nm. Numerical formula (4)

Retardation Rth satisfies more preferably the ranges shown in the following numerical formulae (3-1) and (4-1), particularly preferably the ranges shown in the following numerical formulae (3-2) and (4-2):

−20 nm≦Rth₆₃₀≦20 nm, Numerical formula (3-1)

0 nm≦Re₆₃₀≦5 nm. Numerical formula (4-1)

−15 nm≦Rth₆₃₀≦15 nm, Numerical formula (3-2)

0 nm≦Re₆₃₀≦2 nm. Numerical formula (4-2)

Moreover, with regard to the cellulose acylate film of the invention, in the wavelength range of from 400 nm to 700 nm, preferably, change in Rth is 25 nm or less and change in Re is 10 nm or less, more preferably, change in Rth is 20 nm or less and change in Re is 5 nm or less, and particularly preferably, change in Rth is 15 nm or less and change in Re is 3 nm or less.

Furthermore, with regard to the cellulose acylate film of the invention, retardation Re in the in-plane direction and retardation Rth in the thickness direction at a wavelength of 630 nm satisfies preferably the relation of the following numerical formula (5), more preferably the relation of the following numerical formula (5-1), and even more preferably the relation of the following numerical formula (5-2):

|Re₆₃₀×Rth₆₃₀|≦200, Numerical formula (5)

|Re₆₃₀×Rth₆₃₀|≦100, Numerical formula (5-1)

|Re₆₃₀×Rth₆₃₀|≦50. Numerical formula (5-2)

### [Cellulose Acylate]

### [Raw Material Cellulose for Cellulose Acylate]

The raw material cellulose for cellulose acylate includes cotton linter, wood pulp (hardwood pulp, softwood pulp). Any and every type of cellulose acylate obtainable from any and every type of such raw material cellulose is usable herein. As the case may be, they may be mixed for use herein. The raw material cellulose is described in detail, for example, in Maruzawa & Uda, Plastic Material Lecture (17) Cellulosic Resin, by Nikkan Kogyo Shinbun (1970); and Hatsumei Kyokai, Disclosure Bulletin No. 2001-1745 (pp. 7-8). Celluloses described in these may be used for the cellulose acylate film of the present invention with no specific limitation thereon.

### [Degree of Substitution in Cellulose Acylate]

The cellulose acylate for use in the invention, which is produced from the above-mentioned cellulose material, is described below. The cellulose acylate for use in the invention is produced by acylating the hydroxyl group in cellulose, in which the substituent may be any acyl group having from 2 (acetyl group) to 22 carbon atoms. The degree of substitution of hydroxyl group in cellulose with acyl group to give the cellulose acylate for use herein is not specifically defined. For example, it may be determined by measuring the degree of bonding of acetic acid and/or fatty acids having from 3 to 22 carbon atoms that substitute for the hydroxyl group in cellulose, followed by calculating the resulting data. For the measurement, for example, employable is a method of ASTM D-817-91.

As so mentioned hereinabove, the degree of substitution of hydroxyl group in cellulose with acyl group to give the cellulose acylate for use in the invention is not specifically defined. Preferably, however, the degree of acyl substitution of hydroxyl group in cellulose to give the cellulose acylate is from 2.50 to 3.00, more preferably from 2.75 to 3.00, even more preferably from 2.85 to 3.00.

Of acetic acid and/or fatty acids having from 3 to 22 carbon atoms that substitute for the hydroxyl group in cellulose, the acyl group having from 2 to 22 carbon atoms may be any of aliphatic group or allyl group, and are not specifically defined. It may be a single group or may be a mixture of two or more different groups. They are, for example, cellulose alkylcarbonyl esters, alkenylcarbonyl esters, aromatic carbonyl esters or aromatic alkylcarbonyl esters, which may be further substituted. Preferred examples of the acyl group of the type are acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl and cinnamoyl groups. Of those, preferred are acetyl, propionyl, butanoyl, dodecanoyl, octadecanoyl, t-butanoyl, oleoyl, benzoyl, naphthylcarbonyl and cinnamoyl groups; and more preferred are acetyl, propionyl and butanoyl groups. The most preferred group is an acetyl group.

Of the above acyl substituents that substitute for the hydroxyl group in cellulose, in the case that the substituent substantially comprises at least two different groups of acetyl group/propionyl group/butanoyl group, the optical anisotropy of the cellulose acylate film can be more suitably lowered when total degree of substitution thereof is from 2.50 to 3.00. More preferred degree of acyl substitution is from 2.60 to 3.00 and even more preferred one is from 2.65 to 3.00.

In the case that the above acyl substituent of the cellulose acylate comprises only an acetyl group, the optical anisotropy of the cellulose acylate film can be more suitably lowered when total degree of substitution thereof is from 2.50 to 2.95.

### [Degree of Polymerization of Cellulose Acylate]

Regarding the degree of polymerization of the cellulose acylate preferably used in the invention, it is desirable that the viscosity-average degree of polymerization of the cellulose acylate is from 180 to 700, for the cellulose acetate, more preferably from 180 to 550, even more preferably from 180 to 400, still more preferably from 180 to 350. If the degree of polymerization thereof is less than the upper limit, it is preferred because the viscosity of the dope solution of cellulose acylate may not be too high, and film formation by casting may be easy. If the degree of polymerization is more than the lower limit, it is preferred because the strength of the film formed may not be lowered. The mean degree of polymerization may be determined according to an Uda et all's limiting viscosity method (Kazuo Uda & Hideo Saito, the Journal of Fiber Society of Japan, Vol. 18, No. 1, pp. 105-120, 1962). This is described in detail in JP-A 9-95538.

The molecular weight distribution of the cellulose acylate preferably used in the invention may be evaluated through gel permeation chromatography. It is desirable that the polydispersion index Mw/Mn (Mw indicates the mass-average molecular weight, and Mn indicates the number-average molecular weight) is smaller and the molecular weight distribution is narrower. Concretely, Mw/Mn is preferably from 1.0 to 4.0, more preferably from 2.0 to 3.5, most preferably from 2.3 to 3.3.

When low-molecular components are removed, then the mean molecular weight (degree of polymerization) of the cellulose acylate may be high, but the viscosity thereof may be lower than that of ordinary cellulose acylate and therefore, the cellulose acylate is useful. The cellulose acylate having a reduced content of low-molecular components may be obtained by removing low-molecular components from the cellulose acylate produced in an ordinary method. Removing low-molecular components may be carried out by washing the cellulose acylate with a suitable organic solvent.

When a cellulose acylate having a reduced content of low-molecular components is produced, then the amount of the sulfuric acid catalyst in acylation is preferably controlled to be from 0.5 to 25 parts by mass relative to 100 parts by mass of cellulose. When the amount of the sulfuric acid catalyst is defined to fall within the range, then it is desirable in point of the molecular weight distribution of the resulting cellulose acylate, or that is, a cellulose acylate having a uniform molecular weight distribution can be produced.

Preferably, the water content of the cellulose acylate for use in the invention is at most 2% by mass, more preferably at most 1% by mass, even more preferably at most 0.7% by mass. Ordinary cellulose acylate generally contains water and its water content is known to be from 2.5 to 5% by mass. Therefore, in order that the cellulose acylate for use in the invention is made to have a water content falling within the range as above, the cellulose acylate must be dried. The drying method for it is not specifically defined, so far as the dried cellulose acylate may have the intended water content. The cellulose acylate for use in the invention as well as its starting material cellulose and its production method is described in detail, for example, in Hatsumei Kyokai, Disclosure Bulletin No. 2001-1745 (issued Mar. 15, 2001, by Hatsumei Kyokai), pp. 7-12.

The type of substituent, the degree of substitution, the degree of polymerization and the molecular weight distribution of the cellulose acylate for use in the invention may fall within the ranges as above, and one or more such cellulose acylates may be used herein either singly or as combined.

### [Additives to Cellulose Acylate]

In accordance with their use, various additives may be added to the cellulose acylate solution for use in the invention, during the process of producing the solution. In addition to the retardation regulator and UV absorber mentioned above, various additives (e.g., plasticizer, deterioration inhibitor, fine particles) may be added thereto, and these are described hereinunder. The time when the additives are added to the solution may be any one in the process of dope preparation. As the case may be, the additives may be added to the dope solution in the final step of dope preparation.

### [Mat Agent Particles]

The cellulose acylate film in the invention preferably contains particles serving as a mat agent. The particles for use herein include silicon dioxide, titanium dioxide, aluminium oxide, zirconium oxide, calcium carbonate, talc, clay, calcined kaolin, calcined calcium silicate, calcium silicate hydrate, aluminium silicate, magnesium silicate and calcium phosphate. The particles are preferably silicon-having ones as the haze of the films containing them may be low. Especially preferred is silicon dioxide. Particles of silicon dioxide for use herein preferably have a primary mean particle size of at most 20 nm and have an apparent specific gravity of at least 70 g/liter. More preferred are particles having a small primary mean particle size of from 5 to 16 nm, since the haze of the films containing them is lower. The apparent specific gravity is more preferably from 90 to 200 g/liter, even more preferably from 100 to 200 g/liter. Particles having a larger apparent specific gravity may give a dispersion having a higher concentration, and are therefore preferable since the haze of the films containing them could be lower and since the solid deposits in the film may be reduced.

The particles generally form secondary particles having a mean particle size of from 0.1 to 3.0 μm, and in the film, they exist as aggregates of primary particles, therefore forming protrusions having a size of from 0.1 to 3.0 μm in the film surface. Preferably, the secondary mean particle size is from 0.2 μm to 1.5 μm, more preferably from 0.4 μm to 1.2 μm, most preferably from 0.6 μm to 1.1 μm. The primary and secondary particle sizes are determined as follows: The particles in a film are observed with a scanning electromicroscope, and the diameter of the circle that is circumscribed around the particle is referred to as the particle size. 200 particles are observed at random in different sites, and their data are averaged to give the mean particle size thereof.

For silicon dioxide particles, herein usable are commercial products of Aerosil R972, R972V, R974, R812, 200, 200V, 300, R202, OX50, TT600 (all by Nippon Aerosil). Zirconium oxide particles are also commercially available, for example, as Aerosil R976 and R811 (both by Nippon Aerosil), and are usable herein.

Of those, Aerosil 200V and Aerosil R972V are silicon dioxide particles having a primary mean particle size of at most 20 nm and having an apparent specific gravity of at least 70 g/liter, and these are especially preferred for use herein since they are effective for reducing the friction coefficient of optical films not increasing the haze thereof.

In the invention, for obtaining a cellulose acylate film that contains particles having a small secondary mean particle size, there may be employed some methods for preparing a dispersion of particles. For example, one method for it comprises previously preparing a dispersion of particles by stirring and mixing a solvent and particles, then adding the resulting dispersion to a small amount of a cellulose acylate solution separately prepared, and thereafter further mixing it with a main cellulose acylate dope. This method is desirable since the dispersibility of silicon dioxide particles is good and since the dispersion of silicon dioxide particles prepared hardly reaggregates. Apart from it, also employable herein is a method comprising adding a small amount of a cellulose ester to a solvent, dissolving them with stirring, and fully mixing the resulting dispersion of particles with a dope in an in-line mixer. The invention should not be limited to these methods. When silicon dioxide particles are mixed and dispersed in a solvent, the silicon dioxide concentration in the resulting dispersion is preferably from 5 to 30% by mass, more preferably from 10 to 25% by mass, most preferably from 15 to 20% by mass. Relative to the amount of the particles therein, the dispersion having a higher concentration may have a smaller haze, and is therefore favorable since the haze of the films with it may be lowered and the solid deposits may be reduced in the films. Finally, the amount of the mat agent to be in the cellulose acylate dope is preferably from 0.01 to 1.0 g/m², more preferably from 0.03 to 0.3 g/m², most preferably from 0.08 to 0.16 g/m².

The solvent may be a lower alcohol, preferably methyl alcohol, ethyl alcohol, propyl alcohol, isopropyl alcohol or butyl alcohol. The solvent usable herein except such lower alcohols is not specifically defined, for which, however, preferred are those generally used in cellulose ester film formation.

### (Plasticizer, Deterioration Inhibitor, Release Agent)

In addition to the retardation regulator and UV absorber mentioned above, the cellulose acylate film of the invention may contain various additives (e.g., plasticizer, deterioration inhibitor, release agent, IR absorber) added thereto in the process of producing it and in accordance with the use of the film. The additives may be solid or oily. In other words, they are not specifically defined in point of their melting point and boiling point. For example, UV absorbers may be mixed at 20° C. or lower and at 20° C. or higher; and the same may apply to mixing plasticizers. For example, this is described in JP-A 2001-151901. Further, IR-absorbing dyes are described in, for example, JP-A 2001-194522. The amount of each additive to be added is not specifically defined so far as the additive could exhibit its function. When the cellulose acylate film has a multi-layer structure, then the type and the amount of the additives to be added to each layer may differ. For example, this is described in JP-A 2001-151902, and the technique is well known in the art. Its details are described in Hatsumei Kyokai's Disclosure Bulletin No. 2001-1745 (issued Mar. 15, 2001 by Hatsumei Kyokai), pp. 16-12, and the materials described therein are preferably used in the invention.

### (Ratio of Each Compound to be Added)

In the cellulose acylate film of the invention, total amount of the compounds having a molecular weight of 3,000 or less is desirably from 5 to 45% by mass relative to the mass of the cellulose acylate. More desired is from 10 to 40% by mass and even more desired is from 15 to 30% by mass. As mentioned above, the compounds are a retardation regulator, a UV absorber, a UV inhibitor, a plasticizer, a deterioration inhibitor, fine particles, a release agent, a IR absorber, and the like and the molecular weight thereof is desirably 3,000 or less, more desirably 2,000 or less, even more desirably 1,000 or less. When the total amount of these compounds is at least the lower limit, there arise no such problems that optical performance and physical properties are apt to change with the change of temperature and humidity, for example. Moreover, when the total amount of these compounds does not exceed the upper limit, there arise no such problems that the compounds may precipitate on the surface of the film to make the film turbid (weeping from the film) as a result of exceeding a compatible limit of the compounds in the film. Therefore, it is preferred to use these compounds within the above range in total. The timing of the addition of the compounds may be at any time during the dope preparation step and may be at the final stage of the dope preparation step.

### (Organic Solvent in Cellulose Acylate Solution)

In the invention, the cellulose acylate film is produced preferably according to a solvent-casting method, in which a cellulose acylate is dissolved in an organic solvent to prepare a solution (dope) and the dope is formed into films. The organic solvent preferably used as the main solvent in the invention is selected from esters, ketones and ethers having from 3 to 12 carbon atoms, and halogenohydrocarbons having from 1 to 7 carbon atoms. Esters, ketones and ethers for use herein may have a cyclic structure. Compounds having any two or more functional groups of esters, ketones and ethers (i.e., —O—, —CO— and —COO—) may also be used herein as the main solvent, and for example, they may have any other functional group such as alcoholic hydroxyl group. The number of the carbon atoms that constitute the main solvent having two or more functional groups may fall within the range the compound having any of those functional groups.

For the cellulose acylate film of the invention, chlorine-based halogenohydrocarbons may be used as the main solvent, or non-chlorine solvents as in Hatsumei Kyokai's Disclosure Bulletin 2001-1745 (pp. 12-16) may also be used as the main solvent. Anyhow, the main solvent is not limitative for the cellulose acylate film of the invention. For the cellulose acylate of the invention, poor solvent for cellulose acylate other than main solvent can be used. Poor solvent can be used in 5 to 50 mass %, preferably 5 to 30 mass % based on main solvent. As poor solvent, for example, methanol, ethanol and butanol are exemplified.

In addition, the solvents for the cellulose acylate solution and the film and also methods for dissolution therein are disclosed in the following patent publications, and these are preferred embodiments for use in the invention. For example, they are described in JP-A 2000-95876, 12-95877, 10-324774, 8-152514, 10-330538, 9-95538, 9-95557, 10-235664, 12-63534, 11-21379, 10-182853, 10-278056, 10-279702, 10-323853, 10-237186, 11-60807, 11-152342, 11-292988, 11-60752, 11-60752. These patent publications disclose not only the solvents preferred for cellulose acylate for the invention but also the physical properties of their solutions as well as the substances that may coexist along with them, and these are also preferred embodiments for use in the invention.

### [Method for Producing Cellulose Acylate Film]

### [Dissolution Step]

Preparing the cellulose acylate solution (dope) in the invention is not specifically defined in point of its dissolution process. It may be prepared at room temperature or may be prepared in a mode of cooling dissolution or high-temperature dissolution or in a mode of their combination. A process comprising a step of preparing the cellulose acylate solution for use in the invention and a subsequent step of concentration and filtration of the solution is described in detail in Hatsumei Kyokai's Disclosure Bulletin 2001-1745 (issued Mar. 15, 2001, by Hatsumei Kyokai), pp. 22-25, and this is preferably employed in the invention.

### (Transparency of Dope Solution)

Preferably, the dope transparency of the cellulose acylate solution in the invention is at least 85%, more preferably at least 88%, even more preferably at least 90%. We, the present inventors have confirmed that various additives well dissolve in the cellulose acylate dope solution in the invention. A concrete method for determining the dope transparency is described. A dope solution is put into a glass cell having a size of 1 cm², and its absorbance at 550 nm is measured with a spectrophotometer (UV-3150 by Shimadzu). The solvent alone is measured as a blank, and the transparency of the cellulose acylate solution is calculated from the ratio of the solution absorbance to the blank absorbance.

### [Casting, Drying and Winding Step]

Next, a process of forming a film from the cellulose acylate solution in the invention is described. For the method and the equipment for producing the cellulose acylate film in the invention, herein employable are the solvent-casting method and the solvent-casting equipment heretofore generally used in the art for cellulose triacetate film formation. A dope (cellulose acylate solution) prepared in a dissolver (tank) is once stored in a storage tank, in which the dope is defoamed and is thus finally prepared. From the dope take-out mouth of the tank, the dope is taken out and fed into a pressure die via a metering pressure gear pump capable of feeding it with accuracy, for example, based on the revolution number thereof, and then the dope is uniformly cast onto the endlessly-running cast member of a metal support via the slit of the pressure die, and at a peel point to which the metal support makes nearly one revolution, the still wet dope film (this may be referred to as a web) is peeled from the metal support. While both ends of the thus-obtained web are clipped to ensure its width, the web is conveyed with a tenter and dried, and then further conveyed with rolls in a drier in which the web is completely dried, and thereafter this is wound up around a winder to predetermined width. The combination of the tenter and the drier with rolls may vary depending on the object of the film to be produced. When the essential applications of the cellulose acylate film of the invention are for functional protective films for optical structures in electronic displays or for silver halide photographic materials, then additional coating devices may be fitted to the solvent casting apparatus for producing the film. The additional devices are for further processing the surface of the film by forming thereon a subbing layer, an antistatic layer, an antihalation layer and a protective layer. This is described in detail in Hatsumei Kyokai's Disclosure Bulletin 2001-1745 (issued Mar. 15, 2001, by Hatsumei Kyokai), pp. 25-30. They are classified into casting (including co-casting), metal support, drying and peeling etc., and preferably used in the invention.

The residual solvent content of the cellulose acylate film of the invention in any point on casting film-formation process is defined by the following numerical formula (9):

(Wₜ−W₀)×100/W₀

Wₜ: measured mass of doped film actually measured

W₀: film mass after completion of drying when dried at 110° C. for 3 hours.

The residual solvent content at peeling point falls preferably within the range of from 5 to 90% by mass and the content of poor solvent(s) among the residual solvents falls preferably within the range of from 10 to 95% by mass.

### [Stretching]

The cellulose acylate film of the invention may be subjected to stretching and the stretching may be any of uniaxial stretching and biaxial stretching. The biaxial stretching includes a simultaneous biaxial stretching method and a sequential biaxial stretching method. In view of continuous production, the sequential biaxial stretching method is preferred, wherein a film is peeled from a band or a drum after a dope is cast, and is stretched in the width direction and then in the longitudinal direction. Alternatively, the film may be stretched in the longitudinal direction and then in the width direction.

The methods for stretching films in the width direction are described, for example, JP-A 62-115035, 4-152125, 4-284211, 4-298310, and 11-48271. The stretching of the film is carried out at room temperature or under a heated condition. The heating temperature is preferably a glass transition temperature of the film or lower. The film can be stretched during drying, the case being effective particularly in the case that solvents remain.

In the case of stretching in the longitudinal direction, a film is stretched when the rate of winding the film is larger than the rate of peeling the film by controlling the rate of carrying rollers of the film. In the case of stretching in the width direction, a film can be stretched also by carrying the film with holding the width of the film with a tenter and gradually enlarging the width of the tenter. After drying of the film, it can be stretched using a stretching machine (preferably uniaxial stretching using a Long stretching machine).

The stretching magnitude (ratio of an increase by stretching relative to original length) of the cellulose acylate film of the invention in the carrying direction (longitudinal direction) falls preferably within the range of from 1 to 100%, more preferably within the range of from 1 to 50%, most preferably within the range of from 1 to 35%. The stretching magnitude in the direction perpendicular to the carrying direction (width direction) falls preferably within the range of from 1 to 100%, more preferably within the range of from 5 to 50%, most preferably within the range of from 10 to 40%.

The residual solvent content of the cellulose acylate film of the invention after completion of stretching is preferably from 40 to 80% by mass relative to that at the beginning of stretching.

### [Film Thickness]

The thickness of the cellulose acylate film of the invention is preferably from 10 to 120 μm, more preferably from 20 to 100 μm, even more preferably from 30 to 90 μm. The difference between a maximum value and a minimum value of the thickness of films of the cellulose acylate film of the invention cut into a size of 1 m square is preferably 10% or less, more preferably 5% or less based on an average thickness.

[Evaluation of Physical properties of Cellulose Acylate Film]

### [Optical Performance]

(Change in Optical Performance of Film after High Humidity Treatment]

With regard to change in optical performance of the cellulose acylate film of the invention with environmental change, change in Re and Rth of the film treated at 60° C. and 90% RH for 240 hours is preferably 15 nm or less, more preferably 12 nm or less, even more preferably 10 nm or less.

(Change in Optical Performance of Film after High Temperature Treatment]

Moreover, change in Re and Rth of the film treated at 80° C. for 240 hours is preferably 15 nm or less, more preferably 12 nm or less, even more preferably 10 nm or less.

### (Humidity Dependence of Re and Rth of Film)

With regard to retardation Rth of the cellulose acylate film of the invention in the thickness direction, change with humidity is preferably small. Specifically, the difference between Rth at 25° C. and 10% RH and Rth at 25° C. and 80% RH, ΔRth represented by the following numerical formula (12) is preferably from 0 to 50 nm, more preferably from 0 to 40 nm, even more preferably from 0 to 35 nm.

ΔRth=Rth_{10% RH}−Rth_{80% RH} Numerical formula (12)

(Change in in-plane Retardation before and after Stretching)

A cellulose acylate film sample having a size of 100 mm×100 mm was prepared and was stretched in the machine-carrying direction (MD direction) or in the direction perpendicular to the carrying direction (TD direction) under a temperature condition of 140° C. using a fixed uniaxial stretching machine. The in-plane retardation (Re) of each sample before and after stretching was measured using an automatic birefringence meter “KOBRA 21ADH” (manufactured by Oji Scientific Instruments). The retardation axis was detected from the orientation angle obtained at the above retardation measurement.

It is preferred that change in Re by stretching is small. Specifically, when in-plane retardation of the film stretched n(%) is referred to as Re₍ₙ₎ and in-plane retardation of the film not stretched is referred to as Re₍₀₎, Re at a wavelength of 630 nm preferably satisfies the relation of the following numerical formula (8), more preferably satisfies the relation of the following numerical formula (8-1).

|Re₍ₙ₎−Re₍₀₎|/n≦1.0, Numerical formula (8)

|Re₍ₙ₎−Re₍₀₎|/n≦0.3. Numerical formula (8-1)

### (In-Plane Unevenness of Retardation of Cellulose Acylate Film)

The values of Re and Rth of the cellulose acylate film of the invention at a wavelength of 630 nm preferably satisfies the relation of the following numerical formula (6), more preferably satisfies the relation of the following numerical formula (6-1).

|Re₆₃₀₍ₘₐₓ₎−Re₆₃₀₍ₘᵢₙ₎|≦5 and |Rth₆₃₀₍ₘₐₓ₎−Rth₆₃₀₍ₘᵢₙ₎|≦10, Numerical formula (6)

|Re₆₃₀₍ₘₐₓ₎−Re₆₃₀₍ₘᵢₙ₎|≦3 and |Rth₆₃₀₍ₘₐₓ₎−Rth₆₃₀₍ₘᵢₙ₎|≦5, Numerical formula (6-1)

wherein Re₆₃₀₍ₘₐₓ₎ and Rth₆₃₀₍ₘₐₓ₎ each is a maximum retardation value of a film having a size of 1 m square randomly cut out and Re₆₃₀₍ₘᵢₙ₎ and Rth₆₃₀₍ₘᵢₙ₎ each is a minimum retardation value.

### (Photoelastic Coefficient)

The photoelastic coefficient of the cellulose acylate film of the invention is preferably 50×10⁻¹³ cm²/dyne or less, more preferably 30×10⁻¹³ cm²/dyne or less, even more preferably 20×10⁻³ cm²/dyne or less. As a specific measuring method, tensile stress was applied to a cellulose acylate film sample having a size of 12 mm×120 mm in the longitudinal direction, retardation at that time was measured by means of an elipsometer “M-150” (manufactured by JASCO Corporation), and a photoelastic coefficient was calculated from the change in retardation against the stress.

### (Haze of Film)

The haze of the cellulose acylate film of the invention is preferably from 0.01 to 2.0%, more preferably from 0.05 to 1.5%, even more preferably from 0.1 to 1.0%. As an optical film, transparency of the film is important. The haze was measured on a sample having a size of 40 mm×80 mm of the cellulose acylate film of the invention at 25° C. and 60% RH using a haze meter “HGM-2DP” (manufactured by Suga Test Instruments) in accordance with JIS K-6714.

### (Spectral Properties, Spectral Transmittance)

A transmittance in the wavelength range of from 300 to 450 nm was measured on a sample having a size of 13 mm×40 mm of the cellulose acylate film at 25° C. and 60% RH using a spectrophotometer “U-3210” (manufactured by Hitachi Corporation). The tilt width was determined as the difference between a wavelength at 72% and a wavelength at −5%. The threshold wavelength was represented by (tilt width/2)+(wavelength at 5%). The absorption edge is represented by a wavelength at 0.4% transmittance. Based on these data, transmittances at 380 nm and 350 nm were evaluated.

In the cellulose acylate film of the invention, it is preferred that the spectral transmittance at a wavelength of 400 nm is from 45% to 95% and the spectral transmittance at a wavelength of 350 nm is 10% or less.

### [Physical Properties]

### (Glass Transition Temperature Tg of Film)

The glass transition temperature (Tg) of the cellulose acylate film sample of the invention is preferably from 80 to 165° C. In view of thermal resistance, Tg is more preferably from 100 to 160° C., particularly preferably from 110 to 150° C. In the measurement of the glass transition temperature Tg, 10 mg of the sample of the cellulose acylate film of the invention was subjected to calorimetry from room temperature to 200° C. at a temperature elevation/lowering rate of 5° C./minute on a differential scanning calorimeter “DSC 2910” (manufactured by T. A. Instruments), and then a glass transition temperature Tg was calculated.

### (Equilibrium Water Content of Film)

In order not to impair the adhesiveness with a water-soluble polymer such as polyvinyl alcohol at the time when the cellulose acylate film of the invention is used as a protective film for polarizing plates, the equilibrium water content of the film at 25° C. and 80% RH is preferably from 0 to 4%, more preferably from 0.1 to 3.5%, particularly preferably from 1 to 3% regardless of the film thickness. When the equilibrium water content is 4% or less, dependence of retardation with humidity change is not too large at the time when the film is used as a support of optically-compensatory films and hence the case is preferred.

As a measuring method of the water content, a sample having a size of 7 mm×35 mm of the cellulose acylate film of the invention was measured according to Karl Fischer's method by means of a water content-measuring instrument and a sample-drying equipment “CA-03” and “VA-05” (both manufactured by Mitsubishi Chemical Corporation). A water content was calculated by dividing the water mass (g) by the sample mass (g).

### (Water Vapor Permeability of Film)

The water vapor permeability of the film is determined by measurement under conditions of 60° C. and 95% RH based on JIS Z-0208 and by conversion of a measured value into a value in terms of a film thickness of 80 μm.

The water vapor permeability decreases when the cellulose acylate film is thick and increases when the film is thin. Therefore, it is necessary to convert the water vapor permeability with standardizing the film thickness to 80 μm in every sample having any film thickness. The conversion of the film thickness can be carried out according to the following numerical formula (13):

water vapor permeability in terms of 80 μm=measured water vapor permeability×actual film thickness (μm)/80 (μm). Numerical formula (13)

As the measuring method for the water vapor permeability, the method described in “Kobunshi no Bussei II” ‘Kobunshi Jikken Koza 4, Kyoritsu Shuppan), pp. 285-294: Joki Tokaryo no Sokutei (Shisuryo-hou, Ondokei-hou, Jokiatsu-hou, Kyuchaku-hou) can be applied.

Specifically, a sample of the cellulose acylate film of the invention (70 mmφ) was subjected to moisture conditioning at 25° C. and 90% RH or at 60° C. and 95% RH for 24 hours and the water mass per unit area (g/cm²) was calculated on a water vapor permeation testing equipment “KK-709007” (manufactured by Toyo Seiki K.K.) in accordance with JIS Z-0208 and the water vapor permeability was determined according to the following numerical formula (14):

water vapor permeability=mass after moisture conditioning−mass before moisture conditioning. Numerical formula (14)

The water vapor permeability of the cellulose acylate film of the invention is preferably from 400 to 2,000 g/m²·24 h, more preferably from 500 to 1,800 g/m²·24 h, particularly preferably from 600 to 1,600 g/m²·24 h. When the water vapor permeability is 2,000 g/m²·24 h or less, a disadvantage that absolute values of humidity dependence of Re and Rth of the film exceed 0.5 nm/% RH may not arise. Moreover, in the case that an optically-anisotropic layer is laminated on the cellulose acylate film of the invention to form an optically-compensatory film, absolute values of humidity dependence of Re and Rth do not exceed 0.5 nm/% RH. Thus, the case is preferred. Furthermore, in the case that the optically-compensatory sheet or polarizing plate prepared using such a film is incorporated into a liquid-crystal display device, change in color and decrease in viewing angle are not induced and thus the case is preferred. On the other hand, the water vapor permeability of the cellulose acylate film is 400 g/m²·24 h or more, an excellent adhesiveness is exhibited without inhibition of drying which may be induced by the cellulose acylate film in the case that the film is attached to both faces of a polarizer to prepare a polarizing plate. Thus, the case is preferred.

### (Dimensional Change of Film)

With regard to the dimensional stability of the cellulose acylate film of the invention, both of the dimensional change in the case that the film is allowed to stand under conditions of 60° C. and 90% RH for 24 hours (high humidity) and the dimensional change in the case that the film is allowed to stand under conditions of 90° C. and 5% RH for 24 hours (high temperature) are preferably 0.5% or less, more preferably 0.3% or less, even more preferably 0.15% or less.

As a specific measuring method, two sheets of a cellulose acylate film sample having a size of 30 mm×120 mm were prepared and subjected to moisture conditioning at 25° C. and 60% RH for 24 hours. At the both ends, holes of 6 mmφ were made at an interval of 100 mm, which was referred to as an original length of punch interval (L₀). After one sheet thereof was treated at 60° C. and 90% RH for 24 hours, a length of punch interval (L₁) was measured. Similarly, after another one sheet was treated at 90° C. and 5% RH for 24 hours, a length of punch interval (L₂) was measured. In all the measurement of the intervals, the length was measured in a minimum scale of 1/1,000 mm and dimensional change was determined according to the following numerical formulae (15) and (16):

dimensional change at 60° C. and 90% RH(high humidity)={|L₀−L₁|/L₀}×100, Numerical formula (15)

dimensional change at 90° C. and 5% RH(high temperature)={|L₀−L₂|/L₀}×100. Numerical formula (16)

### (Elastic Modulus of Film)

The elastic modulus of the cellulose acylate film of the invention is preferably from 200 to 500 kgf/mm², more preferably from 240 to 470 kgf/mm², even more preferably from 270 to 440 kgf/mm². As a specific measuring method, stress at 0.5% elongation was measured at a tensile rate of 10%/minute under an atmosphere of 23° C. and 70% RH using a universal tensile tester S™ T50BP manufactured by Toyo Baldwin to determine the elastic modulus.

### [Appearance of Film Surface]

With regard to the surface of the cellulose acylate film of the invention, it is preferred that the arithmetic mean roughness (Ra) of surface unevenness based on JIS B-0601-1994 is 0.1 μm or less and the maximum height thereof (Ry) is 0.5 μm or less. Preferably, the arithmetic mean roughness (Ra) is 0.05 μm or less and the maximum height thereof (Ry) is 0.2 μm or less. The shapes of concavity and convexity of the film surface can be evaluated by means of an atomic force microscope (AFM).

### [Compound Retaining Ability of Film]

In the cellulose acylate film of the invention, the ability of retaining various compounds such as the retardation regulator and UV absorber added to the film is required.

(Evaporated Amount of Compound after Heat Treatment of Film)

With regard to the compounds such as the retardation regulator and UV absorber added to the cellulose acylate film of the invention, the evaporated amount of them from the film treated at 80° C. for 240 hours is preferably 30% by mass or less, more preferably 25% by mass or less, even more preferably 20% by mass or less. The evaporated amount of each compound from the film was calculated according to the following numerical formula (17) by immersing the film treated at 80° C. for 240 hours or untreated film in a solvent and analyzing the solvent after immersion on a high performance liquid chromatography to determine the peak area of each compound as a remaining amount of the compound in the film.

evaporated amount (%)={(remaining amount of compound in untreated one)−(remaining amount of compound in treated one)}/(remaining amount of compound in untreated one)×100. Numerical formula (17)

(Compound-Retaining Ability after High-Temperature and High-Humidity Treatment of Film)

With regard to the ability of retaining the compounds such as the retardation regulator and UV absorber added to the cellulose acylate film of the invention after high-temperature and high-humidity treatment of the film, specifically, change in mass of the film when allowed to stand under conditions of 80° C. and 90% RH for 48 hours is preferably from 0 to 5% by mass, more preferably from 0 to 3% by mass, even more preferably from 0 to 2% by mass.

### (Evaluation Method of Retaining Ability)

The cellulose acylate film sample was cut into a size of 10 cm×10 cm. The mass thereof after 24 hours of standing under an atmosphere of 23° C. and 55% RH was measured and then the sample was allowed to stand under conditions of 80±5° C. and 90±10% RH for 48 hours. The surface of the sample after treatment was gently wiped and the mass after 1 day of standing at 23° C. and 55% RH was measured. Then, a compound-retaining ability after high-temperature and high-humidity treatment was calculated according to the following numerical formula (18):

compound-retaining ability after high-temperature and high-humidity treatment (% by mass)={(mass before standing−mass after standing)/mass before standing}×100. Numerical formula (18)

### [Mechanical Properties of Film]

### (Curl)

The curl value of the cellulose acylate film of the invention in the width direction is preferably from −10/m to +10/m.

With regard to the cellulose acylate film of the invention, when the curl value of the film in the width direction falls within the above range, there arise no problems that a trouble on handling of the film may result in break of the film, at the time when surface treatment or rubbing treatment at application of an optically-anisotropic layer to be described later is carried out or an orientation film or an optically-anisotropic layer is applied or attached on a long size film. Moreover, there also arises no problems that the film comes into strong contact with a carrying roll at a film edge or at a central part of the film to generate dust and hence attachment of a large amount of foreign particles onto the film occurs, which may induce a result that frequency of point defect and uneven application of an optically-compensatory film exceeds tolerance. Furthermore, when the curl falls within the above range, color unevenness which is apt to occur in the installation of the optically-anisotropic layer can be reduced and also air-bubble contamination at attaching a polarizing film can be prevented. Thus, the case is preferred.

The curl value can be measured in accordance with the measuring method defined by American National Standards Institute (ANSI/ASCPH 1.29-1985).

### (Tear Strength)

The tear strength of the film is measured by a method (Elmendorf tearing method) based on the tearing test method of JIS K-7128-2: 1998. The tear strength of the cellulose acylate film of the invention is preferably 2 g or more in the film thickness range of from 20 to 80 μm, more preferably from 5 to 25 g, even more preferably from 6 to 25 g. In the case that the film thickness is converted into 60 μm, the tear strength is preferably 8 g or more, more preferably from 8 to 15 g. Specifically, the tear strength can be measured by means of a light-load tearing tester after 2 hours of moisture conditioning under conditions of 25° C. and 65% RH.

### [Amount of Residual Solvent in Film]

At film formation, the cellulose acylate film of the invention is preferably dried under conditions so that the amount of residual solvent in the film falls in the range of from 0.01 to 1.5% by mass. More preferred is from 0.01 to 1.0% by mass. In the case that the cellulose acylate film of the invention is used as a transparent support for antireflective films or optically-compensatory films, curl can be suppressed by decreasing the amount of the residual solvent to 1.5% or less. More preferred is 1.0% by mass or less. A main reason for the effect is supposed to be that reduction of the amount of residual solvent at the film formation by a casting method (solvent casting method) using the above dope results in a decreased free volume.

### [Hygroscopic Expansion Coefficient]

The hygroscopic expansion coefficient of the cellulose acylate film of the invention is preferably 30×10⁻⁵% RH or less. The hygroscopic expansion coefficient is more preferably 15×10⁻⁵% RH or less, even more preferably 10×10⁻⁵% RH or less. Moreover, a lesser hygroscopic expansion coefficient is preferred but the value is ordinary 10×10⁻⁵% RH or more. The hygroscopic expansion coefficient represents change in length of a sample when relative humidity is changed under a constant temperature. By controlling the hygroscopic expansion coefficient, a picture frame-like increase in transmission, i.e., light leakage induced by strain can be prevented with maintaining the optically-compensatory function of an optically-compensatory film when the cellulose acylate film of the invention is used as a support for the optically-compensatory film.

### [Surface Treatment]

The cellulose acylate film can achieve improvement of adhesion of the cellulose acyate film with individual functional layers (e.g., undercoat layer and back layer) by optionally subjecting it to a surface treatment. For the surface treatment of the cellulose acylate film, a glow-discharge treatment, a UV irradiation treatment, a corona treatment, a flame treatment, or an acid or alkali treatment can be employed, for example.

The glow-discharge treatment herein may be a treatment with a low-temperature plasma induced with a low-pressure gas of 10⁻³ to 20 Torr or a plasma treatment under atmospheric pressure is also preferred. A plasma excitation gas means a gas which is excited to plasma under the above conditions and there may be mentioned argon, helium, neon, krypton, xenon, nitrogen, carbon dioxide, fluorocarbons such as tetrafluoromethane, and mixtures thereof. They are described in detail in Hatsumei Kyokai's Disclosure Bulletin 2001-1745 (issued Mar. 15, 2001, by Hatsumei Kyokai), pp. 30-32 and can be preferably employed.

### (Saponification Treatment)

As one of effective means for surface treatment in the case that the cellulose acylate film of the invention is used as a transparent protective film for polarizing plates, an alkali-saponification treatment may be mentioned.

The following will specifically describe the alkali-saponification treatment.

The alkali-saponification treatment of the cellulose acylate film is preferably carried out as a cycle of immersing the film surface in an alkali solution, neutralizing it with an acidic solution, and then washing and drying the film. As the alkali solution, there may be mentioned a potassium hydroxide solution and a sodium hydroxide solution. The concentration of the hydroxyl ion falls preferably within the range of from 0.1 to 5.0 mol/L, more preferably within the range of from 0.5 to 4.0 mol/L. The temperature of the alkali solution falls preferably within the range from room temperature to 90° C., more preferably within the range from 40 to 70° C.

In the above saponification treatment, the content of the retardation regulator and/or the UV absorber in the cellulose acylate film satisfies the following numerical formula (2), more preferably the following numerical formula (2-1):

0.9≦Cmₛ/Cmₒ≦1.0 Numerical formula (2)

0.95≦Cmₛ/Cmₒ≦1.0. Numerical formula (2-1)

wherein Cmₒ is the content before saponification and Cmₛ is the content after saponification.

With regard to the content of the compounds before and after saponification, the cellulose acylate film is treated with a solvent such as tetrahydrofuran to extract the compounds such as the retardation regulator, which is then detected and quantitatively determined by a high performance liquid chromatography.

In the cellulose acylate film of the invention, the contact angle of the film surface after alkali saponification treatment is preferably 55° or less, more preferably 50° or less, even more preferably 45° or less. The evaluation method of the contact angle comprises a usual method of dropping a water drop having a diameter of 3 mm onto the film surface and determining the angle between the film surface and the water drop, which can be used as evaluation of hydrophilicity.

In general, the surface energy of a solid can be determined by a contact angle method, a wet thermal method, and an adsorption method as described in “Nure no Kiso to Oyo” (issued on Dec. 10, 1989, by Realize Co.). In the case of the cellulose acylate film of the invention, it is preferred to use the contact angle method. Specifically, two kinds of solutions whose surface energy is known are dropped onto the cellulose acylate film and an angle between a tangent line of the liquid drop and the film surface at the cross point of the surface of the liquid drop and the film surface is defined as a contact angle. Then, the surface energy of the film can be calculated by computation based on the contact angles.

(Change in Re and Rth before and after Saponification of Film Surface)

With regard to the cellulose acylate film of the invention, change in the values of Re and Rth at a wavelength of 630 nm before and after saponification of the film surface with an alkali solution satisfies preferably the following numerical formula (7), more preferably the following numerical formula (7-1), even more preferably the following numerical formula (7-2):

|Re₆₃₀₍ₒ₎−Re₆₃₀₍ₛ₎|≦10 and |Rth₆₃₀₍ₒ₎−Rth₆₃₀₍ₛ₎|≦20, Numerical formula (7)

|Re₆₃₀₍ₒ₎−Re₆₃₀₍ₛ₎|≦8 and |Rth₆₃₀₍ₒ₎−Rth₆₃₀₍ₛ₎|≦15, Numerical formula (7-1)

|Re₆₃₀₍ₒ₎−Re₆₃₀₍ₛ₎|≦5 and |Rth₆₃₀₍ₒ₎−Rth₆₃₀₍ₛ₎|≦10, Numerical formula (7-2)

wherein Re₆₃₀₍ₒ₎ represents Re at a wavelength of 630 nm before saponification with an alkali solution, Re₆₃₀₍ₛ₎ represents Re at a wavelength of 630 nm after saponification with an alkali solution, Rth₆₃₀₍ₒ₎ represents Rth at a wavelength of 630 nm before saponification with an alkali solution, Rth₆₃₀₍ₛ₎ represents Rth at a wavelength of 630 nm after saponification with an alkali solution.

When the values fall within the above ranges, the optical performance of the protective film is by no means inferior and no light leakage occurs when the film is applied to a polarizing plate, optically-compensatory film, or liquid-crystal display device.

In this regard, a specific alkali saponification treatment in the invention means a procedure wherein a film sample having a size of 10 cm×10 cm is immersed in a 1.5 mol/L aqueous sodium hydroxide solution at 55° C. for 2 minutes and then, the film is neutralized with a 0.05 mol/L sulfuric acid solution at 30° C., washed in a water-washing bath at room temperature, and dried at 100° C.

### [Light Resistance]

As a measure of light resistance of the cellulose acylate film of the invention, change in Rth of the film irradiated with a super xenon light for 200 hours was measured. The xenon irradiation was carried out by irradiating the cellulose acylate film alone with a xenon light in a super xenon weather meter “SX-75” (manufactured by Suga Test Instruments, conditions of 60° C. and 50% RH) with 250,000 Lx for 200 hours. After the passage of a predetermined time, the film was taken out of a constant-temperature bath and subjected to moisture conditioning as above, followed by measurement.

Alternatively, as a measure of light resistance, color difference ΔE*a*b* may be employed. The film is irradiated with a super xenon light under the same conditions as above and the color difference ΔE*a*b* before and after the irradiation is preferably 20 or less, more preferably 18 or less, even more preferably 15 or less.

For the measurement of the color difference, “UV3100” (manufactured by Shimadzu Corporation) was employed. In the measurement, the film was subjected to moisture conditioning at 25° C. and 60% RH for 2 hours or more and then color of the film before xenon irradiation was measured to determine initial values (L₀*, a₀*, b₀*). Thereafter, the film alone was irradiated with a xenon light under conditions of 60° C. and 50% RH. After the passage of a predetermined time, the film was taken out of a constant-temperature bath and subjected to moisture conditioning at 25° C. and 60% RH for 2 hours. Then, color measurement was again carried out to determine values (L₁*, a₁*, b₁*) after irradiation. From these results, a color difference ΔE*a*b* was determined according to the following numerical formula (19):

ΔE*a*b*=[(L₀*−L₁*)²+(a₀*−a₁*)²+(b₀*−b₁*)²]^{1/2}. Numerical formula (19)

In the cellulose acylate film of the invention, the content of the retardation regulator and/or the UV absorber before and after irradiation satisfies preferably the following numerical formula (1), more preferably the following numerical formula (1-1):

0.8≦Cmₓ/Cmₒ≦1.0 Numerical formula (1)

0.9≦Cmₓ/Cmₒ≦1.0 Numerical formula (1)

wherein Cmₒ is the content of the compound before irradiation with a xenon light and Cmₓ is the content of the compound after irradiation with a xenon light.

It is more preferred that the above relation is satisfied by the retardation regulator.

In the above test, the film was irradiated with a super xenon light under the same conditions as above and the film before or after irradiation was treated with a solvent such as tetrahydrofuran to extract the compounds such as the retardation regulator, which was then detected and quantitatively determined by a high performance liquid chromatography. In this regard, in the test for light resistance in the invention, carbon arc irradiation may be employed, which is a similar acceleration test.

### <Uses of Cellulose Acylate Film>

### [Optical Uses]

The cellulose acylate film of the invention is applied to optical uses and photographic sensitive materials as its uses. Particularly, it is preferred that the film is used for liquid-crystal display devices as the optical uses. A liquid-crystal display device has commonly a constitution wherein a liquid-crystal cell supporting liquid crystals between two electrode substrates and two polarizing plates arranged at both faces thereof are arranged. The cellulose acylate film of the invention is preferably used as a protective film for polarizing plates or used for liquid-crystal display devices after incorporation of functional layer(s) to be mentioned below. As the liquid-crystal display devices, TN, IPS, FLC, AFLC, OCB, STN, ECB, VA, and HAN are preferred.

### [Functional Layer]

When the cellulose acylate film of the invention is used for the above optical uses, various functional layers may be incorporated. They may be, for example, an antistatic layer, a cured resin layer (transparent hard coat layer), an antireflection layer, an easy-adhesive layer, an antiglare layer, an optically-compensatory layer, an orientation layer, a liquid-crystal layer, and the like.

As these functional layers and materials thereof to be used in the cellulose acylate film of the invention, there may be mentioned a surfactant, a lubricant, a mat agent, an antistatic layer, a hard coat layer, and the like, which are described in detail in Hatsumei Kyokai's Disclosure Bulletin 2001-1745 (issued Mar. 15, 2001, by Hatsumei Kyokai), pp. 32-45 and are preferably used in the invention.

### [Usage (Polarizing Plate)]

Next, the usage of the cellulose acylate film according to the invention will be described.

The cellulose acylate film according to the invention is particularly useful as a protective film for a polarizing plate. When the cellulose acylate film is used as a protective film for a polarizing plate, the method for producing a polarizing plate is not limited especially, and a polarizing plate can be produced by a common method. A common method comprises treating the obtained cellulose acylate film with an alkali and then bonding to both faces of a polarizer, which has been constructed by dipping a polyvinyl alcohol film in an iodine solution and stretched, by using a completely saponified aqueous polyvinyl alcohol solution. As an alternative for the alkali treatment, use may be made of a treatment for facilitating adhesion as reported in JP-A-6-94915 or JP-A-6-118232.

Examples of the adhesive to be used for bonding the treated face of the protective film to the polarizer include polyvinyl alcohol-based adhesives such as polyvinyl alcohol and polyvinyl butyral, vinyl-based latexes such as butyl acrylate and so on.

The polarizing plate is composed of the polarizer and the protective films protecting both faces thereof. It may further have a protective film on one side of the polarizing plate and a separate film on the opposite face. The protect film and the separate film are employed in order to protect the polarizing plate during shipment, product inspection and other steps. In this case, the protective film, which aims at protecting the surface of the polarizing plate, is bonded to the face opposite to the face to be bonded to a liquid-crystal plate. On the other hand, the separate film, which aims at covering the adhesive layer to be boned to the liquid-crystal cell, is bonded to the face of the polarizing plate to be bonded to the liquid-crystal face.

In a liquid-crystal display device, a substrate containing liquid-crystals is usually provided between two polarizing plates. The protective film for polarizing plate comprising the cellulose acylate film according to the invention enables the achievement of excellent display characteristics at any site. It is particularly preferable to use the protective film for polarizing plate as a protective film for polarizing plate as the outmost layer in the display side of a liquid-crystal display device, since a transparent hard coat layer, an antiglare layer, an antireflective layer, etc. are formed therein.

### (Usage (Optically-Compensatory Film))

A cellulose acylate film of the present invention may be used for various uses but is particularly effective when the cellulose acylate film is used as an optically-compensatory film of a liquid-crystal display device. Incidentally, the optically-compensatory film is used in a liquid-crystal display device and indicates an optical material of compensating the phase difference, and this film has the same meaning as the retardation plate, optical compensatory sheet or the like. The optically-compensatory film has birefringence and is used for the purpose of eliminating the coloration on the display screen of a liquid-crystal display device or improving the viewing angle property.

Therefore, in the case that the cellulose acylate film of the invention is used as an optically-compensatory film for liquid-crystal display devices, Re and Rth of the optically-anisotropic layer to be used in combination fall preferably within the following ranges: i.e., Re is from 0 to 200 nm and |Rth| is from 0 to 400 nm. Any optically-anisotropic layer may be usable so far as the values fall within the ranges.

The optical performance and driving mode of the liquid-crystal cell of the liquid-crystal display device in which the cellulose acylate film of the invention is used are not specifically defined and any optically-anisotropic layer required as an optically-compensatory film may be used in combination. The optically-anisotropic layer to be used in combination may be formed of a composition containing a liquid-crystal compound or may be formed of a polymer film having birefringence.

### (Optically-Anisotropic Layer Comprising Liquid-Crystal Compound)

In the case that a layer containing a liquid-crystal compound is used as an optically-anisotropic layer, a discotic liquid-crystal compound or a rod-shaped liquid-crystal compound is preferred as the liquid-crystal compound.

### (Discotic Liquid-Crystal Compound)

Examples of the discotic liquid-crystal compound usable in the invention are described in various references (C. Destrade et al., Mol. Cryst. Liq. Cryst., Vol. 71, p. 111 (1981); Quarterly Journal of Outline of Chemistry, by the Chemical Society of Japan, No. 22, Chemistry of Liquid Crystal, Chap. 10, Sec. 2 (1994); B. Kohne et al., Angew. Chem. Soc. Chem. Comm., p. 1794 (1985); J. Zhang et al., J. Am. Chem. Soc., Vol. 116, p. 2655 (1994)).

Preferably, the discotic liquid-crystal molecules are fixed as aligned in the optically-anisotropic layer in the invention, most preferably fixed therein through polymerization. The polymerization of discotic liquid-crystal molecules is described in JP-A 8-27284. For fixing discotic liquid-crystal molecules through polymerization, a polymerizable group must be bonded to the disc core of each discotic liquid-crystal molecule as a substituent thereto. However, if such a polymerizable group is directly bonded to the disc core, then the molecules could hardly keep their orientation during polymerization. Accordingly, a linking group is introduced between the disc core and the polymerizable group to be bonded thereto. Such polymerizable group-having discotic liquid-crystal molecules are disclosed in JP-A 2001-4387.

### (Rod-Shaped Liquid-Crystal Compound)

Examples of the rod-shaped liquid-crystal compound usable in the invention are azomethines, azoxy compounds, cyanobiphenyls, cyanophenyl esters, benzoates, phenyl cyclohexanecarboxylates, cyanophenylcyclohexanes, cyano-substituted phenylpyrimidines, alkoxy-substituted phenylpyrimidines, phenyldioxanes, tolans, and alkenylcyclohexylbenzonitriles. Not only such low-molecular liquid-crystal compounds, but also high-molecular liquid-crystal compounds may also be usable herein.

In the optically-anisotropic layer, it is desirable that the rod-shaped liquid-crystal molecules are fixed in an aligned state, most preferably they are fixed through Ipolymerization. Examples of the polymerizable rod-shaped liquid-crystal compound usable in the invention are described in Macromol. Chem., Vol. 190, p. 2255 (1989); Advanced Materials, Vol. 5, p. 107 (1993); U.S. Pat. Nos. 4,683,327, 5,622,648, 5,770,107; pamphlets of International Laid-Open Nos. 95/22586, 95/24455, 97/00600, 98/23580, 98/52905; JP-A 1-272551, 6-16616, 7-110469, 11-80081, 2001-328973.

### (Optically-Anisotropic Layer Comprising Polymer Film)

The optically-anisotropic layer may also be formed from a polymer film. The polymer film is formed of a polymer capable of expressing optical anisotropy. Examples of such a polymer include polyolefin (e.g., polyethylene, polypropylene, norbornene-based polymer), polycarbonate, polyarylate, polysulfone, polyvinyl alcohol, polymethacrylic acid ester, polyacrylic acid ester and cellulose ester (e.g., cellulose triacetate, cellulose diacetate). Also, a copolymer of such a polymer or a mixture of these polymers may be used.

The optical anisotropy of the polymer film is preferably obtained by stretching. The stretching is preferably uniaxial stretching or biaxial stretching. More specifically, longitudinal uniaxial stretching utilizing peripheral velocity difference of two or more rolls, tenter stretching of stretching the polymer film in the width direction by nipping both sides, or biaxial stretching using these in combination is preferred. It is also possible that two or more polymer films are used and the optical property of two or more films as the whole satisfies the above-described conditions. The polymer film is preferably produced by a solvent casting method so as to lessen unevenness of birefringence. The thickness of the polymer film is preferably from 20 to 500 μm, and most preferably from 40 to 100 μm.

The polymer film constituting the optically-anisotropic layer may also be preferably produced by a method using at least one polymer material selected from the group consisting of polyamide, polyimide, polyester, polyether ketone, polyamideimide polyesterimide and polyarylether ketone, in which a solution-obtained by dissolving the polymer material in a solvent is coated on a substrate, and the solvent is dried to form a film. At this time, a method of stretching the polymer film with the substrate to express optical anisotropy and using the film as the optically-anisotropic layer is also preferably used. The cellulose acylate film of the present invention can be preferably used as the substrate. It is also preferred that the polymer film is produced on a separate substrate and after separating the polymer film from the substrate, laminated with the cellulose acylate film of the present invention and the resulting laminate is used as the optically-anisotropic layer. According to this method, the thickness of the polymer film can be decreased and is preferably 50 μm or less, more preferably from 1 to 20 μm.

### (Constitution of General Liquid-Crystal Display Device)

When the cellulose acylate film of the invention is used as an optically-compensatory film, the transmission axis of the polarizer element for it may be at any angle to the slow axis of the optically-compensatory film of the cellulose acylate film. A liquid-crystal display device comprises a liquid-crystal cell that carries a liquid crystal between two electrode substrates, two polarizing elements disposed on both sides of the cell, and at least one optically-compensatory film disposed between the liquid-crystal cell and the polarizing element.

The liquid-crystal layer of the liquid-crystal cell is generally formed by introducing a liquid crystal into the space formed by two substrates via a spacer put therebetween, and sealed up in it. A transparent electrode layer is formed on a substrate as a transparent film that contains a conductive substance. The liquid-crystal cell may further have a gas barrier layer, a hard coat layer or an undercoat layer (for adhesion to transparent electrode layer). These layers are generally formed on a substrate. The substrate of the liquid-crystal cell generally has a thickness of from 50 μm to 2 mm.

### (Type of Liquid-Crystal Display Device)

The cellulose acylate film of the invention may be used for liquid-crystal cells of various display modes. Various display modes such as TN (twisted nematic), IPS (in-plane switching), FLC (ferroelectric liquid-crystal), AFLC (anti-ferroelectric liquid-crystal), OCB (optically-compensatory bent), STN (super-twisted nematic), VA (vertically aligned), ECB (electrically-controlled birefringence) and HAN (hybrid aligned nematic) modes have been proposed. Also proposed are other display modes with any of the above-mentioned display modes aligned and divided. The transparent film of the invention is effective in liquid-crystal display devices of any display mode. Further, it is also effective in any of transmission-type, reflection-type and semitransmission-type liquid-crystal display devices.

### (TN-Mode Liquid-Crystal Display Device)

The cellulose acylate film of the invention may be used as a support of the optically-compensatory film in TN-mode liquid-crystal cell-having TN-mode liquid-crystal display devices. TN-mode liquid-crystal cells and TN-mode liquid-crystal display devices are well known from the past. The optically-compensatory film to be used in TN-mode liquid-crystal display devices is described in JP-A 3-9325, 6-148429, 8-50206, 9-26572. In addition, it is also described in Mori et al's reports (Jpn. J. Appl. Phys., Vol. 36 (1997), p. 143; Jpn. J. Appl. Phys., Vol. 36 (1997), p. 1068).

### (STN-Mode Liquid-Crystal Display Device)

The cellulose acylate film of the invention may be used as a support of the optically-compensatory film in STN-mode liquid-crystal cell-having STN-mode liquid-crystal display devices. In general, the rod-shaped liquid-crystal molecules in the liquid-crystal cell in an STN-mode liquid-crystal display device are twisted at an angle within a range of from 90 to 360 degrees, and the product of the refractivity anisotropy (Δn) of the rod-shaped liquid-crystal molecules and the cell gap (d), And falls between 300 and 1500 nm. The optically-compensatory film to be used in STN-mode liquid-crystal display devices is described in JP-A 2000-105316.

### (VA-Mode Liquid-Crystal Display Device)

The cellulose acylate film of the invention is especially favorable for a support of the optically-compensatory film in VA-mode liquid-crystal cell-having VA-mode liquid-crystal display devices. Preferably, the optically-compensatory film for use in VA-mode liquid-crystal display devices has a retardation Re of from 0 to 150 nm and a retardation Rth of from 70 to 400 nm. More preferably, the retardation Re of the film is from 20 to 70 nm. When two optically-anisotropic polymer films are used in a VA-mode liquid-crystal display device, then the retardation Re of the films preferably falls between 70 and 250 nm. When one optically-anisotropic polymer film is used in a VA-mode liquid-crystal display device, then the retardation Rth of the film preferably falls between 150 and 400 nm. The VA-mode liquid-crystal display devices for the invention may have an orientation-divided system, for example, as in JP-A 10-123576.

### (IPS-Mode Liquid-Crystal Display Device, and ECB-Mode Liquid-Crystal Display Device)

The cellulose acylate film of the invention is also favorable for a support of the optically-compensatory film and for a protective film of the polarizing plate in IPS-mode or ECB-mode liquid-crystal cell-having IPS-mode liquid-crystal display devices and ECB-mode liquid-crystal display devices. In these modes, the liquid-crystal material is aligned nearly in parallel to the film face in black display, and the liquid-crystal molecules are aligned in parallel to the surface of the substrate when no voltage is applied to the device for black display. In these embodiments, the polarizing plate that comprises the cellulose acylate film of the invention contributes to enlarging the viewing angle and to improving the image contrast. In these embodiments, of the protective films for the polarizing plates disposed in top and bottom of the liquid-crystal cell, it is prefer to use a polarizing plate, which comprises the cellulose acylate film of the invention as a protective film disposed between the liquid-crystal cell and the polarizing plate (protective film in cell side), in at least one side of the liquid-crystal cell. More preferably, the optically-anisotropic layer is disposed between the protective film of the polarizing plate and the liquid crystal cell, and the retardation value of the optically-anisotropic layer disposed between the protective film of the polarizing plate and the liquid crystal cell is preferably at most 2 times the value of Δn·d of the liquid-crystal layer.

### (OCB-Mode Liquid-Crystal Display Device, and HAN-Mode Liquid-Crystal Display Device)

The cellulose acylate film of the invention is also favorable for a support of the optically-compensatory film in OCB-mode liquid-crystal cell-having OCB-mode liquid-crystal display devices and HAN-mode liquid-crystal cell-having HAN-mode liquid-crystal display devices. Preferably, the optically-compensatory film for use in OCB-mode liquid-crystal display devices and HAN-mode liquid-crystal display devices is so designed that the direction in which the absolute value of the retardation of the film is the smallest does not exist both in the in-plane direction and in the normal line direction of the optically-compensatory film. The optical properties of the optically-compensatory film for use in OCB-mode liquid-crystal display devices and HAN-mode liquid-crystal display devices are determined, depending on the optical properties of the optically-anisotropic layer, the optical properties of the support and the positional relationship between the optically-anisotropic layer and the support. The optically-compensatory film for use in OCB-mode liquid-crystal display devices and HAN-mode liquid-crystal display devices is described in JP-A 9-197397. It is described also in Mori et al's reports (Jpn. J. Appl. Phys., Vol. 38 (1999), p. 2837).

### (Reflection-Type Liquid-Crystal Display Device)

The cellulose acylate film of the invention is also favorably used for an optically-compensatory film in TN-mode, STN-mode, HAN-mode or GH (guest-host)-mode reflection-type liquid-crystal display devices. These display modes are well known from the past. TN-mode reflection-type liquid-crystal devices are described in JP-A 10-123478, pamphlet of International Laid-Open No. 98/48320, and Japanese Patent 3022477. The optically-compensatory film for use in reflection-type liquid-crystal display devices is described in pamphlet of International Laid-Open No. 00/65384.

### (Other Liquid-Crystal Display Devices)

The cellulose acylate film of the invention is also favorably used as a support of the optical compensatory film in ASM (axially symmetric aligned microcell)-mode liquid-crystal cell-having ASM-mode liquid-crystal display devices. The liquid-crystal cell in ASM-mode devices is characterized in that it is supported by a resin spacer capable of controlling and varying the thickness of the cell. The other properties of the cell are the same as those of the liquid-crystal cell in TN-mode devices. ASM-mode liquid-crystal cells and ASM-mode liquid-crystal display devices are described in Kume et al's report (Kume et al., SID 98 Digest 1089 (1998)).

### (Hard Coat Film, Antiglare Film, Antireflection Film)

The cellulose acylate film of the invention is favorably applied to hard coat films, antiglare films and antireflection films. For the purpose of improving the visibility of flat panel displays such as LCD, PDP, CRT, EL, any or all of a hard coat layer, an antiglare layer and an antireflection layer may be fitted to one or both faces of the cellulose acylate film of the invention. Preferred embodiments of such antiglare films and antireflection films are described in Hatsumei Kyokai's Disclosure Bulletin 2001-1745 (issued Mar. 15, 2001, by Hatsumei Kyokai), pp. 54-57, and the cellulose acylate film of the invention may be favorably used in these.

### (Photographic Film Support)

The cellulose acylate film usable in the invention is applicable to supports of silver halide photographic materials. Various materials and formulations and methods for processing them are described in some patent publications, and they may apply to the invention. Regarding the techniques, JP-A 2000-105445 has detailed descriptions of color negative films, and the cellulose acylate film of the invention is favorably used in these. Also preferably, the film of the invention is applicable to supports of color reversal silver halide photographic materials, and various materials and formulations and methods for processing them described in JP-A 11-282119 are applicable to the invention.

### [Transparent Substrate]

Since the cellulose acylate film of the invention has nearly zero optical anisotropy and has good transparency, it may be substitutable for the glass substrate for liquid-crystal cells in liquid-crystal display devices, or that is, it may be usable as a transparent support for sealing up the driving liquid crystals in the devices.

Since the transparent substrate for sealing up liquid crystal must have a good gas-barrier property, a gas-barrier layer may be optionally fitted to the surface of the cellulose acylate film of the invention, if desired. The morphology and the material of the gas-barrier layer are not specifically defined. For example, SiO₂ may be deposited on at least one face of the cellulose acylate film of the invention, or a polymer coating layer of a vinylidene-based polymer or a vinyl alcohol-based polymer having a relatively higher gas-barrier property may be formed on the film of the invention. These techniques may be suitably selected for use in the invention.

When the film of the invention is used as a transparent substrate for sealing up liquid crystal, a transparent electrode may be fitted to it for driving liquid crystal through voltage application thereto. The transparent electrode is not specifically defined. For example, a metal film or a metal oxide film may be laminated on at least one surface of the cellulose acylate film of the invention so as to form a transparent electrode on it. Above all, a metal oxide film is preferred in view of the transparency, the electroconductivity and the mechanical characteristics of the film; and a thin film of indium oxide essentially comprising tin oxide and containing from 2 to 15 mass % of zinc oxide is more preferred. These techniques are described in detail, for example, in JP-A 2001-125079 and 2000-227603.

### EXAMPLES

The following will describe Examples of the invention but the invention is not limited thereto.

### <Preparation of Cellulose Acylate Film>

### Example 1-1

### Preparation of Cellulose Acylate Stock Solution (CAL-1)

The following composition was charged into a mixing tank and stirred under heating to dissolve individual components, whereby a cellulose acylate stock solution (CAL-1) was prepared.

{Composition of Cellulose Acylate Stock Solution (CAL-1)}

| | | |
|---|---|---|
| Cellulose acetate | 100 | parts by mass |
| (degree of acetyl substitution of 2.94, | | |
| mean degree of polymerization of 310) | | |
| Methylene chloride (first solvent) | 402 | parts by mass |
| Methanol (second solvent) | 60 | parts by mass |

### [Preparation of Mat Agent Solution (ML-1)]

The following composition was charged into a dispersing machine and stirred to dissolve individual components, whereby a mat agent solution (ML-1) was prepared.

{Composition of Mat Agent Solution (ML-1)}

| | | |
|---|---|---|
| Silica particles dispersion | 10.0 | parts by mass |
| (mean particle size of 16 nm) | | |
| (“AEROSIL R972”, manufactured | | |
| by Japan Aerosil K.K.) | | |
| Methylene chloride (first solvent) | 76.3 | parts by mass |
| Methanol (second solvent) | 3.4 | parts by mass |
| Cellulose acylate stock solution (CAL-1) | 10.3 | parts by mass |

### [Preparation of Retardation Regulator Solution (REL1-1)]

The following composition was charged into another mixing tank and stirred under heating, whereby a retardation regulator solution (REL1-1) was prepared.

{Composition of Retardation Regulator Solution (REL1-1)}

| | | |
|---|---|---|
| UV absorber (UV-107) | 7.6 | parts by mass |
| Retardation regulator (A-20) | 49.3 | parts by mass |
| Methylene chloride (first solvent) | 58.4 | parts by mass |
| Ethanol (second solvent) | 8.7 | parts by mass |
| Cellulose acylate stock solution (CAL-1) | 12.8 | parts by mass |

### [Manufacture of Cellulose Acylate Film (101)]

After filtration of each solution, 94.6 parts by mass of the above cellulose acylate stock solution (CAL-1), 1.3 parts by mass of the mat agent solution (ML-1), and 4.1 parts by mass of the retardation regulator solution (REL1-1) were mixed and the mixture was thoroughly stirred under heating to dissolve individual components, whereby a dope (DPI-1) was prepared. The resulting dope (DP1-1) was cast using a band casting machine. A film was peeled off at a residual solvent content of 26% by mass and then dried at 140° C. for 40 minutes to prepare a cellulose acylate film sample (101) having a thickness of 80 μm.

In the above composition, the amounts to be added relative to 100 parts by mass of the cellulose acylate were 1.8 parts by mass for the UV absorber (UV-107) and 12.0 parts by mass for the retardation regulator (A-20).

### Examples 1-2 to 1-11 and Comparative Examples 1-1 to 1-3

### Preparation of Retardation Regulator Solutions (REL1-2) to (REL1-16)

The retardation regulator solutions (REL1-2) to (REL1-16) were prepared in the same manner as in the preparation of the retardation regulator solution (REL1-1) except that the kind of the retardation regulator solution was changed or was not used and/or the kind of the UV absorber was changed or was not used in the preparation of the retardation regulator solution (REL1-1), as shown in Table 2. In this regard, each of the retardation regulator and UV absorber used is a compound having a molecular weight of 1,000 or less. The retardation regulators used except TPP of Comparative Example 1-2 satisfy the numerical formula (11) and all of them has a value of Rth(a)−Rth(0)/a of −2.0 or less. The value of the numerical formula (11) for TPP is 0.1 or less when a=12.0, and the value of the numerical formula (10) is also 0.1 or less for TPP.

### [Preparation of Cellulose Acylate Films (102) to (116)]

The cellulose acylate film samples (102) to (116) were prepared in the same manner as in Example 1-1 except that dopes (DP1-2) to (DP1-16) were prepared using any one of the retardation regulator solutions (REL1-2) to (REL1-16) instead of the retardation regulator solution (REL1-1) and a cellulose acylate film was prepared using each of the resulting dopes in the preparation of the cellulose acylate film sample (101) in Example 1-1. The thickness of the cellulose acylate film sample was in the range of from 79.5 to 80.5 μm in all the cellulose acylate film samples (102) to (116). Moreover, in the samples (101) to (116), the difference between a maximum value and a minimum value of thickness of any film randomly cut into a size of 1 m square fell within 5% relative to mean value of the thickness.

TABLE 2

| | | Dope | | | | | | | | |
|---|---|---|---|---|---|---|---|---|---|---|
| | | | | | Retardation regulator solution | | | | | |
| | | | CA*¹ | Mat | | Retardation | | | | |
| | | | stock | agent | | regulator | | UV absorber | | |
| | Film | | solution | solution | | | Amount | | Amount | Maximum |
| | No. | No. | No. | No. | No. | Kind | added*² | Kind | added* | wavelength (nm) |
| Example 1-1 | 101 | DP1-1 | CAL-1 | ML-1 | REL-1 | A-20 | 12.0 | UV-107 | 1.8 | 342 |
| Comparative | 102 | DP1-2 | CAL-1 | ML-1 | REL-2 | A-20 | 12.0 | — | — | — |
| Example 1-1 | | | | | | | | | | |
| Example 1-2 | 103 | DP1-3 | CAL-1 | ML-1 | REL-3 | A-20 | 12.0 | UV-19 | 1.8 | 348 |
| Example 1-3 | 104 | DP1-4 | CAL-1 | ML-1 | REL-4 | B-6 | 12.0 | UV-19 | 1.8 | 348 |
| Example 1-4 | 105 | DP1-5 | CAL-1 | ML-1 | REL-5 | CA-5 | 12.0 | UV-19 | 1.8 | 348 |
| Example 1-5 | 106 | DP1-6 | CAL-1 | ML-1 | REL-6 | SA-11 | 12.0 | UV-19 | 1.8 | 348 |
| Example 1-6 | 107 | DP1-7 | CAL-1 | ML-1 | REL-7 | SB-8 | 12.0 | UV-19 | 1.8 | 348 |
| Example 1-7 | 108 | DP1-8 | CAL-1 | ML-1 | REL-8 | SC-1 | 12.0 | UV-19 | 1.8 | 348 |
| Example 1-8 | 109 | DP1-9 | CAL-1 | ML-1 | REL-9 | A-14 | 12.0 | UV-38 | 1.8 | 351 |
| Example 1-9 | 110 | DP1-10 | CAL-1 | ML-1 | REL-10 | A-20 | 12.0 | UV-15 | 1.8 | 342 |
| Example 1-10 | 111 | DP1-11 | CAL-1 | ML-1 | REL-11 | A-20 | 12.0 | UV-204 | 1.8 | 326 |
| Example 1-11 | 112 | DP1-12 | CAL-1 | ML-1 | REL-12 | A-20 | 12.0 | UV-309 | 1.8 | 304 |
| Example 1-12 | 115 | DP1-15 | CAL-1 | ML-1 | REL-15 | A-20 | 12.0 | UV-223 | 1.8 | 327 |
| Example 1-13 | 116 | DP1-16 | CAL-1 | ML-1 | REL-16 | A-20 | 12.0 | UV-126 | 1.8 | 340 |
| Comparative | 113 | DP1-13 | CAL-1 | ML-1 | REL-13 | TPP*³ | 12.0 | UV-107 | 1.8 | 342 |
| Example 1-2 | | | | | | | | | | |
| Comparative | 114 | DP1-14 | CAL-1 | ML-1 | REL-14 | — | — | UV-107 | 1.8 | 342 |
| Example 1-3 | | | | | | | | | | |

CA*¹cellulose acylate
Amount added*²part by mass relative to 100 parts by mass of cellulose acylate
TPP*³triphenyl phosphate

Table 3 shows various retardation properties, change in Rth before and after xenon irradiation, change in Rth and Re before and after saponification, spectral transmittance, and ratio of contents of the retardation regulator and UV absorber before and after saponification of the resulting cellulose acylate films (102) to (116).

With regard to variation of Re and Rth of the cellulose acylate film samples (101) to (116) in a film having a size of 1 m square, the value of |Re₆₃₀₍ₘₐₓ₎−Re₆₃₀₍ₘᵢₙ₎| was 4 nm or less and the value of |Rth₆₃₀₍ₘₐₓ₎−Rth₆₃₀₍ₘᵢₙ₎| was 5 nm or less in all the samples and thus the results were preferred.

TABLE 3

| | | Retardation | | | | | | | | | | | |
|---|---|---|---|---|---|---|---|---|---|---|---|---|---|
| | | | | Rth change | | | | Change before | | | | Cmₛ/Cm₀ before and | |
| | | | | before and | | | | and after | | Spectral | | after saponification | |
| | | | | after xenon | | | | saponification | | transmittance | | Retar- | |
| | Film | Rth₆₃₀ | Re₆₃₀ | irradiation | ΔRth*¹ | ΔRe*¹ | \|Re₆₃₀ × | Rth | Re | 400 nm | 350 nm | dation | UV |
| | No. | (mm) | (mm) | (nm) | (nm) | (nm) | Rth₆₃₀\| | (nm) | (nm) | (%) | (%) | regulator | absorber |
| Example 1-1 | 101 | −10 | 3 | 10 | 20 | 5 | 30 | 2 | 2 | 77 | =<1 | 0.91 | 0.91 |
| Comparative | 102 | −27 | 2 | 18 | 33 | 7 | 54 | 7 | 3 | 89 | 90.5 | 0.82 | — |
| Example 1-1 | | | | | | | | | | | | | |
| Example 1-2 | 103 | 24 | 1 | 3 | 9 | 4 | 24 | 1 | 2 | 64.5 | =<1 | 0.95 | 0.98 |
| Example 1-3 | 104 | 10 | 1 | 4 | 8 | 3 | 10 | 1 | 1 | 64.5 | =<1 | 0.94 | 0.98 |
| Example 1-4 | 105 | −5 | 2 | 2 | 10 | 3 | 10 | 1 | 1 | 64.5 | =<1 | 0.96 | 0.98 |
| Example 1-5 | 106 | 20 | 2 | 8 | 9 | 3 | 40 | 1 | 1 | 64.5 | =<1 | 0.91 | 0.98 |
| Example 1-6 | 107 | 13 | 3 | 5 | 8 | 3 | 39 | 1 | 1 | 64.5 | =<1 | 0.92 | 0.98 |
| Example 1-7 | 108 | 15 | 3 | 6 | 8 | 3 | 30 | 1 | 1 | 64.5 | =<1 | 0.91 | 0.98 |
| Example 1-8 | 109 | 22 | 1 | 2 | 10 | 2 | 22 | 1 | 1 | 66.5 | =<1 | 0.95 | 0.98 |
| Example 1-9 | 110 | −9 | 1 | 3 | 11 | 4 | 9 | 2 | 1 | 77 | =<1 | 0.94 | 0.91 |
| Example 1-10 | 111 | 22 | 2 | 5 | 13 | 4 | 44 | 4 | 1 | 89 | =<1 | 0.93 | 0.93 |
| Example 1-11 | 112 | 15 | 4 | 11 | 14 | 5 | 60 | 4 | 1 | 91 | =<1 | 0.93 | 0.93 |
| Example 1-12 | 115 | −7 | 2 | 9 | 7 | 3 | 21 | 1 | 1 | 78 | =<1 | 0.93 | 0.93 |
| Example 1-13 | 116 | −5 | 2 | 5 | 8 | 3 | 24 | 1 | 1 | 88 | =<1 | 0.98 | 0.98 |
| Comparative | 113 | 51 | 5 | 9 | 35 | 11 | 255 | 1 | 1 | 87.5 | =<1 | 0.98 | 0.98 |
| Example 1-2 | | | | | | | | | | | | | |
| Comparative | 114 | 55 | 5 | 9 | 36 | 11 | 275 | 1 | 1 | 87.5 | =<1 | 0.98 | 0.98 |
| Example 1-3 | | | | | | | | | | | | | |

ΔRth*¹change in Rth in the wavelength range of from 400 to 700 nm
ΔRe*²change in Re in the wavelength range of from 400 to 700 nm

From the results in the above Table 3, the retardation regulators suitably used in the invention have a high ability to lower Rth but are insufficient in view of change in optical properties before and after xenon irradiation. By using the regulator in combination with the UV absorber in the invention, both of light resistance and a low optical anisotropy can be achieved. Also, it is revealed that it is possible to reduce change in Rth in a visible wavelength region and change in Rth before and after saponification treatment by combining the both agents and thus the combination is preferred.

Moreover, from the viewpoint of reducing the change in Rth after saponification treatment, it is revealed that it is preferred to use, as a UV absorber, a polymeric compound where plurality of triazine-based compounds or UV absorbable units are bonded.

Furthermore, in view of light resistance, it is revealed that an excellent effect can be obtained using a triazine-based compound as a UV absorber.

### Example 11

With regard to the cellulose acylate film samples (101) to (103) of Examples 1-1 to 1-2 and Comparative Example 1-1, a residual ratio after xenon irradiation (aforementioned Cmₓ/Cmₒ) was measured using film samples before and after xenon irradiation. The results are shown in the following Table 4.

TABLE 4

| | Film | Cmₓ/Cmₒ before and after xenon irradiation | |
|---|---|---|---|
| | No. | Retardation regulator | UV absorber |
| Example 11-1 | 101 | 0.91 | 0.85 |
| Comparative | 102 | 0.75 | — |
| Example 11-1 | | | |
| Example 11-2 | 103 | 0.95 | 0.92 |

When the ratio of Cmₓ/Cmₒ falls within the range defined in the invention as in the cases of the film samples (101) and (103), a cellulose acylate film having a preferred retardation and a small change in optical properties during xenon irradiation is obtained.

### Example 2

### Preparation of Cellulose Acylate Stock Solution (CAL-2)

The following composition was charged into a mixing tank and stirred under heating to dissolve individual components, whereby a cellulose acylate stock solution (CAL-2) was prepared.

{Composition of Cellulose Acylate Stock Solution (CAL-2)}

| | | |
|---|---|---|
| Cellulose acylate | 100 | parts by mass |
| (degree of acetyl substitution of 2.86, | | |
| mean degree of polymerization of 310) | | |
| Triphenyl phosphate (plasticizer) | 7.8 | parts by mass |
| Biphenyl diphenyl phosphate (plasticizer) | 3.9 | parts by mass |
| Methylene chloride (first solvent) | 400 | parts by mass |
| Methanol (second solvent) | 60 | parts by mass |

### [Preparation of Retardation Regulator Solution (REL2-1)]

The following composition was charged into another mixing tank and stirred under heating, whereby a retardation regulator solution (REL2-1) was prepared.

{Composition of Retardation Regulator Solution (REL2-1)}

| | | |
|---|---|---|
| UV absorber (UV-19) | 4.0 | parts by mass |
| Retardation regulator (A-14) | 40.0 | parts by mass |
| Methylene chloride (first solvent) | 80.0 | parts by mass |
| Methanol (second solvent) | 20.0 | parts by mass |

### [Manufacture of Cellulose Acylate Film (201)]

To 477 parts by mass of the cellulose acylate stock solution (CAL-2) was added 40 parts by mass of the retardation regulator solution (REL2-1), and the mixture was thoroughly stirred to prepare a dope (DP2-1). The resulting dope (DP2-1) was cast onto a drum cooled at 0° C. A film was peeled off at a time point of a residual solvent content of 50% by mass and then both ends in the width direction of the film were fixed with a pin tenter (pin tenter described in FIG. 3 of JP-A-4-1009). The film was dried in a state where a solvent content was from 3 to 5% by mass with maintaining intervals so that stretching ratio in the width direction (direction perpendicular to the machine direction) was 3%. Thereafter, the film was further dried by carrying it through rolls of a heat treatment equipment to manufacture a cellulose acylate film sample (201) having a thickness of 80 μm.

When the cellulose acylate film sample (201) thus manufactured was evaluated as in Example 1, it was found that the cellulose acylate film of the invention was small in both of Re and Rth and thus was preferred. Moreover, change in Re {|Re₍ₙ₎−Re₍₀₎|/n: Re₍ₙ₎ is Re of a film stretched in a ratio of n(%) and Re₍₀₎ is Re of an unstreched film} by stretching of the cellulose acylate film sample (201) was 0.63 and thus it was found that change in Re before and after stretching was also small and thus the film was preferred.

### Examples 3-1 to 3-2

By using a liquid UV absorber, decrease of precipitation of foreign particles is demonstrated.

### [Preparation of Retardation Regulator Solution (REL3-1)]

A retardation regulator solution (REL3-1) was prepared in the same manner as in the preparation of the retardation regulator solution (REL1-1) except that a UV absorber (UV-111) was used in the same amount instead of the UV absorber (UV-107).

### [Preparation of Retardation Regulator Solution (REL3-2)]

A retardation regulator solution (REL3-2) was prepared in the same manner as in the preparation of the retardation regulator solution (REL1-1) except that a 1:1 mixture of a UV absorber (UV-116) and a UV absorber (117) was used in the same amount instead of the UV absorber (UV-107).

### [Manufacture of Cellulose Acylate Films (301) and (302)]

The cellulose acylate film samples (301) and (302) were manufactured in the same manner as in Example 1-1 except that dopes (DP3-1) and (DP3-2) are prepared using the retardation regulator solutions (REL3-1) and (REL3-2), respectively, instead of the retardation regulator solution (REL1-1) and a cellulose acylate film is manufactured using each of the resulting dopes. When the resulting cellulose acylate film samples (301) and (302) were evaluated as in Example 1, preferable retardation was obtained in both cases.

### [Evaluation of Precipitation of Foreign Particles]

After the manufacture of the cellulose acylate film samples (101) and (112) obtained in Example 1 and the cellulose acylate film samples (301) and (302) obtained in Example 3, each of the films was wound up in a roll shape and the original roll was stored at 35° C. and 90% RH for 2 months. Each cellulose acylate film was cut into a size of 100 mm×100 mm. The cut film was observed under crossed nicols in a magnification of 30 times using a polarizing microscope and the following evaluation was performed based on number of foreign particles.

◯: number of foreign particles of from 0 to 10

Δ: number of foreign particles of from 11 to 50

X: number of foreign particles of 51 or more

TABLE 5

| | | | | | | | | | | | | Number |
|---|---|---|---|---|---|---|---|---|---|---|---|---|
| | | | Dope | | | | | | | | | of |
| | | | | | Retardation regulator solution | | | | | | | foreign |
| | | | CA*¹ | Mat | | Retardation | | UV absorber | | | | parti- |
| | | | stock | agent | | regulator | | | | Maximum | | cles |
| | Film | | solution | solution | | | Amount | | Amount | wavelength | | precipi- |
| | No. | No. | No. | No. | No. | Kind | added*² | Kind | added* | (nm) | Form | tated |
| Example 1-1 | 101 | DP1-1 | CAL-1 | ML-1 | REL1-1 | A-20 | 12.0 | UV-107 | 1.8 | 342 | powder | Δ |
| Example 1-11 | 112 | DP1-12 | CAL-1 | ML-1 | REL1- | A-20 | 12.0 | UV-309 | 1.8 | 304 | liquid | ◯ |
| | | | | | 12 | | | | | | | |
| Example 3-1 | 301 | DP3-1 | CAL-1 | ML-1 | REL3-1 | A-20 | 12.0 | UV-111 | 1.8 | 340 | powder | X |
| Example 3-2 | 302 | DP3-2 | CAL-1 | ML-1 | REL3-2 | A-20 | 12.0 | UV-116 | 0.9 | 348 | liquid | ◯ |
| | | | | | | | | UV-117 | 0.9 | 342 | liquid | |

From the above Table, it is revealed that trouble of precipitation of foreign particles can be reduced with preferable retardation and thus production suitability can be improved when a liquid UV absorber suitable in the invention is used.

### <Manufacture of Polarizing Plate>

### Example 21

### Saponification Treatment

The cellulose acylate film sample (103) manufactured in Example 1 was immersed in a 1.5 mol/L sodium hydroxide aqueous solution at 55° C. for 2 minutes. The sample was washed in a washing water bath at room temperature and then neutralized with 0.05 mol/L sulfuric acid at 30° C. The sample was again washed in a washing water bath at room temperature and further dried with hot air of 100° C. Thus, the surface of the cellulose acylate film was saponified.

### [Manufacture of Polarizing Plate]

A polarizer was manufactured by adsorbing iodine onto a stretched polyvinyl alcohol film.

Then, the saponified cellulose acylate film sample (103) was attached to one face of the polarizer with a polyvinyl alcohol-based adhesive. They were arranged so that the retardation axis of the transparent support and the transmission axis of the polarizer were parallel to each other.

A commercial cellulose triacetate film “Fujitack TD80UF” (manufactured by Fuji Photo Film Co., Ltd.) was saponified in the same manner as above and then attached to an opposite side of the polarizer with a polyvinyl alcohol-based adhesive. Thus, a polarizing plate (P-1) was manufactured.

[Manufacture of Polarizing Plate with Retardation Film]

A norbornene-based resin film having a thickness of 100 μm (manufactured by JSR, “Artone”) was stretched at 175° C. by means of a tenter stretching machine to manufacture a retardation film having a refractive properties of nₓ>n_{y}>n_{z} and having Re of 40 nm and Rth of 30 nm, which was then attached to the cellulose acylate film (103) side of the above polarizing plate (P-1) with an adhesive to manufacture a polarizing plate with retardation film.

### Example 31

### Mounting Evaluation to IPS Liquid-Crystal Display Device

Using the cellulose acylate film sample (104) of the invention manufactured in Example 1, an optically-compensatory function was imparted to the polarizing plate (P-2) manufactured similarly to Example 21 by attaching a uniaxially stretched optically-compensatory film thereto. At that time, viewing properties can be improved without changing in-plane properties by arranging the retardation axis of retardation in the in-plane direction of the optically-compensatory film and the transmission axis of the polarizing plate orthogonal. An optically-compensatory film having a retardation in the in-plane direction Re of 270 nm, a retardation in the thickness direction Rth of 0 nm, and an Nz factor of 0.5 was used.

A display device was manufactured wherein a laminate of the polarizing plate using the cellulose acylate film sample (104) of the invention and the optically-compensatory film manufactured as above, an IPS-mode liquid-crystal cell, and a polarizing plate using the cellulose acylate film sample (101) of the invention were overlaid in this order from the top. At that time, the transmission axes of the upper and lower polarizing plates were arranged orthogonal and the transmission axis of the upper polarizing plate was made parallel to the molecular long-axis direction of the liquid-crystal cell, i.e., the retardation axis of the optically-compensatory layer and the molecular long-axis direction of the liquid-crystal cell were arranged orthogonal. As the liquid-crystal cell, electrodes and substrate, those hitherto used as IPS can be employed as they are. The orientation of the liquid-crystal cell is horizontal orientation and the liquid crystal has positive dielectric anisotropy. As the liquid crystal, one developed for IPS liquid crystal and commercially available can be used. The physical properties of the liquid-crystal cell were as follows: Δn of liquid crystal: 0.099, cell gap of liquid crystal layer: 3.0 μm, pre-tilt angle: 5°, and rubbing direction: 75° at upper and lower parts of the substrate.

In the liquid-crystal display device manufactured as above, when a light leakage ratio at the time when black was displayed was measured in the azimuthal angle direction of 45° and in the polar angle direction of 70° from the front face of the device, it was revealed that the optically-compensatory film and polarizing plate manufactured with the cellulose acylate film of the invention have a wide contrast viewing angle and thus are preferred.

### INDUSTRIAL APPLICABILITY

According to the studies of the inventors, a cellulose acylate film having a small optical anisotropy Re, Rth and an excellent light resistance can be manufactured and furthermore a cellulose acylate film having an excellent saponification resistance can be manufactured. Using the cellulose acylate film, it becomes possible to provide optical materials such as an optically-compensatory film and a polarizing plate, and a liquid-crystal display device using the same.

The entire disclosure of each and every foreign patent application from which the benefit of foreign priority has been claimed in the present application is incorporated herein by reference, as if fully set forth.

1. A cellulose acylate film comprising:
at least one retardation regulator; and
at least one UV absorber having at least one absorption maximum in a wavelength range of from 250 nm to 380 nm.

2. The cellulose acylate film according to claim 1,
wherein the at least one retardation regulator is a compound satisfying numerical formula (11-1):
Rth(a)−Rth(0)/a≦−1.5 Numerical formula (11-1)
wherein 0.01≦a≦30;
Rth(a) represents Rth (nm) of a cellulose acylate film containing the at least one retardation regulator in an amount of a % at a wavelength of 630 nm;
Rth(0) represents Rth (nm) of a cellulose acylate film containing no retardation regulator at a wavelength of 630 nm; and
a represents part by mass of the at least one retardation regulator relative to 100 parts by mass of a cellulose acylate.

3. The cellulose acylate film according to claim 1,
wherein at least one of the at least one retardation regulator is a compound represented by any one of formulae (1) to (6): 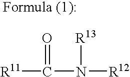
wherein R¹¹ represents an aryl group; R¹² and R¹³ each independently represents an alkyl group or an aryl group, and at least one of which is an aryl group; and the alkyl group and the aryl group each may have a substituent; 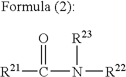
wherein R²¹, R²², and R²³ each independently represents an alkyl group; and the alkyl group may have a substituent; 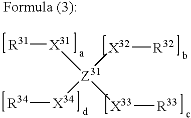
wherein R³¹, R³², R³³ and R³⁴ each independently represents a hydrogen atom, a substituted or unsubstituted aliphatic group or a substituted or unsubstituted aromatic group; X³¹, X³², X³³ and X³⁴ each independently represents a divalent connecting group formed of one or more groups selected from the group consisting of a single bond, —CO— and —NR³⁵— in which R³⁵ represents a substituted or unsubstituted aliphatic group or a substituted or unsubstituted aromatic group; a, b, c and d each is an integer of 0 or more, and a+b+c+d is 2 or more; and Z³¹ represents an (a+b+c+d) valent organic group excluding a cyclic group; 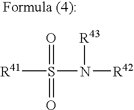
wherein R⁴¹ represents an alkyl group or an aryl group; R⁴² and R⁴³ each independently represents a hydrogen atom, an alkyl group or an aryl group; and a total carbon number of R⁴¹, R⁴² and R⁴³ is 10 or more; 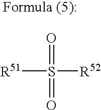
wherein R⁵¹ and R⁵² each independently represents an alkyl group or an aryl group; and a total carbon number of R⁵¹ and R⁵² is 10 or more; 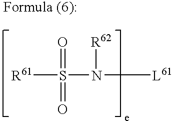
wherein R⁶¹ represents a substituted or unsubstituted aliphatic group or a substituted or unsubstituted aromatic group; R⁶² represents a hydrogen atom, a substituted or unsubstituted aliphatic group or a substituted or unsubstituted aromatic group; L⁶¹ represents a 2 to 6 valent connecting group; and e is an integer of 2 to 6 corresponding to the valency of L⁶¹.

4. The cellulose acylate film according to claim 3,
wherein at least one of the at least one retardation regulator is a compound represented by any one of the formulae (1) to (3).

5. The cellulose acylate film according to claim 1,
wherein the at least one UV absorber is at least one compound represented by formulae (7) to (9):
Q⁷¹-Q⁷²-OH Formula (7)
wherein Q⁷¹ represents a nitrogen-containing aromatic heterocycle; and Q⁷² represents an aromatic ring; 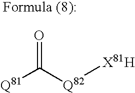
wherein Q⁸¹ and Q⁸² each independently represents an aromatic ring; and X⁸¹ represents NR⁸¹ in which R⁸¹ represents a hydrogen atom or a substituent, an oxygen atom or a sulfur atom; 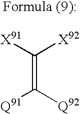
wherein Q⁹¹ and Q⁹² each independently represents an aromatic ring; and X⁹¹ and X⁹² each independently represents a hydrogen atom or a substituent, and at least one of which represents a cyano group, a carbonyl group, a sulfonyl group or an aromatic heterocycle.

6. The cellulose acylate film according to claim 5,
wherein the at least one UV absorber is a triazine compound wherein Q⁷¹ in the formula (7) is a 1,3,5-triazine ring.

7. The cellulose acylate film according to claim 1,
wherein the at least one UV absorber is a liquid compound at 25° C.

8. The cellulose acylate film according to claim 1,
wherein when the cellulose acylate film is irradiated with xenon light, contents of at least one of the at least one retardation regulator and the at least one UV absorber before and after irradiation satisfy numerical formula (1):
0.8≦Cmₓ/Cmₒ≦1.0
wherein Cmₒ is a content of the compound before irradiation with xenon light; and Cmₓ is a content of the compound after irradiation with xenon light.

9. The cellulose acylate film according to claim 1,
wherein the cellulose acylate film is saponified, and contents of at least one of the at least one retardation regulator and the at least one UV absorber before and after saponification satisfy a relation of numerical formula (2):
0.9≦Cmₛ/Cmₒ≦1.0
wherein Cmₒ is a content of the compound before saponification; and Cmₛ is a content of the compound after saponification.

10. The cellulose acylate film according to claim 1,
wherein Rth and Re of the cellulose acylate film at a wavelength of 630 nm satisfy ranges of numerical formulae (3) and (4):
−25 nm≦Rth₆₃₀≦25 nm,
0 nm≦Re₆₃₀≦10 nm.

11. The cellulose acylate film according to claim 1,
wherein values of Re and Rth of the cellulose acylate film at a wavelength of 630 nm satisfy a relation of numerical formula (5):

|Re₆₃₀×Rth₆₃₀|≦200. Numerical formula (5)

12. The cellulose acylate film according to claim 1,
wherein values of Re and Rth of the cellulose acylate film at a wavelength of 630 nm satisfy a relation of numerical formula (6):

|Re₆₃₀₍ₘₐₓ₎−Re₆₃₀₍ₘᵢₙ₎|≦5 and |Rth₆₃₀₍ₘₐₓ₎−Rth₆₃₀₍ₘᵢₙ₎|≦10. Numerical formula (6)
wherein Re₆₃₀₍ₘₐₓ₎ and Rth₆₃₀₍ₘₐₓ₎ each is a maximum retardation value of a film having a size of 1 m square randomly cut out at a wavelength of 630 nm; and Re₆₃₀₍ₘᵢₙ₎ and Rth₆₃₀₍ₘᵢₙ₎ each is a minimum retardation value at a wavelength of 630 nm.

13. The cellulose acylate film according to claim 1,
wherein changes in values of Re and Rth of the cellulose acylate film at a wavelength of 630 nm before and after saponification of the film surface with an alkali solution satisfy numerical formula (7):

|Re₆₃₀₍ₒ₎−Re₆₃₀₍ₛ₎|≦10 and |Rth₆₃₀₍ₒ₎−Rth₆₃₀₍ₛ₎|≦20. Numerical formula (7)
wherein Re₆₃₀₍ₒ₎ represents Re at a wavelength of 630 nm before saponification with an alkali solution; Re₆₃₀₍ₛ₎ represents Re at a wavelength of 630 nm after saponification with an alkali solution; Rth₆₃₀₍ₒ₎ represents Rth at a wavelength of 630 nm before saponification with an alkali solution; and Rth₆₃₀₍ₛ₎ represents Rth at a wavelength of 630 nm after saponification with an alkali solution.

14. The cellulose acylate film according to claim 1,
wherein a change in Rth in a wavelength range of from 400 nm to 700 nm is 25 nm or less, and a change in Re in a wavelength range of from 400 nm to 700 nm is 10 nm or less.

15. The cellulose acylate film according to any of claim 1,
wherein a spectral transmittance of the cellulose acylate film at a wavelength of 400 nm is from 45% to 95%, and a spectral transmittance of the cellulose acylate film at a wavelength of 350 nm is 10% or less.

16. The cellulose acylate film according to any of claim 1,
wherein a degree of an acyl substitution of a cellulose acylate in the cellulose acylate film is from 2.50 to 3.00, and an average degree of polymerization of the cellulose acylate is from 180 to 700.

17. The cellulose acylate film according to claim 1,
wherein an acyl substituent of a cellulose acylate in the cellulose acylate film comprises substantially only an acetyl group, a total degree of substitution of the cellulose acylate is from 2.50 to 2.95 and an average degree of polymerization of the cellulose acylate is from 180 to 550.

18. The cellulose acylate film according to claim 1, which has a film thickness of from 10 μm to 120 μm.

19. The cellulose acylate film according to claim 1, which is obtained by stretching,
wherein a stretching magnitude is from 1% to 100% in a direction perpendicular to a film-carrying direction (width direction).

20. The cellulose acylate film according to claim 19,
wherein Re at a wavelength of 630 nm in the cellulose acylate film obtained by stretching satisfies a relation of numerical formula (8):

|Re₍ₙ₎−Re₍₀₎|/n≦1.0 Numerical formula (8)
wherein Re₍ₙ₎ is Re of a film stretched in a ratio of n(%); and Re₍₀₎ is Re of an unstreched film.

21. The cellulose acylate film according to claim 1, which is obtained by casting a cellulose acylate solution (dope) to form a film,
wherein a compound having a molecular weight of 3,000 or less is added to the a cellulose acylate solution in a final step in a preparation step of the dope.

22. A polarizing plate comprising:
a polarizer; and
at least two protective films attached to both faces of the polarizer,
wherein at least one of the at least two protective films is a cellulose acylate film according to any of claim 1.

23. A liquid-crystal display device comprising:
a liquid-crystal cell; and
at least two polarizing plates arranged on both faces of the liquid-crystal cell,
wherein at least one of the at least two polarizing plates is a polarizing plate according to claim 22.

24. The liquid-crystal display device according to claim 23,
wherein the liquid-crystal display device is IPS-mode.
